(19) United States
(12) Patent Application Publication
(10) Pub. No.: US 2005/0069225 A1
(43) Pub. Date: Mar. 31, 2005

(54) Binding interactive multichannel digital document system and authoring tool

(75) Inventors: Tina Fay Schneider, San Francisco, CA (US); Bee Yian Liew, Cupertino, CA (US); Christine Gui Jun Yang, Pleasanton, CA (US)

Correspondence Address: FLIESLER MEYER, LLP, FOUR EMBARCADERO CENTER, SUITE 400, SAN FRANCISCO, CA, 94111, US

(73) Assignee: Fuji Xerox Co., Ltd., Minato-Ku (JP)

(21) Appl. No.: 10/672,875

(22) Filed: Sep. 26, 2003

(51) Int. Cl. G06K 9/54; H04N 5/445

(52) U.S. Cl. 382/305; 725/57

(57) ABSTRACT

A digital document and authoring tool for generating a digital document comprising a multi-channel interface is provided that achieves improved user interaction. The digital document includes a plurality of content channels providing primary content continuously in a looping manner and at least one supplementary channel on a single page. The supplementary channel is configured to provide supplementary content upon the occurrence of an event during playback of the document. Channel content may include video, text, images, 3D content, web page content, audio and any other suitable content. In addition to media content, a channel may contain interactive regions in the form of hot spots, and interactive mapping regions, and other interactive features. The codument can utilize a stage layout having at least one channel to present media and a collection of properties, the collection of properties forming a program. Using an authoring tool, the media and programs can be imported from search media collection and management tools to the channels. The authoring tool utilizes intuitive interfaces to configure digital documents.

### CROSS-REFERENCE TO RELATED APPLICATIONS

The following applications are cross-referenced and incorporated herein by reference:

U.S. patent application Ser. No. ______ [Attorney Docket No. FXPL-1044US3], entitled COMPREHENSIVE AND INTUITIVE MEDIA COLLECTION AND MANAGEMENT TOOL, by Tina F. Schneider, et al., filed herewith.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

This invention relates generally to the field of multimedia documents, and more particularly to authoring and managing media within interactive multi-channel multimedia documents.

### BACKGROUND

Communication has evolved to take place in many forms for many purposes. In order to communicate effectively, the presenter must be able to maintain the attention of the message recipient. One method for maintaining the recipient's attention is to make the communication interactive. When a recipient is invited to interact as part of the communicative process, the recipient is likely to pay more attention to the details of the communication in order to interact successfully.

With the development of computers and digital multimedia, the electronic medium has become a popular stage house for narrating stories, generating digital presentations, and other types of communication. Despite the advances in electronics, the art of storytelling as well as communication in general still faces the challenge of finding a way to communicate messages through interaction. For example, print content presentation evolved from lengthy scrolls to bound pages. Digital documents having a variety of media content types need a way to bind content together to present a sense of cohesion. The problem is that most interface designs used in electronic narration applications revolve around undefined multi-layered presentations with no predefined boundaries. New content and storyline sequences are presented to the user through multiple window displays triggered by hyperlinks. This requires a user of an interface to exit one sequence of a story to experience a new sequence. As a result, most interactive narratives are either very linear where interaction is equivalent to turning a page, or non-linear where a user is expected to help author the story. In either case, the prior art does not address the need for binding multiple types of content together in a defined manner. These interactive narratives are overwhelming because a user must keep track of loose and unorganized arrays of windows.

One example of a digital interactive narration is the DVD version of the movie Timecode. Timecode takes a traditional film frame and breaks the screen into four equal and stationary frames. Each of the four frames depicts a segment of a story. A single event, an earthquake, ties the stories together as do the characters as they appear in different screens. The film was generated with the idea that sound presented in the theatrical version of Timecode would be determined by the director and correspond to one of the four channels at various points in the story. The DVD released version of the story contains an audio file for each of the four channels. The viewer may select any one of the four channels and hear the audio corresponding to that channel. The story of the Timecode DVD is presented once while the DVD is played from beginning to end. The DVD provides a yellow highlight in one corner of the frame currently selected by the user. Though a character may appear to move from one channel to another, each channel concentrates on a separate and individual storyline. Channels in the DVD are not combined to provide a larger channel.

The DVD release of Timecode has several disadvantages as an implementation of an interactive interface. These disadvantages stem from the difficulty of transferring a linear movie intended to be driven by a script into an interactive representation of the movie in DVD format. One disadvantage of the DVD release of Timecode involves channel management. When a user selects a frame to hear the audio corresponding to that frame, there is no further information provided by the DVD regarding that frame. Thus, a user is immediately subjected to audio relating to a channel without any context. The user does not know any information about what a character in the story is attempting, thinking, or where the storyline for that channel is heading. Thus, a user must stay focused on that channel for longer periods of time in hope that the audio will illuminate the storyline of the channel.

Yet another disadvantage of the Timecode DVD as a narration is that no method exists for determining the overall plot of the story. None of the channels represent an abstract, long shot, or overview perspective of the characters in the story. As a result, it is difficult for a user to determine what frame displays content that is important to the storyline at different times in the movie. Although a user may rapidly and periodically surf between different channels, there is no guarantee that a user will be able to ascertain what content is most relevant.

Yet another disadvantage of the DVD release of Timecode as an interactive interface is that the channels in the Timecode DVD do not provide any sense of temporal depth. A user can not ascertain the temporal boundaries of the DVD from watching the DVD itself until the movie within the DVD ends. Thus, to ascertain and explore movie content during playback of the movie, a user would have to manually rewind movie scenes to review a scene that was missed in another frame.

Another example of a multimedia interface is a research project called HyperCafe, by Sawhney et al., Georgia Institute of Technology, School of Literature, Communication, and Culture, College of Computing, Atlanta, Ga. HyperCafe replaces textual link properties for video links to create an interactive environment of hyperlinks. Multiple video windows associate different aspects of a continuous narrative. The HyperCafe experience begins with a small number of video windows on a screen. A user may select one of the video windows. Once selected, a new moving window appears displaying content related to the previously selected window. Thus, to receive information about a first video window in HyperCafe, a user may have to engage several windows to view the additional video windows. Further, the video windows move autonomously across a display screen in a choreographed pattern. The technique used is similar to the narrative technique used in several movies, where the camera follows a first character, and then when the first character interacts with a second character, the camera follows the second character in a different direction through the movie. This narrative technique moves the story not through a single plot but through associated links in a story. In HyperCafe, the user can follow an actor in one video window and through another video window follow another actor as the windows move like characters across a screen. The user can also manipulate the story by dragging windows together to help make a narrative connection between the different conversations in the story.

The HyperCafe project has several limitations as an interface. The frames used in HyperCafe provide hyper-video links to new frames or windows. Once a hyper-video link is selected, the new windows appear in the interface replacing the previously selected windows. As a result, a user is required to interact with the interface before having the opportunity to view multiple segments of a storyline.

Another limitation of the HyperCafe project is the moving frames within the interface. The attention of a human is naturally attracted to moving objects. As the frames in the HyperCafe move across the screen, they tend to monopolize the attention of the user. As a result, the user will focus less attention towards the other frames of the interface. This makes the other frames inefficient at providing information while a particular frame is moving within the interface. Further, the HyperCafe presentation has no temporal depth. There is no way to determine the length of the content contained, nor is there a method for reviewing content already presented. Once content, or “conversations”, in HyperCafe is presented, they are removed and the user must move forward in time by choosing a hypervideo link representing new content. Also, there is no sense of spatial depth in that the number of windows presenting content to a user is not constant. As hypervideo links are selected by a user, new windows are added to the interface. The presentation of content in HyperCafe is not defined by any structured set of windows. These limitations of the HyperCafe project result from the intention of HyperCafe to present a ‘live’ performance of a scene at a coffee shop instead of a way of presenting and binding several types of media content to from a presentation.

Further, the hyper-video links may only be selected at certain times within a particular frame. HyperCafe does not provide a way for reviewing what was missed in a previous video sequence nor skipping ahead to the end of a video sequence. The HyperCafe experience is similar to viewing a live stage-like viewing where actors play out a story in real time. Thus, a user is not encouraged to freely experience the content of different frames as the user wishes. To the contrary, a user is required to focus on a particular frame to choose a hyperlink during the designated time the hyperlink is made available to the user.

Accordingly, a need exists for a digital document system including an authoring tool that addresses the limitations and disadvantages of the prior art.

### SUMMARY

In one embodiment of the present invention, a digital document authoring tool is provided for authoring a digital document that binds media content types using spatial and temporal boundaries. The binding element of the document achieves cohesion among document content, which enables a better understanding by and engagement from a user, thereby achieving a higher level of interaction from a user A user may engage the document and explore document boundaries at his or her own pace. The document of the present invention features a single-page interface and media content that may include video, text, images, web page content and audio. In one embodiment, the media content is managed in a spatial and temporal manner.

In one embodiment, a digital document includes a multi-channel interface that can present media simultaneously along a multi-dimensional grid in a continuous loop. Additional media content is activated through user interaction with the channels. In one embodiment, the selection of a content channel having media content initiates the presentation of supplementary content in supplementary channels. In another embodiment, selection of hot spots or the selection of an enabled mapping object in a map channel may also trigger the presentation of supplementary content or the performance of an action within the document. Channels may display content relating to different aspects of a presentation, such as characters, places, objects, or other information that can be represented using multimedia.

The digital document of the present invention may be defined by boundaries. A boundary allows a user of the document to perceive a sense of depth in the document. In one embodiment, a boundary may relate to spatial depth. In this embodiment, the document may include a grid of multiple channels on a single page. The document provides content to a user through the channels. The channels may be placed in rows, columns or in some other manner. In this embodiment, content during playback is not provided outside the multi-channel grid. Thus, the spatial boundary provides a single ‘page’ format using a multi-channel grid to arrange content.

In another embodiment, the boundary may relate to temporal depth. In one embodiment, temporal depth is provided as the document displays content continuously and repetitively within the multiple channels. Thus, in one embodiment, the document may repetitively provide sound, text, images, or video in one or more channels of the multi-channel grid where time acts as part of the interface. The repetitive element provides a sense of temporal depth by informing the user of the amount of content provided in a channel.

In yet another embodiment, the digital document supports a redundancy element. Both the spatial and temporal boundaries of the document may contribute to the redundancy element. As a user interacts with the document and perceives the boundaries of the document, the user learns a predictability element present within the document. The spatial boundary may provide predictability as all document content is provided on a multi-channel grid located on a single page. The temporal boundary may provide predictability as content is provided repetitively. The perceived predictability allows the user to become more comfortable with the document and achieve a better and more efficient perception of document content.

In yet another embodiment, the boundaries of the document of the present invention serve to bind media content into a defined document for presenting multi-media. In one embodiment, the document is defined as a digital document having a multi-channel grid on a single page, wherein each channel provides content. The channels may provide media content including video, audio, web page content, images, or text. The single page multi-channel grid along with the temporal depth of the content presented act to bind media content together in a cohesive manner.

The document of the present invention represents a new genre for multi-media documents. The new genre stems from a digital defined document for communication using a variety of media types, all included within the boundary of a defined document. A document-authoring tool allows an author to provide customized depth and content directly into a document of the new genre.

In one embodiment, the present invention includes a tool for generating a digital defined document. The tool includes an interface that allows a user to generate a document defined by boundaries and having an element of redundancy. The interface is easy to use and allows users to provide customized depth and content directly into a document.

The digital document of the present invention is adaptable for use in many applications. The document may be implemented as an interactive narration, educational tool, training tool, advertising tool, business planning or communication tool, or any other application where communication may be enhanced using multi-media presented in multiple channels of information.

The boundary-defined media-binding document of the present invention is developed in response to the recognition that human physiological senses uses familiarity and predictability to perceive and process multiple signals simultaneously. People may focus senses such as sight and hearing to determine patterns and boundaries in the environment. With the sense of vision, people are naturally equipped to detect peripheral movement and detect details from a centrally focused object. Once patterns and consistencies are detected in an environment and determined to predictably not change in any material manner, people develop a knowledge and resulting comfort with the patterns and consistencies which allow them to focus on other ‘new’ information or elements from the environment. Thus, in one embodiment, the digital document of the present invention binds media content in a manner such that a user may interact with multiple displays of information while still maintaining a high level of comprehension because the document provides stationary spatial boundaries through the multi-grid layout, thereby allowing the user to focus on the content contained within the document boundaries.

The digital document can be authored using an object based system that incorporates a comprehensive and media collection and management tool. The media collection and management tool is implemented as a software component than can import and export programs. A program is set of properties that may or may not be associated with media. The properties relate to narration, hot spot, synchronization, annotation, channel properties, and numerous other properties.

### BRIEF DESCRIPTION OF THE DRAWINGS

FIG. 1 is a diagram of an interactive multichannel document in accordance with one embodiment of the present invention.

FIG. 2 illustrates a digital interactive multichannel document as displayed on a display screen in accordance with one embodiment of the present invention.

FIG. 3 is a diagram of an interactive multichannel document having a mapping frame in accordance with one embodiment of the present invention.

FIG. 4 illustrates a digital interactive multichannel document having a mapping frame as displayed on a display screen in accordance with one embodiment of the present invention.

FIG. 5 is a diagram of an interactive multichannel document having a mapping frame and multiple object groups in accordance with one embodiment of the present invention.

FIG. 6 illustrates a method for executing a interactive multi-channel digital document in accordance with one embodiment of the present invention.

FIG. 7 illustrates a system for authoring and playback an interactive multi-channel digital document in accordance with one embodiment of the present invention.

FIG. 8 illustrates a method for authoring a digital document in accordance with one embodiment of the present invention.

FIG. 9 illustrates multi-channel digital document layouts in accordance with one embodiment of the present invention.

FIG. 10 illustrates an interface for generating a multichannel digital document in accordance with one embodiment of the present invention.

FIG. 11 illustrates a method for generating a mapping feature in a multichannel digital document in accordance with one embodiment of the present invention.

FIG. 12 illustrates a method for generating a stationary hot spot feature in a multichannel digital document in accordance with one embodiment of the present invention.

FIG. 13 illustrates a method for generating a moving hot spot feature in a multichannel digital document in accordance with one embodiment of the present invention.

FIG. 14 illustrates an interface for implementing a property and media management and configuration tool in accordance with one embodiment of the present invention.

FIG. 15 illustrates a method for configuring a program in accordance with one embodiment of the present invention.

FIG. 16 illustrates an interface for managing media and authoring a digital document in accordance with one embodiment of the present invention.

FIG. 17 illustrates an interface for managing media and authoring a digital document in accordance with one embodiment of the present invention.

FIG. 18 illustrates a relationship between programs and program properties in accordance with one embodiment of the present invention.

FIG. 19 illustrates a method for generating a copy of a program property in accordance with one embodiment of the present invention.

FIG. 20 illustrates a method for retrieving and importing media in accordance with one embodiment of the present invention.

FIG. 21 illustrates a method for generating an interactive multichannel document in accordance with one embodiment of the present invention.

FIG. 22 illustrates a method for configuring program settings in accordance with one embodiment of the present invention.

FIG. 23 illustrates a method for configuring program properties in accordance with one embodiment of the present invention.

FIG. 24 illustrates a method for configuring hot spot properties in accordance with one embodiment of the present invention.

FIG. 25 illustrates a method for configuring project settings in accordance with one embodiment of the present invention.

FIG. 26 illustrates a method for publishing a digital document in accordance with one embodiment of the present invention.

FIG. 27 illustrates a program property editor interface in accordance with one embodiment of the present invention.

FIG. 28 illustrates a project setting editor interface in accordance with one embodiment of the present invention.

FIG. 29 illustrates a publishing editor interface in accordance with one embodiment of the present invention.

FIG. 30 illustrates a stage window program editor interface in accordance with one embodiment of the present invention.

FIG. 31 illustrates a program property editor interface in accordance with one embodiment of the present invention.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In the following description, various aspects of the present invention will be described. However, it will be apparent to those skilled in the art that the present invention may be practiced with only some or all aspects of the present invention. For purposes of explanation, specific numbers, materials, and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description will be presented in data processing terms, such as data, selection, retrieval, generation, and so forth, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through electrical, optical, and/or biological components of a processor and its subsystems.

Various operations will be described as multiple discrete steps in turn, in a manner that is most helpful in understanding the present invention, however, the order of description should not be construed as to imply that these operations are necessarily order dependent.

Various embodiments will be illustrated in terms of exemplary classes and/or objects in an object-oriented programming paradigm. It will be apparent to one skilled in the art that the present invention can be practiced using any number of different classes/objects, not merely those included here for illustrative purposes. Furthermore, it will also be apparent that the present invention is not limited to any particular software programming language or programming paradigm.

In one embodiment of the present invention, a digital document comprising an interactive multi-channel interface is provided that binds video, text, images, web page content and audio media content types using spatial and temporal boundaries. The binding element of the document achieves cohesion among document content, which enables a better understanding by and engagement from a user, thereby achieving a higher level of engagement from a user. A user may interact with the document and explore document boundaries and document depth at his or her own pace and in a procession chosen by the user. The document of the present invention features a single-page interface with customized depth of media content that may include video, text, one or more images, web page content and audio. In one embodiment, the media content is managed in a spatial and temporal manner using the content itself and time. The content in the multi-channel digital document may repeat in a looping pattern to allow a user the chance to experience the different content associated with each channel. The boundaries of the document that bind the media together provide information and comfort to a user as the user becomes familiar with the spatial and temporal layout of the content allowing the user to focus on the content instead of the interface. In another embodiment, the system of the present invention allows an author to create an interactive multi-channel digital document.

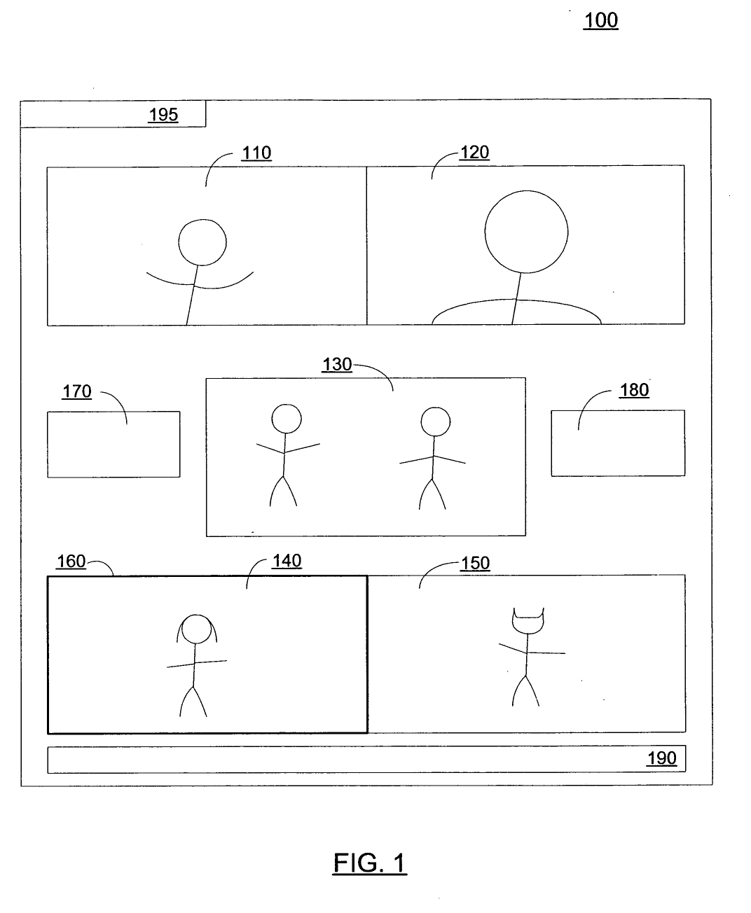

FIG. 1 is a diagram of an interactive multi-channel document 100 in accordance with one embodiment of the present invention. The document is comprised of an interface 100 that includes content channels 110, 120, 130, 140, and 150. The content channels may be used to present media including video, audio, images, web page content, 3D content as discussed in more detail below, and text. The interface also includes supplementary channels 170 and 180. Similar to the content channels, the supplementary channels may be used to present video, audio, images, web page content and text. Though five content channels and two supplemental channels are shown, the number and placement of the content channels and supplementary channels may vary according to the desire of the author of the interface. The audio presented within a content or supplementary channel may be part of a video file or a separate audio file. Interactive multi-channel interface 100 also includes channel highlight frame 160, optional control bar 190, and information window 195. In one embodiment, a background sound channel is also provided. A background sound channel may or may not be visually represented on the interface (not shown in FIG. 1).

An interactive multi-channel digital document in accordance with one embodiment of the present invention may have several features. One feature of the digital document of the present invention is that all content is presented on a single page. A user of the multi-channel interface does not need to traverse multiple pages when exploring new content. The changing content is organized and provided in a single area. Within any content channel, the content may change automatically, through the interactions of the user, or both. In one embodiment, the interface consists of a multi-dimensional grid of channels. In one embodiment, the author of the narration may configure the size and layout of the channels. In another embodiment, an author may configure the size of the channels, but all channels are of the same size. A channel may present media including video, text, one or more images, audio, web page content, 3D content, or a combination of these media types. Additional audio, 3D content, video, image, images, web page content and text may be associated with the channel content and brought to the foreground through interaction by the user.

In another embodiment of the present invention, the multi-channel interface uses content and the multi-grid layout in a rhythmic, time-based manner for displaying information. In one embodiment, content such as videos may be presented in single or multiple layers. When only one layer of content is displayed, each video channel will play continuously in a loop. This allows users to receive information on a periphery basis from a variety of channels without having playback of the document end upon the completion of a video. The loop automatically repeats until a user provides input indicating that playback of the document shall end.

The digital document of the present invention may be defined by boundaries. A boundary allows a user of the document to perceive a sense of depth in the document. In one embodiment, a boundary may relate to spatial depth. In this embodiment, the document may include a grid of multiple channels on a single page. The document provides content to a user through the channels. The channels may be placed in rows, columns or in some other manner. In this embodiment, content is not provided outside the multi-channel grid. Thus, the spatial boundary provides a single ‘page’ format using a multi-channel grid to arrange content.

In another embodiment, the boundary may relate to temporal depth. In one embodiment, temporal depth is provided as the document displays content continuously and repetitively within the multiple channels. Thus, in one embodiment, the document may repetitively provide sound, text, images, or video in one or more channels of the multi-channel grid where time acts as part of the interface. The repetitive element provides a sense of temporal depth by informing the user of the amount of content provided in a channel.

In yet another embodiment, the digital document supports a redundancy element. Both the spatial and temporal boundaries of the document may contribute to the redundancy element. As a user interacts with the document and perceives the boundaries of the document, the user learns a predictability element present within the document. The spatial boundary may provide predictability as all document content is provided on a multi-channel grid located on a single page. The temporal boundary may provide predictability as content is provided repetitively. The perceived predictability allows the user to become more comfortable with the document and achieve a better and more efficient perception of document content.

In yet another embodiment, the boundaries of the document of the present invention serve to bind media content into a defined document for presenting multi-media. In one embodiment, the document is defined as a digital document having a multi-channel grid on a single page, wherein each channel provides content. The channels may provide media content including video, audio, web page content, images, or text. The single page multi-channel grid along with the temporal depth of the content presented act to bind media content together in a cohesive manner.

The document of the present invention represents a new genre for multi-media documents. The new genre stems from a digital defined document for communication using a variety of media types, all included within the boundary of a defined document. A document-authoring tool allows an author to provide customized depth and content directly into a document of the new genre.

In one embodiment, the present invention includes a tool for generating a digital defined document. The tool includes an interface that allows a user to generate a document defined by boundaries and having an element of redundancy. The interface is easy to use and allows users to provide customized depth and content directly into a document.

The boundary-defined media-binding document of the present invention is developed in response to the recognition that human physiological senses uses familiarity and predictability to perceive and process multiple signals simultaneously. People may focus senses such as sight and hearing to determine patterns and boundaries in the environment. With the sense of vision, people are naturally equipped to detect peripheral movement and detect details from a centrally focused object. Once patterns and consistencies are detected in an environment and determined to predictably not change in any material manner, people develop a knowledge and resulting comfort with the patterns and consistencies which allow them to focus on other ‘new’ information or elements from the environment. Thus, in one embodiment, the digital document of the present invention binds media content in a manner such that a user may interact with multiple displays of information while still maintaining a high level of comprehension because the document provides stationary spatial boundaries through the multi-grid layout, thereby allowing the user to focus on the content contained within the document boundaries.

In one embodiment, audio is another source of information that the user explores as the user experiences a document of the present invention. In one embodiment, there are multiple layers of audio presented to the user of the interface. One layer of audio may be associated with an individual content channel. In this case, when multiple channels are presented in an interface and a user selects a particular channel, audio corresponding to the selected channel may be presented to the user. In one embodiment, the audio corresponding to a particular channel is only engaged while the channel is selected. Once a user selects a different channel, the audio of the newly selected channel is activated. When a new channel is activated, the audio corresponding to the previously selected channel may end or reduce in volume. Examples of audio corresponding to a particular channel may include dialogue, non-dialogue audio effects and music corresponding to the video content presented in a channel.

Another audio layer in one embodiment of the present invention may be a universal or background layer of audio. Background audio may be configured by the author and continue throughout playback of the document regardless of what channel is currently selected by a user. Examples of the background audio include speech narration, music, and other types of audio. The background audio layer may be chosen to bring the channels of an interface into one collective experience. In one embodiment of the present invention, the background audio may be chosen to enhance events such as an introduction, conclusion, foreshadowing events or the climax of a story. Background audio is provided through a background audio channel provided in the interface of the present invention.

In one embodiment, the content channels are used to collectively narrate a story. For example, the content channels may display video sequences. Each channel may present a video sequence that narrates a portion of the story. For example, three different channels may focus on three different characters featured in a story. Another channel may present a video sequence regarding an important location in the story, such as a location where the characters reside throughout the story or any other aspect of the story that can be represented visually. Yet another channel may provide an overview or long shot perspective. The long shot perspective may show content featured in multiple channels, such as the characters featured in those channels. In the embodiment shown in FIG. 1, channels 110, 120, and 140 relate to a single character and channel 150 relates to a creature. In the embodiment shown in FIG. 1, channel 130 relates to a long shot view of the characters depicted in channels 110 and 120 at the current time in the narration. In one embodiment, the video sequences of each channel are synchronized in time such that what is appearing to occur in one channel is happening at the same time as what is appearing to occur in the other content channels. In one embodiment, the channels do not adjust in size and do not migrate across the interface. A user of the narration interface may interact with the interface by selecting a particular content channel. When selected, each content channel presents information regarding the content channels video segment through the supplemental channels.

The supplemental channels provide supplementary information. The channels may be placed in locations as chosen by the interface author or at pre-configured locations. In one embodiment, supplemental channels provide media content upon the occurrence of an event during document playback. The event may be the selection of the supplemental channel, selection of a content channel, expiration of a timer, selection of a hot spot, selection of a mapping object or some other event. The supplementary channel media content may correspond to a content channel selected by the user at the current playback time of the document. Thus, the media content provided by the supplementary channels may change over time for each channel. The content may address an overview of what is happening in the selected channel, what a particular character in the selected frame is thinking or feeling, or provide some other information relating to the selected channel. This provides a user with a context for what is happening in the selected channel. In another embodiment, the supplemental channels may provide content that conveys something that happened in the past, something that a character is thinking, or other information as determined by the author of the interface. The supplemental channels may also be configured to provide a forward, credits, or background information within the document. Supplementary channels can be implemented as a separate channel as shown in FIG. 1, or within a content channel. When implemented within a content channel, media content may be displayed within the content channel when a user selects the content channel.

The content channels can be configured in many ways to further secure the attention of the user and enhance the user's understanding of the information provided. In one embodiment, a content channel may be configured to provide video from the perspective of a long distance point of view. This “long distance shot” may encapsulate multiple main characters, an important location, or some other subject of the narration. While one frame may focus on multiple main characters, another frame may focus on one of the characters more specifically. This provides a mirror-type effect between the two channels. This assists to bring the channels together as one story and is very effective in relating multiple screens together at different points in the story. A long distance shot is shown in the center channel of FIG. 1.

In accordance with another embodiment of the present invention, characters and scenes may line up visually across two channels. In this case, a character could seamlessly move across two or more channels as if it were moving in one channel. In another embodiment, two adjoining channels may have content that make the channels appear to be a single channel. Thus, the content of two adjoining channels may each show one half of a video or object to make the two channels appear as one channel.

A user may interact with the multi-channel interface by selecting a channel. To select a channel, the user provides input through an input device. An input device as used herein is defined to include a mouse device, keyboard, numerical keypad, touch-screen monitor, voice recognition system, joystick, game controller, a personal digital assistant (PDA) or some other input device enabled to generate an input event signal. In one embodiment, once a user has selected a channel, a visual representation will indicate that the channel has been selected. In one embodiment, the border of the selected channel is highlighted. In the embodiment shown in FIG. 1, the border 160 of content channel 140 is highlighted to indicate that channel 140 is currently selected. Upon selecting a content channel, the supplementary channels can be used to provide media or information in some other form regarding the selected channel. In one embodiment, sound relating to the selected channel at the particular time in the narration is also provided. The interactive narration interface may be configured to allow a user to start, stop, rewind, fast forward, step through and pause the narration interface with the input device. In an embodiment where the input device is a mouse, a user may select a channel by using a mouse to move a cursor into the channel and pause playback of the document by clicking on the channel. A user may restart document playback by clicking a second time on the selected channel or by using a control bar such as optional control bar 190 in FIG. 1. A particular document may not contain a control bar, have each video display its own control bar, or have one control bar for all video channels simultaneously. In one embodiment, if there is one story, presentation, theme or related subject matter that is to be displayed across multiple channels, such as in a traditional one-plot narrative, then a single control bar may control all of the channels simultaneously.

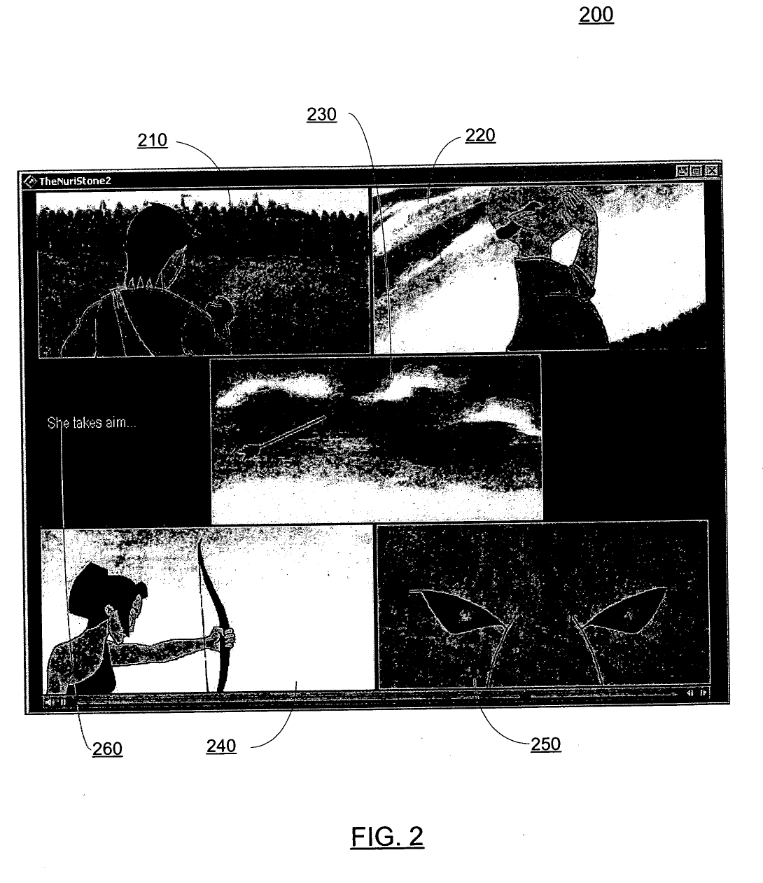

FIG. 2 illustrates an interactive narration interface 200 where the content channels contain animated video in accordance with one embodiment of the present invention. As shown in FIG. 2, the interface 200 includes content channels 210, 220, 230, 240, and 250 and supplemental channel 260. Content channel 230 shows an arrow in mid-flight, an important aspect of the narration at the particular time. Content channel 240 is currently selected by a user and highlighted by a colored border. The animation of channel 240 depicts a character holding a bow, and text displayed in supplementary channel 260 regarding the actions of the character. Content channels 210 and 220 depict other human characters in the narration while content channel 250 depicts a creature.

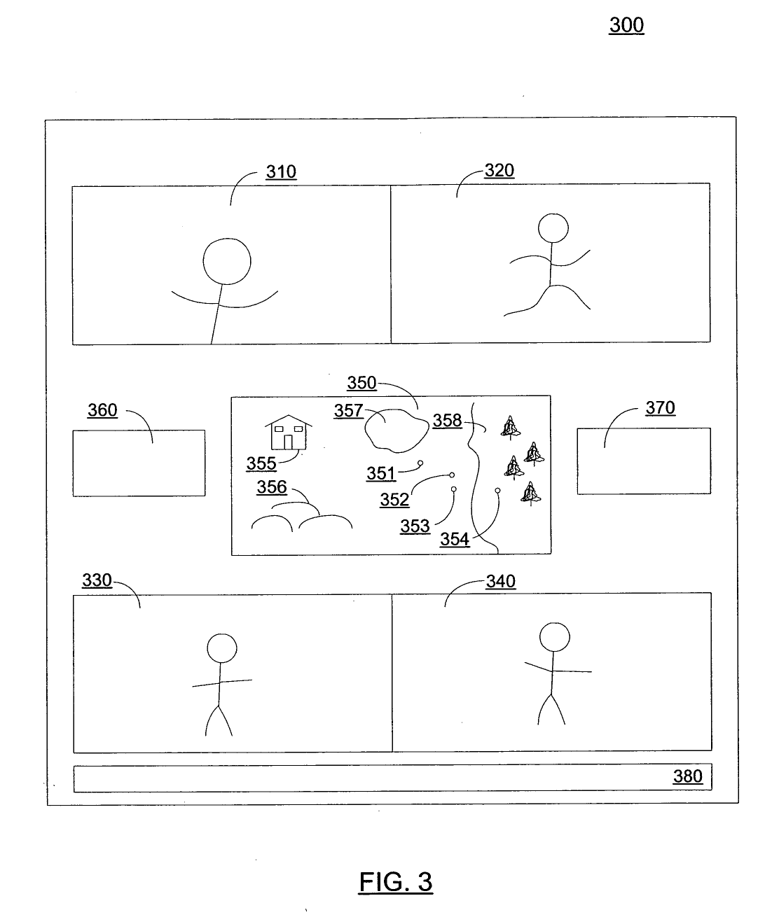

In one embodiment of the present invention, a content channel may be used as a map channel to present information relating to the geographical location of objects in the narration. For example, a content channel may resemble a map. FIG. 3 is a diagram of an interactive narration system interface 300 having a mapping frame in accordance with one embodiment of the present invention. Interface 300 includes content channels 310, 320, 330, 340, and 350, supplemental channels 360 and 370, and an optional control bar 380. Content channels 310-340 relate to characters in the narration and content channel 350 is a map channel. Map channel 350 includes character icons 351-354, object icons 355-357, and terrain shading 358.

In the embodiment shown in FIG. 3, the map channel presents an overview of a geographical area. The geographical area may be a view of the entire landscape where narration takes place, a portion of the entire landscape, or some other geographical representation. In one embodiment, the map may provide a view of only a portion of the total landscape involved in a narration in the beginning of the narration and expand as a character moved around the landscape. Within the map channel are several icons. In one embodiment, a character icon corresponds to a major character in the narration. Selecting a character icon may provide information regarding the character such as biographical information. For each character icon, there may be a content channel displaying video of the corresponding character. In FIG. 3, character icons 351-354 correspond to the characters of content channels 310, 320, 330 and 340. As a character moves, details regarding the movements may be depicted in its respective content channel. The map channel would depict the movement in relation to a larger geographic area. Thus, as the character in map channel 320 runs, a corresponding character icon 352 moves in the map of map channel 350. Further, the character icons may vary throughout a story depending upon the narration. For example, a character icon may take the form of a red dot. If a character dies, the dot may turn gray, a light red, or some other color. Alternatively, a character icon may change shape. In the case of a character's death, the indicator may change from a red dot to a red “x”. Multiple variations of depicting character and object icons on a map are possible, all of which are considered within the scope of the present invention.

The map channel may also include object icons. Object icons may include points of interest in the narration such as a house 355, hills 356, or a lake 357. Further, a map depicted in the map channel may indicate different types of terrain or properties of specific areas. For example, a forest may be depicted as a colored area such as colored area 358. A user may provide input that selects object icons. Once the object icons are selected, background information on the objects such as the object icon history may be provided in the content or supplemental channels. Any number of object icons could be depicted in the map channel depending upon the type of narration being presented, all of which are considered within the scope of the present invention.

In another embodiment of the present invention, the map channel may depict movement of at least one object icon over a time period during document playback. The object icon may represent anything that is configured to change positions over time elapsed during document playback. The object icon may or may not correspond to a content channel. For example, the map channel may be implemented as a graph that shows the fluctuation of a value over time. The value may be a stock price, income, change in opinion, or any other quantifiable value. In this embodiment, an object icon in a map channel may be associated with a content channel displaying information related to the object. Related information may include company information or news when mapping stock price objects, news clips or developments when mapping changes in opinion, or other information to give a background or further information regarding a mapped value. In another embodiment, the map channel can be used as a navigational guide for users exploring the digital document.

Similar to the interactive properties of the channels discussed in relation to FIG. 1, media content can be brought to the foreground according to the selection of an object or a particular character icon in a map channel. In one embodiment of the present invention, a user may select a character icon within the map channel. Upon selecting a character icon, a content channel will automatically be selected that relates to the character icon selected by the user. In one embodiment, a visual indicator will indicate that the content channel has been selected. The visual indicator may include a highlighted border around the content channel or some other visual indicator. In an embodiment, a visual indicator may also appear indicating a character icon has been selected. The visual indicator in this case may include a border around the character icon or some other visual signal. In any case, once a character icon is selected, supplemental media content corresponding to the particular character may be presented in the supplemental channels.

In one embodiment, the map channel is essentially the concept tool of the multi channel digital document. It allows many layers, multiple facets or different clusters of information to be presented without over crowding or complicating the single page interface. In an embodiment, the digital document is made up of two or more segments of stories; the map channel can be used to bring about the transition of one segment to another. As the story transitions from one segment to another, one or more of the channels might be involved in presenting the transition. The content in the affected channels may change or go empty as designed. The existence of the map channel helps the user to maintain the big picture and the current context as the transition takes place.

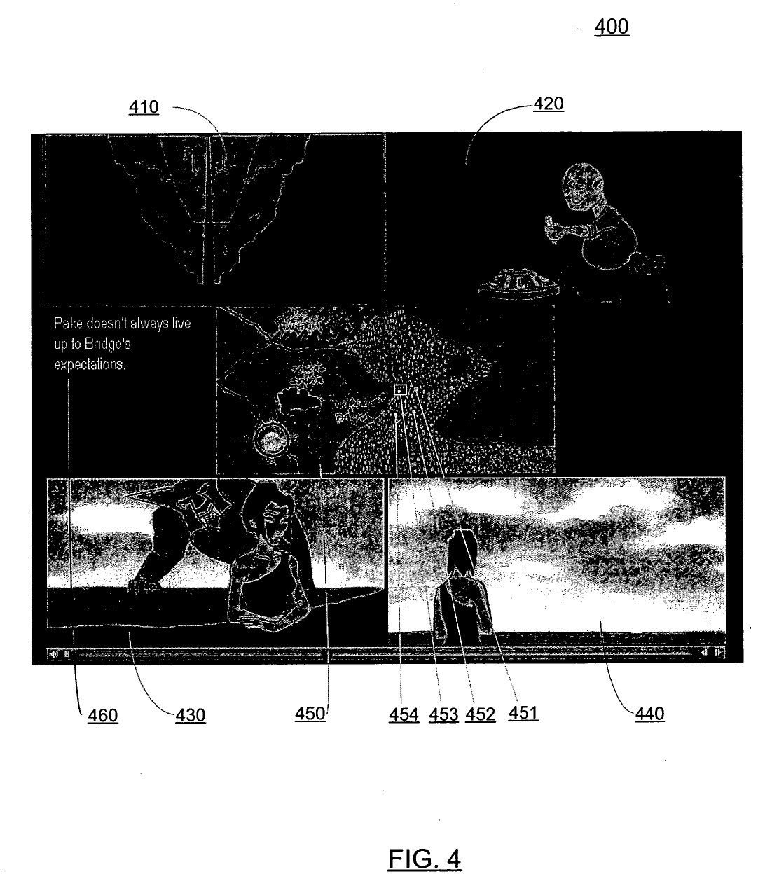

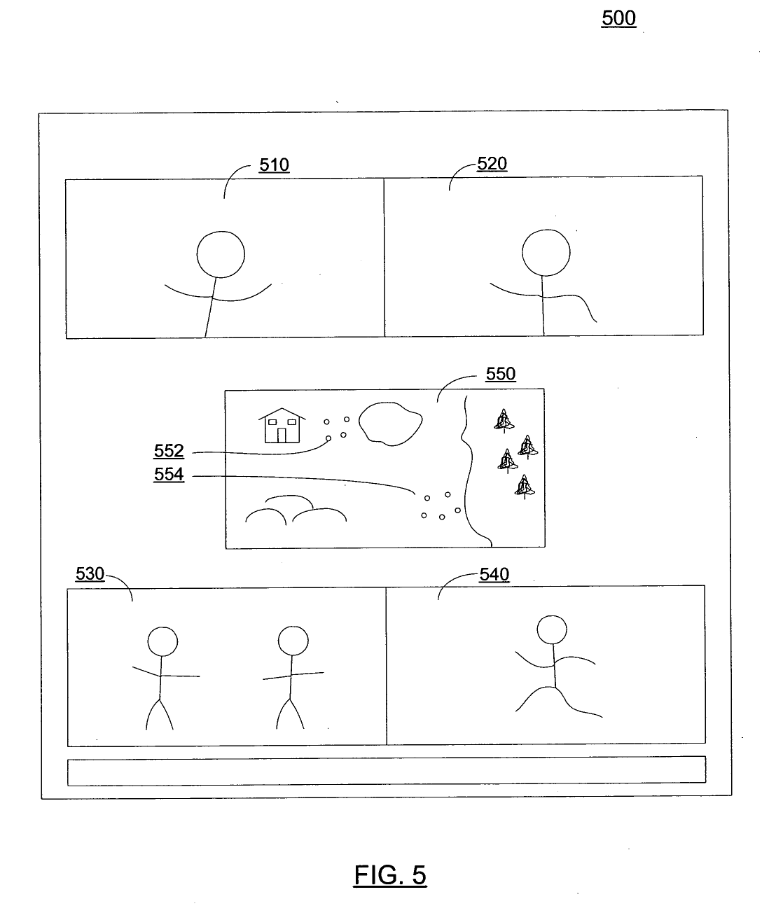

FIG. 4 illustrates an interactive narration interface 400 where the content channels contain animated video having a map channel in accordance with one embodiment of the present invention. Interface 400 includes content channels 410, 420, 430, and 440, map channel 450, and supplemental channel 460. In the embodiment shown, the map channel includes object icons such as a direction indicator, a castle, mountains, and a forest. Text is also included within the map channel to provide information regarding objects located on the map. Map channel also includes character icons 451, 452, 453, and 454. In the embodiment shown, each character icon in the map channel corresponds to a character featured in a surrounding content channel. In the embodiment shown in FIG. 4, the character featured in content channel 410 corresponds to character icon 453. As shown, character icon 453 has been selected, as indicated by the highlighted border around the indicator in the map channel. Accordingly, content channel 410 is also selected by a highlighted border because of the association with between channel 410 and the selected character icon. In the embodiment shown, text displayed in supplemental channel 460 corresponds to character icon 453 at the current time in the narration.

In yet another embodiment, there may not be content channels for all the characters, places or objects featured in a story or other type of presentation. This may be a result of author design or impracticality of having numerous channels on a single interface. In this situation, content channels may be delegated to different characters or objects based on certain criteria. In one embodiment of the present invention, available content channels may be delegated to a group of characters that are related in some way, such as those positioned in the same geographic area in the map channel. In one embodiment, the interface may be configured to allow a user to select a group of characters. FIG. 5 is a diagram of an interactive narration interface 500 having two groups of characters in the map channel 550, group 552 and group 554. In FIG. 5, the user may select either group 552 or 554. Upon selecting a particular group, content related to those characters may be provided in the content channels of the interface. In an embodiment, if a user provided input to select a second group while content relating to a first group was currently displayed in the content channels, the content channels would then display content associated with the second group. In another embodiment, a user could distinguish between selecting content channel or supplemental channel content regarding a group. For example, a first group may currently be selected by a user. A user may then provide a first input to obtain supplemental content related to a second group, such as video, audio, text and sound. In this embodiment, the content channels would display content related to the first group while the supplemental channels provide content related to the second group. A user would only generate content in the content channels relating to the second group when the user provided a second input. In one embodiment, the input device may be a mouse. In this case, a user may generate a first input by using the mouse to place a cursor over the first group on the map channel. The user may generate the second input by using the mouse to place the cursor over the second group in the map channel and then depressing a mouse button. Other input devices could also be used to provide input to mapping characters, all of which are considered to be within the scope of the present invention. Generation and configuration of mapping channels is discussed in more detail below.

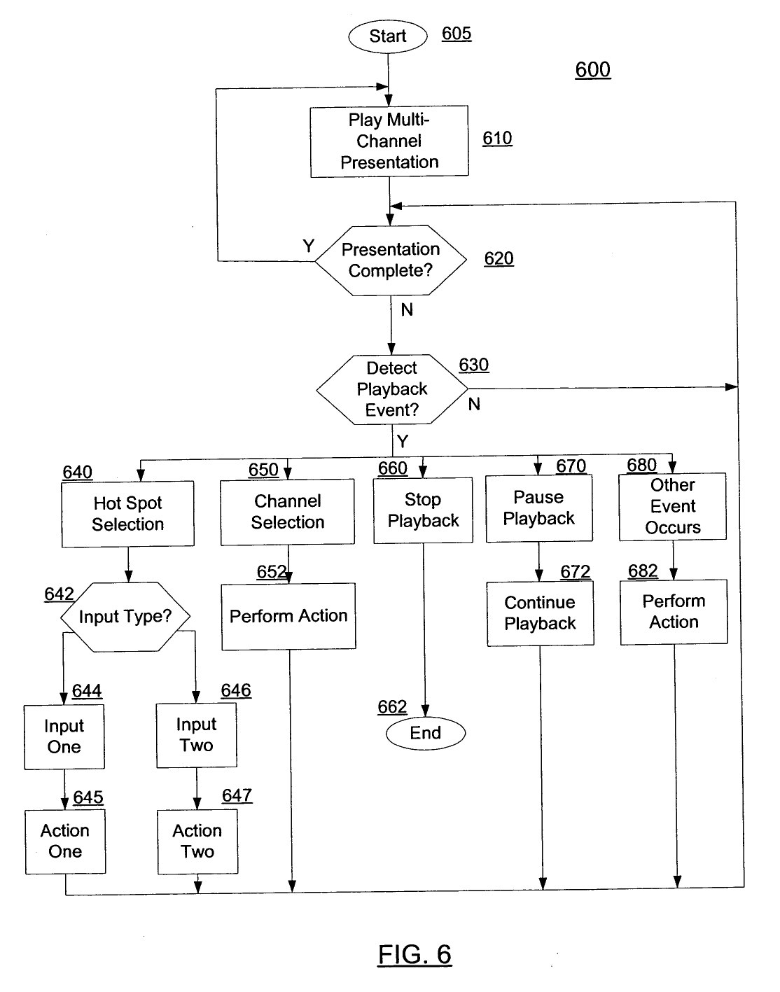

A method 600 for playback of an interactive multi-channel document in accordance with one embodiment of the present invention is illustrated in FIG. 6. Method 600 begins with start step 605. Playback of the multi-channel interface is then initiated in step 610.

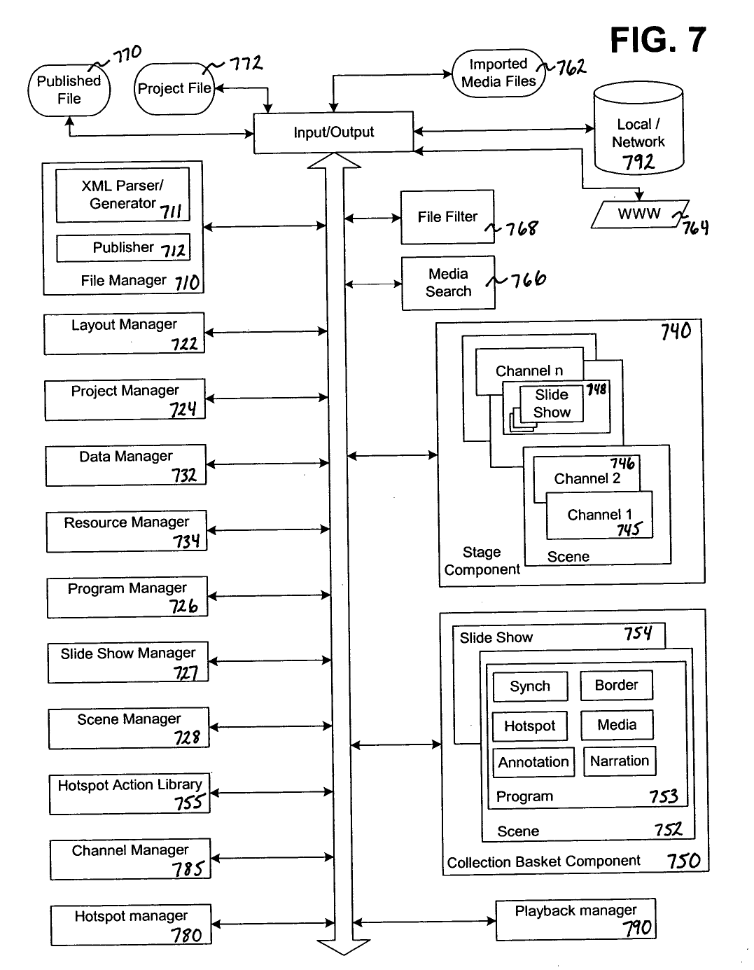

In one embodiment, a playback of a digital document is authoring or publication mode is handled by the playback manager of FIG. 7. When digital document playback is triggered, either by user input or by some other event, the playback manager begins playback by first opening a digital document project file. In one embodiment, the project file is loaded into cache memory. Once the project file is loaded, it is read by the playback manager. In one embodiment, the project file is in XML format. In this case, reading the XML formatted project file may include parsing the project file to retrieve information from the file. After reading and/or parsing the project file, the data from the project file is provided to various manager components of the MDMS as appropriate. For example, if the project file includes a slide show, data regarding the slide show is provided to the slide show manager. Other managers that may receive data in the MDMS the hot spot, channel, scene, program, resource, data, layout and project managers. In publish mode, wherein a user is not permitted to edit the digital document, no collection basket is generated. In other modes, a collection basket may be provided along with programs as they were when the project file was saved.

After reading and loading managers of the MDMS, the media files are referenced. This may include determining the location of the media files referenced in the project file, confirming they are accessible (i.e., the path for the media is correct), and providing the reference to the program objects and optionally other managers in the MDMS. Playback of the digital document is then initiated by the playback manager. In one embodiment, separate input or events are required for loading and playback of a digital document. During playback, the MDMS may load all media files completely into the cache or load the media files only as they are needed during document playback. For example, the MDMS may load media content associated with a start scene immediately at the beginning of document playback, but only load media associated with a second scene or a hot spot action upon the need to show the respective media during document playback. In one embodiment, the MDMS may include embedded media players or a custom media player to display certain media formats. For example, the MDMS may include an embedded player that operates to play QuickTime compatible media or Real One compatible media. The MDMS may be configured to have an embedded media player in each channel or a single media player playing media for all channels.

The system of the present invention may have a project file currently in cache memory that can be executed. This may occur if a project file has been previously opened, created, or edited by a user. Operation of method 600 then continues to step 620. In another embodiment, the document exists as an executable file. In this case, a user may initiate playback by running the executable file. Upon running the executable, the project file is placed into cache memory of the computer. The project file may be a text file, binary file, or in some other format. The project file contains information in a structured format regarding stage, scene and channel settings, as well as subject matter corresponding to different channels. An example of a project file XML format in accordance with one embodiment of the present invention is provided in Appendix A.

The project file of Appendix A is only an example of one possible project file and not intended to limit the scope of the present invention. In one embodiment, the content, properties and preferences retrieved from the parsed project file are stored in cache memory.

Channel content can be managed during document playback in several ways in accordance with the present invention. In one embodiment, channel content is preloaded. In this case, all channel content is loaded before the document is played back. Thus, at a time just before document playback begins, the document and all document content is located locally on the machine. In another embodiment, only multi-media files such as video are loaded prior to document playback. The files may be loaded into cache memory from a computer hard disk, from over a network, or some other source. Preloading of channel content uses more memory than channel content on request method, but may be desirable for slower processors that wouldn't be able to keep up with channel content requests during playback. In another embodiment, the media files that make up the channel content are loaded on request. For example, media files that are imported could be implemented as externally linked. In this case, only a portion of the channel content is loaded into cache memory before playback. Additional portions of channel content are loaded as requested by the multi-channel document management system (MDMS) of FIG. 7. In one embodiment, channel content is received as streaming content from over a network. Content data may be received as a channel content stream from a server or machine over the network, the content data then placed into cache memory as it is received. During content on-request mode, content in cache memory that has already been presented to a user is cycled out of cache memory to make room for future content. As content is presented, the system constantly requests future content data, processed current data, and replaces data associated with content already displayed that is still in cache memory, all in a cyclic manner. In one embodiment, the source of the requested data is a data stream received from over a network. The network may be a LAN, WAN, the Internet, or any other network capable of providing streaming data. The load on request method of providing channel content during playback uses less memory during document playback, but requires a faster processor to handle the streaming element. In one embodiment, the document will request an amount of future content that fills a predetermined amount of cache memory. In another amount, the document will request content up to a certain time period ahead of the currently provided content during document playback.

Once playback of the document has commenced in step 610, playback manager Z90 determines if playback of the document is complete at step 620. In one embodiment, playback of a document is complete if the content of all content channels has been played back entirely. In another embodiment, playback is complete when the content of one primary content channel has been played back to completion. In this embodiment, the primary content channel is a channel selected by the author. Other channels in a document may or may not play back to completion before the primary content channel content plays to completion. If playback has completed, then operation returns to step 610 where document playback begins again. If playback is not complete at step 620, then operation continues to step 630 where playback system 760 determines whether or not a playback event has occurred.

If no playback event is received within a particular time window at step 630, then operation returns to step 620. In one embodiment, more than one type of playback event could be received at step 630. As shown, input could be received as selection of a hot spot, channel selection, stop playback, or pause of playback. If input is received indicating a user has selected a hot spot as shown in step 640, operation continues to step 642. In one embodiment, the playback system 760 determines what type of input is received at step 642 and configures the document with the corresponding action as determined by playback system 760. The method 600 of FIG. 6 illustrates two recognized input types at step 644 and step 646. The embodiment illustrated in FIG. 6 is intended to be only an example of possible implementations, and more or fewer input types can be recognized accordingly. As shown in method 600, if a first input has been detected at a hot spot at step 644, then a first action corresponding to the first input is implemented in the multi-channel interface as shown at step 645. In one embodiment, a first input may include placing a cursor over a hot spot, clicking or double clicking a button on a mouse device when a cursor is placed over a hot spot, providing input through a keyboard or touch screen, or otherwise providing input to select a hot spot. The first action may correspond to a visual indicator indicating that a hot spot is present at the location selected by the user, text appearing in a supplemental channel or content channel, video playback in a supplemental channel or content channel, or some other action. In one embodiment, the visual indicator may include a highlighted border around the hot spot indicating that the user has selected a hot spot. A visual indicator may also include a change in the cursor icon or some other visual indicator.

In one embodiment, the action may continue after the input is received. An example of a continued action may include the playback of a video or audio file. Another example of a continuing action is a hot spot highlight that remains after the cursor is removed from the hot spot. In this embodiment, an input including placing a cursor over a hot spot may cause an action that includes providing a visible highlight around the hot spot. The visible highlight remains around the hot spot whether the cursor remains on the hot spot or not. Thus, the hot spot is locked as the highlight action continues. In another embodiment, the implemented action may last only as long as the input is received or a specified time afterwards. An example of this type of action may include highlighting a hot spot or changing a cursor icon while a cursor is placed over the hotspot. If a second input has been detected at a hot spot as shown at step 646, a second action corresponding to the second input is implemented by playback system 760 as shown in step 647. After an action corresponding to the particular input has been implemented, operation continues to step 620.

Input can also be received at step 630 indicating that a channel within the multi-channel interface has been selected as shown in step 650. In this case, operation continues from step 650 to step 652 where an action is performed. In one embodiment, the action may include displaying a visual indicator. The visual indicator may indicate that a user has provided input to select the particular channel selected. An example of a visual indicator may include a highlighted border around the channel. In another embodiment, the action at step 652 may include providing supplementary media content within a supplementary channel. Supplementary channels may be located inside or outside a content channel. After an action has been implemented at step 652, operation continues to step 620.

Other events may occur at step 680 besides those discussed with reference to steps 640-670. The other events may include user-initiated events and non-user initiated events. User initiated events may include scene changes that result from user input. Non-user initiated events may include timer events, including the start or expiration of a timer. After an event is detected at step 680, an appropriate action is taken at step 682. The action at step 682 may include a similar action as discussed with reference to step 645, 647, 652 or elsewhere herein.

Though not pictured in method 600 of FIG. 6, input may also be received within a map channel as input selecting an icon within the map channel. In this case, operation may continue in a manner similar to that described for hot spot selection.

Input can also be received at step 630 indicating a user wishes to end playback of the document as shown in step 660. If a user provides input indicating document playback should end, then playback ends at step 660 and operation of method 600 ends at step 662. A user may provide input that pauses playback of the document at step 670. In this case, a user may provide a second input to continue playback of the document at step 672. Upon receiving a second input at step 672, operation continues to step 620. Though not shown in method 600, a user may provide input to stop playback after providing input to pause playback at step 670. In this case, operation would continue from step 670 to end step 662. In another embodiment not shown in FIG. 6, input may also be received through user manipulation of a control bar within the interface. In this case, appropriate actions associated with those input will be executed accordingly. These actions may be predefined or implemented as a user plug-in option. For user plug-in, the MDMS may support a scripting engine or plug-in object compiled using a programming language.

A multichannel document management system (MDMS) may be used for generating, playback, and editing an interactive multi-channel document. FIG. 7 is an illustration of an MDMS 700 in accordance with one embodiment of the present invention. MDMS 700 includes file manager 710, which includes an XML parser and generator 711 and a publisher 712, layout manager 722, project manager 724, program manager 726, slide show manager 727, scene manager 728, data manager 732, resource manager 734, stage component 740, collection basket component 750, hot spot action library 755, hot spot manager 780, channel manager 785, playback manager 790, media search component 766, file filter 768, local network 792, and an input output component that communicates with the world wide web 764, imported media files 762, project file 772, and published file 770. Components of system 700 can be implemented as hardware, software, or a combination of both. System modules 710-780 are discussed in more detail below. In one embodiment, the software component of the invention may be implemented in an object-based language such as JAVA, produced by Sun Microsystems of Mountain View, Calif., or a script-based language software such as “Director”, produced by Macromedia, Inc., of San Francisco, Calif. In one embodiment, the script-based software is operable to create an interface using a scripting language, the scripting language configurable to define an object and place a behavior to the object.

MDMS 700 may be implemented as a stand-alone application, client-server application, or internet application. When implemented in JAVA, the MDMS can operate on various operating systems including Microsoft Windows, UNIX, Linux, and Apple Macintosh. As a stand-alone application, the application and all content may reside on a single machine. In one embodiment, the media files presented in the document channels and referred to by a project file may be located at a location on the computer storing the project file or accessible over a network. In another embodiment, a stand-alone application may access media files from a URL location. In a client-server application, the components comprising the MDMS may reside on the client, server, or both. The client may operate similarly to the stand-alone application. A user of the document or author creating a document may interact with the client end. In one embodiment, a server may includes a web server, video server or data server. In another embodiment, the server could be implemented as part of a larger or more complex system. The larger system may include a server, multiple servers, a single client or multiple clients. In any case, a server may provide content to the MDMS components on the client. When providing content, the server may provide content to one or more channels of a document. In one embodiment, the server application may be a collection of JAVA servlets. A transportation layer between the server and client can have any of numerous implementations, and is not considered germane to the present invention. As an internet application, the MDMS client component or components can be implemented as a browser-based client application and deployed as downloadable software. In one embodiment, the client application can be deployed as one or more JAVA applets. In another embodiment, the MDMS client maybe an application implemented to run within a web browser. In yet another embodiment, the MDMS client may be running as a client application on the supporting Operating System environment.

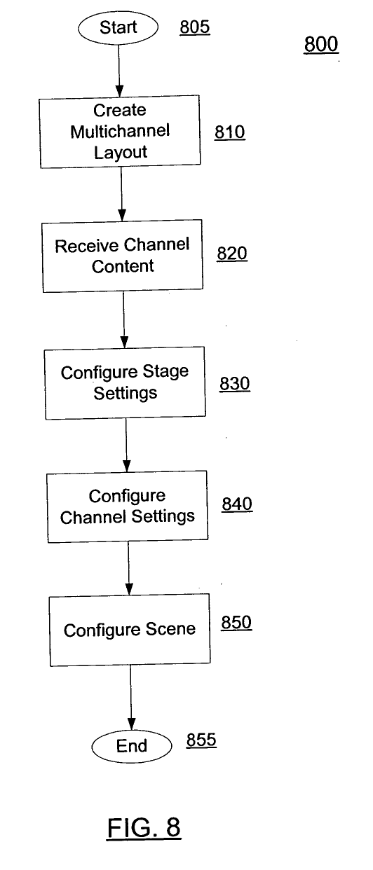

A method 800 for generating an interactive multi-channel document in accordance with one embodiment of the present invention is shown in FIG. 8. In the embodiment discussed with reference to method 800, the digital document is authored using an interface created with the stage layout. For example, if a stage layout is to have five channels, the authoring interface is built into the five channels. Method 800 can be used to generate a new document or edit an existing document. Whether generating a new document or editing an existing document, not all the steps of method 800 need to be performed. Further, when generating a new document or editing an existing document, steps 820-850 can be performed in any order. In one embodiment, document settings are stored in cache memory as the file is being created or edited. The settings being created or edited can be saved to a project file at any point during the operation of method 800. In one embodiment, method 800 is implemented using an interactive graphic user interface (GUI) that is supported by the system of the present invention.

In one embodiment, user input in method 800 may be provided through a series of drop down menus or some other method using an input device. In one embodiment, any stage and channel settings for which no input is received will have a default value in a project file. In one embodiment, as stage and channel settings are received, the stage settings in the project file are updated accordingly.

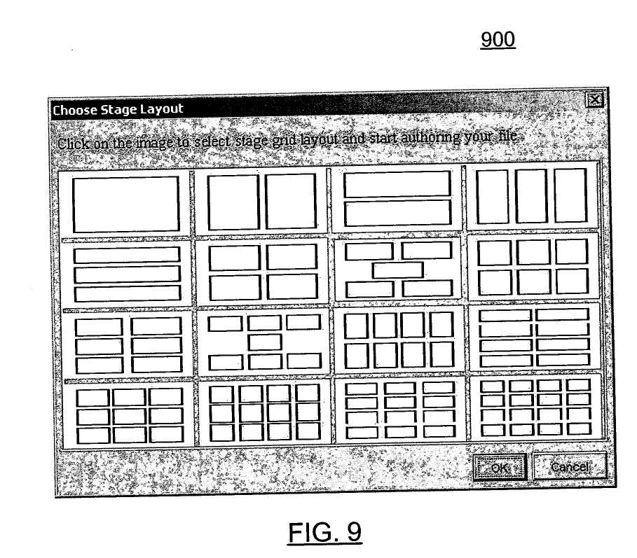

Method 800 begins with start step 805. A multi-channel interface layout is then created in step 810. In one embodiment, creating a layout includes allowing an author to create a channel size, the number of channels to place in the layout, and the location of each channel. In another embodiment, creating a layout includes receiving input from an author indicating which of a plurality of pre-configured layouts to use as the current layout. An example of pre-configured layouts for selection by an author is shown in FIG. 9. In one embodiment, once an interface layout is created, a project file is created and configured with stage settings and default values for the remainder of the document settings. As channel settings, stage settings, mapping data objects and properties, hot spot properties, and other properties and settings are configured, the project file is updated with the corresponding values. If no properties or settings are configured, project file default values are used.

Next, channel content is received by the system in step 820. In one embodiment, channel content is routed to a channel filter system. Channel content may be received from a user or another system. A user may provide channel content input to the system using an input device. This may include providing file location information directly into a window or open dialogue box, dragging and dropping a file icon into a channel within the multi-channel interface, specifying a location over a network, such as a URL or other location, or some other means of providing content to the system. When received, the channel filter system 720 determines the channel content type to be one of several types of content. The determination of channel content may be done automatically or with user input. In one embodiment, the types of channel content include video, 3D content, an image, a set of static images or slide show, web page content, audio or text. When receiving channel content automatically, the system may determine the content type automatically. Video format types capable of being detected may include but are not limited to AVI, MOV, MP2, MPG, and MPM. Audio format types capable of being detected may include but are not limited to AIF, AIFF, AU, FSM, MP3, and WAV. Image format types capable of being detected may include but are not limited to GIF, JPE, JPG, JFIF, BMP, TIF, and TIFF. Text format types capable of being detected may include but are not limited to TXT. Web page content may include html, java script, JSP or ASP. Additional types and formats of video, audio, text, images, slide, and web content types and formats may be used or added as they are developed as known by those skilled in the art. This may be performed by checking the type of channel content file against a list of known file types. When receiving the channel content with author input, the user may indicate the corresponding channel content type. If the channel filter system cannot determine the content type, the system may query the author to specify the content type. In this case, an author may indicate whether the content is video, text, slides, a static image, or audio.

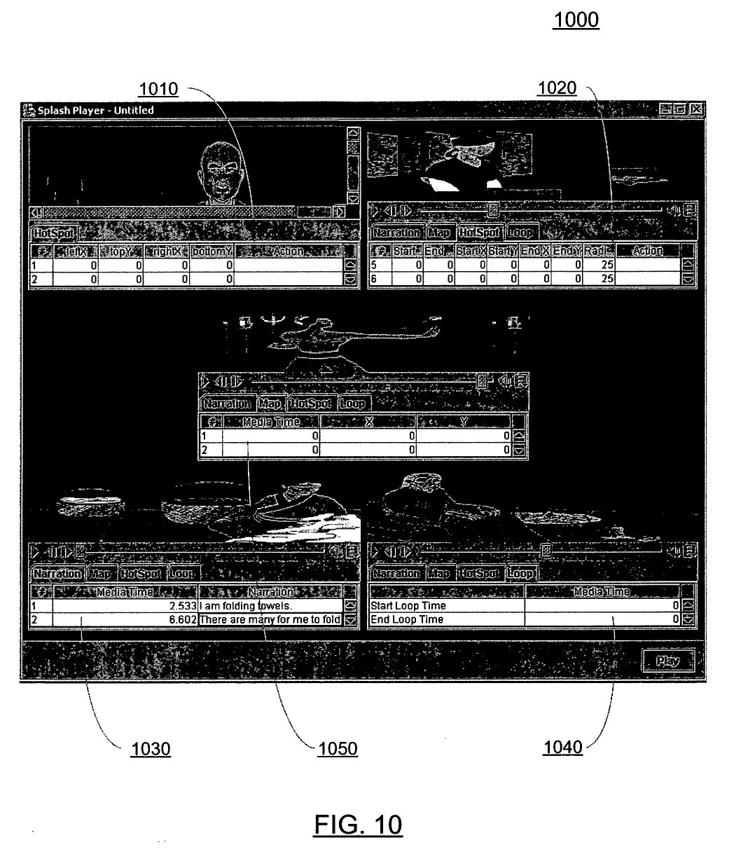

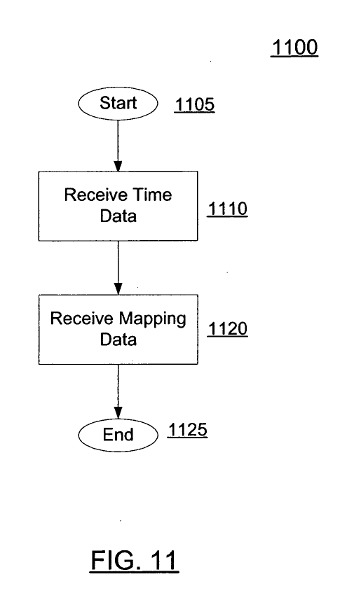

In one embodiment, only one type of visual channel content may be received per channel. Thus, only one of video, an image, a set of images, or text type content may be loaded into a channel. However, audio may be added to any type of visual-based content, including such content configured as a map channel, as an additional content for that channel. In one embodiment, an author may configure at what time during the presentation of the visual-based content to present the additional audio content. In one embodiment, an author may select the time at which to present the audio content in a manner similar to providing narration for a content channel as discussed with respect to FIG. 10.

In one embodiment where the received information is the location of channel content, the location of the channel content is stored in cache memory. If a project file is saved, then the locations are saved to the project file as well. This allows the channel content to be accessed upon request during playback and editing of a document. In another embodiment, when the content location is received, the content is retrieved, copied and stored in a memory location. This centralization of content files is advantageous when content files are located in different folders or networks and provides for easy transfer of a project file and corresponding content files. In yet another embodiment, the channel content may be pre-loaded into cache memory so that all channel content is available whether requested or not. In addition to configuring channel content as a type of content, a user may indicate that a particular channel content shall be designated as a map channel. Alternatively, a user may indicate that a channel is a map channel when configuring individual channels in step 840. In one embodiment, as channel content is received and characterized, the project file is updated with this information accordingly.

After receiving channel content, stage settings may be configured by a user in step 830. Stage settings may include features of the overall document such as stage background color, channel highlight color, channel background color, background sound, forward and credit text, user interface look and feel, timer properties, synchronized loop-back and automatic loop-back settings, the overall looping property of the document, the option of having an overall control bar, and volume settings. In one embodiment, stage settings are received by the system as user input. Stage background color is the color used as the background when channels do not take up the entire space of single page document. Channel highlight color is the color used to highlight a channel when the channel is selected by a user. Channel background color is the color used to fill in a channel with no channel content the background color when channel content is text. User interface look and feel settings are used to configure the document for use on different platforms, such as Microsoft Windows, Unix, Linux and Apple Macintosh platforms.

In one embodiment, a timer function may be used to initiate an action at a certain time during playback of the document. In one embodiment, the initiating event may occur automatically. The automatic initiating event may be any detectable event. For example, the event may be the completed playback of channel content in one or more content or supplementary channels or the expiration of a period of time. In another embodiment, the timer-initiating event may be initiated by user input. Examples of user-initiated events may include but are not limited to the selection of a hot spot, selection of a mapping object, selection of a channel, or the termination of document playback. In another embodiment, a register may be associated with a timer. For example, a user may be required to engage a certain number of hot spots within a period of time. If the user engages the required hot spots before the expiration of the timer, the timer may be stopped. If the user does not engage the hot spots before expiration of the timer, new channel content may be displayed in one or more content windows. In this case, the register may indicate whether or not the hot spots were all accessed. In one embodiment, the channel content may indicate the user failed to accomplish a task. Applications of a timer in the present invention include, but are not limited to, implementing a time limit for administering an examination or accomplishing a task, providing time delayed content, and implementing a time delayed action. Upon detecting the expiration of the timer, the system may initiate any document related action or event. This may include changing the primary content of a content channel, changing the primary content of all content channels, switching to a new scene, triggering an event that may be also be triggered by a hot spot, or some other type of event. Changing the primary content of a content channel may include replacing a first primary content with a second primary content, starting primary content in an empty content channel, stopping the presentation of primary content, providing audio content to a content channel, or other changes to content in a content channel.

Channel settings may be configured at step 840. As with stage settings, channel settings can be received as user input through an input device. Channel settings may include features for a particular channel such as color, font, and size of the channel text, forward text, credit text, narration text, and channel title text, mapping data for a particular channel, narration data, hot spot data, looping data, the color and pattern of the channel borders when highlighted and not highlighted, settings for visually highlighting a hot spot within the channel, the shape of hot spots within a channel, channel content preloading, map channels associated with the channel, image fitting settings, slide time interval settings, and text channel editing settings. In one embodiment, settings relating to visually highlighting hot spots may indicate whether or not an existing hot spot should be visually highlighted with a visual marker around the hot spot border within a channel. In one embodiment, settings relating to shapes of hot spots may indicate whether hot spots are to be implemented as circles or rectangles within a channel. Additionally, a user may indicate whether or not a particular channel shall be designated as a map channel. Channel settings may be configured one channel at a time or for multiple channels at a time, and for primary or supplementary channels. In one embodiment, as channel settings are received, the channel settings are updated in cache memory accordingly.

In one embodiment, an author may configure channel settings that relate to the type of content loaded into the channel. In one embodiment, a channel containing video content may be configured to have settings such as narration text turned on or off, maintain the original aspect ratio of the video. In an embodiment, a channel containing an image as content may be configured to have settings including fitting the image to the size of the channel and maintaining the aspect ratio of the image. In an embodiment, a channel containing audio as content may be configured to have settings including suppressing the level of a background audio channel when the channel audio content is presented. In an embodiment, a channel containing text as content may be configured to have settings including presenting the text in UNICODE format. In another embodiment, text throughout the document may be handled in UNICODE format to uniformly provide document text in a particular foreign language. When configured in UNICODE, text in the document may appear in languages as determined by the author.

A channel containing a series of images or slides as content may be configured to have settings relating to presenting the slides. In one embodiment, a channel setting may determine whether a series of images or slides is cycled through automatically or based on an event. If cycled through automatically, an author may specify a time interval at which a new image should be presented in the channel. If the images in a channel are to be cycled through upon the occurrence of an event, the author may configure the channel to cycle the images based upon the occurrence of a user initiated event or a programmed event. Examples of a user-initiated event include but are not limited to selection of a mapping object, hot spot, or channel by a user. An example of a programmed event may include but are not limited to the end of a content presentation within a different channel and the expiration of a timer.

FIG. 10 illustrates an interface 1000 for configuring channel settings in accordance with one embodiment of the present invention. For purposes of example, interface 1000 depicts five content channels consisting of two upper channels 1010 and 1020, two lower channels 1030 and 1040, and one middle channel 1050. When generating or editing a document, a user may provide input to initiate a channel configuration mode for any particular channel. In this embodiment, once channel configuration mode is selected, an editing tool allows a user to configure the channel. In the embodiment shown in FIG. 10, the editing tool is an interface that appears in the channel to be configured. Once in channel configuration mode, the user may select between configuring narration, map, hot spot, or looping data for the particular channel.

In FIG. 10, the lower left channel 1030 is configured to receive narration data for the video within the particular channel. In the embodiment shown, narration data may be entered by a user in table format. The table provides for entries of the time that the narration should appear and the narration content itself. In one embodiment, the time data may be entered directly by a user into the table. Alternatively, a user may provide input to select a narration entry line number, provide additional input to initiate playback of the video content in the channel, and then provide input to pause the video at some desired point. The desired point will correspond to a single frame or image. When paused, the media time at which the video was paused will automatically be entered into the table. In the lower left channel 1030 of interface 1000, entry number one is configured to display “I am folding towels” in a supplementary channel associated with content channel 1030 at a time 2.533 seconds into video playback. At a time associated with 6.602 seconds into playback of the document, the supplementary channel associated with content channel 1030 will display “There are many for me to fold”. As discussed above, the location of the supplementary channel displaying text may be in the content channel or outside the content channel. In one embodiment, narration associated with a content channel can be configured to be displayed or not displayed through a corresponding channel setting.

In another embodiment, narration data may be configured to display narration content in a supplementary channel based upon the occurrence of an author-configured event. In this embodiment, the author may configure the narration to appear in a supplemental channel based upon document actions described herein, including but not limited to the triggering or expiration of a timer and user selection of a channel, mapping object, or hot spot (without relation to the time selected).

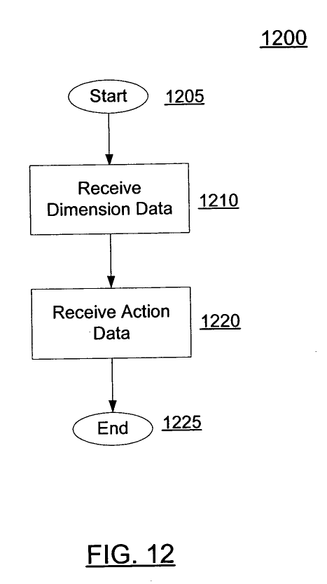

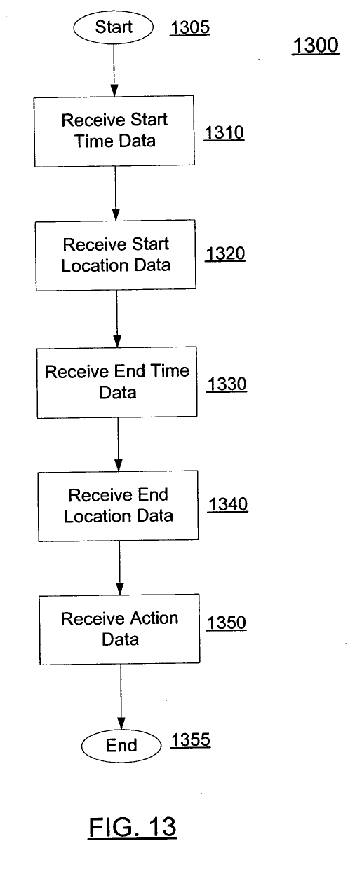

The lower right channel of interface 1000 is configured to have a looping characteristic. In one embodiment, looping allows an author to configure a channel to loop between a start time and an end time, only to proceed to a designated target time in the media content if user input is received. To configure a looping time, an author may enter the start loop time, end loop time, and a target or “jump to” time for the channel. In one embodiment, upon document playback, playback of the looping portion of the channel content is initiated. When a user provides input selecting the channel, playback of the first portion “jumps” to the target point indicated by the author. Thus, a channel A may have channel content consisting of video lasting thirty seconds, a start loop setting of zero seconds and end loop setting of ten seconds, and target point of eleven seconds. Initially, the channel content will be played and then looped back to the beginning of the content after the first ten seconds have been played. Upon receiving input from a user indicating that channel A has been selected, playback will be initiated at the target time of eleven seconds in the content. At this point, playback will continue as the next looping setting is configured or until the end of content if no further loop-back characteristic is configured. The configuration of map channels, mapping data and hot spot data is discussed in more detail below with respect to FIGS. 11 and 12.

In one embodiment of the present invention, configuring channel settings may include configuring a channel within the multi-channel interface to serve as a map channel. A map channel is a channel in which mapping icons are displayed as determined by mapping data objects. In one embodiment, the channel in which mapping data objects are associated with differs from the map channel itself. In this embodiment, any channel may be configured with a mapping data object as long as the channel is associated with a map channel. The mapping data object is used to configure a mapped icon on the map channel. A mapped icon appears in the map channel according to the information in the mapping data object associated with another channel. The mapping data object configured for a channel may configure movement in a map, ascending or descending values in a graph, or any other dynamic or static element.

Configuring mapping data objects for a channel in accordance with one embodiment of the present invention is illustrated in method 1100 of FIG. 11. In this embodiment, mapping data objects are generated based on input received in an interface such as that illustrated in channel 1050 of FIG. 10. Method 1100 illustrates a method for receiving information through such an interface. Method 1100 begins with start step 1105. Next, time data is received in step 1110. The time data corresponds to the time during channel content playback at which the mapping object should be displayed in the map channel. For example, an interface 1000 for configuring channels for a multi-channel interface, in accordance with one embodiment of the present invention, is shown in FIG. 10. In the embodiment shown, the center channel 1050 is set to be configured with mapping data. As shown, the user may input the time that the mapping object will be displayed in the designated map channel under the “Media Time” column. The time entered is the time during playback of the channel content at which an object or mapping point is to be displayed in the map channel. Though the mapping time and other mapping data for the center channel are entered into an interface within the center channel, the actual mapping will be implemented in a map channel as designated by the author. Thus, any of the five channels shown in FIG. 10 could be selected as the map channel. In this embodiment, the mapping data entered into the center channel will automatically be applied to the selected map channel. In one embodiment, the mapping time may be chosen by directly entering a time into the interface directly. In another embodiment, the mapping time may be entered by first enabling the mapping configuration interface shown channel 1050 of FIG. 10, providing an input to select a data entry line in the interface, providing input to initiate playback of the channel content of the channel, and then providing input to pause channel content playback, thereby selecting the time in content playback at which the mapping object should appear in the map channel. In this embodiment, the time associated with the selected point in channel content playback is automatically entered to the mapping interface of the channel for which mapping data is being entered.

After time data is received in step 1110, mapping location data is received by the system in step 1120. In one embodiment, the mapping location data is a two dimensional location corresponding to a point within the designated map channel. In the embodiment shown in FIG. 10, the two dimensional mapping location data is entered in the interface of the center channel 1050 as an x,y coordinate. In one embodiment, an author may provide input directly into the interface to select an x,y coordinate. In another embodiment, an author may select a location within the designated map channel using an input device such as a touch-screen monitor, mouse device, or other input device. Upon selecting a location within the designated map channel, the coordinates of the selected location in the map channel will appear automatically in the interface within the channel for which mapping location data is being configured. Upon playback of a document with a map channel and mapping data, a point or other object will be plotted as a mapped icon on the map channel at the time and coordinates indicated by the mapping data. Several sets of mapping points and times can be entered for a channel. In this case, when successive points are plotted on a map channel, previous points are removed. In this embodiment, the appearance of a moving point can be achieved with a series of mapping data having a small change in location and a small change in time. In another embodiment, mapping icons can be configured to disappear from a map channel. Removing a mapped icon may be implemented by receiving input indicating a start time and end time for displaying a mapping object in a map channel. Once all mapping data has been entered for a channel, method 1100 ends at step 1125. In one embodiment, an author may configure a start time and end time for the mapped icon to control the time an object is displayed on a map channel.

In another embodiment, an author may configure mapping data, from which the mapping data object is created in part, such that a mapping icon is displayed in a map channel based upon the occurrence of an event during document playback. In this embodiment, the author may configure the mapping icon to appear in a map channel based upon document actions described herein, including but not limited to the triggering or expiration of a timer and user selection of a channel or hot spot (without relation to the time selected).

In another embodiment, when an author of a digital document determines that a channel is to be a mapping channel, he provides input indicating so in a particular channel. Upon receiving this input, the authoring software (described in more detail later) generates a mapping data object. In this object oriented embodiment of the present invention, the mapping data object can be referenced by a program object associated with the mapping channel, a channel in the digital document associated with the object or character icon being mapped, or both. In another embodiment, the mapping channel or the channel associated with the mapped icon can be referenced by the mapping data object. The mapping data itself may be referenced by the mapping data object or contained as a table, array, vector or stack. When the mapping channel utilizes three dimensional technology as discussed herein to implement a map, the data mapping object is associated with three dimensional data as well, including x,y,z coordinates (or other 3D mapping data), lighting, shading, perspective and other 3D related data as discussed herein and known to those skilled in the art.

In another embodiment, configuring a channel may include configuring a hot spot property within a channel. A two dimensional hot spot may be configured for any channel having visual based content including a set of images, an image, text or video, 3D content, including such channels configured as a map channel, in a multi-channel interface in accordance with the present invention. In one embodiment, a hot spot may occupy an enclosed area within a content channel, whereby the user selection of the hot spot initiates an action to be performed by the system. The action initiated by the selection of the hot spot may include starting or stopping media existing in another channel, providing new media to or removing media from a channel, moving media from one channel to another, terminating document playback, switching between scenes, triggering a timer to begin or end, providing URL content, or any other document event. In another embodiment, the event can be scripted in a customized manner by an author. The selection of the hot spot may include receiving input from an input device, the input associated with a two-dimensional coordinate within the area enclosed by the hot spot. The hot spot can be stationary or moving during document playback.

A method 1200 for configuring a stationary hot spot property in accordance with one embodiment of the present invention is shown in FIG. 12. In one embodiment, while editing channel settings, an author may configure a channel interface with a stationary hot spot data as shown in channel 1010 of FIG. 10. In the embodiment shown, timing data is not entered into the interface and the hot spot exists throughout the presentation of the content associated with the channel. The hot spot is configured by default to exist for the entire length of time that the content appears in the particular channel. In anther embodiment, a stationary hot spot can be configured to be time-based. In this embodiment, the stationary hot spot will only exist in a channel for a period of time as configured by the author. Configuring a time-based stationary hot spot may be performed in a manner similar to configuring time-based properties for a moving hot spot as discussed with respect to method 1300. Stationary hot spots may be configured for visual media capable of being implemented over a period of time, including but not limited to time-based media such as an image, a set of images, and video.

Method 1200 begins with start step 1205. Next, hot spot dimension data is received in step 1210. In one embodiment, dimension data includes a first and second two dimensional point, the points comprising two opposite corners of a rectangle. The points may be input directly into an interface such as that shown in channel 1010 of FIG. 10. In another embodiment, the points may be entered automatically after an author provides input selecting the first and second point in the channel. In this case, the author provides input to select an entry line number, then provides input to select a first point within the channel, and then provides input to select the second point in the channel. As the two points are selected in the channel, the two dimensional coordinates are automatically entered into the interface. For example, a user may provide input to place a cursor at the desired point within a channel. The user may then provide input indicating the coordinates of the desired point should be the first point of the hot spot. When the input is received, the coordinates of the selected location are retrieved and stored them as the initial point for the hot spot. In one embodiment, displays the selected coordinates are displayed in an interface as shown in channel 1010 of FIG. 10. Next, the user may provide input to place the cursor at the second point of the hot spot and input that configures the coordinates of the point as the second point. In one embodiment, the selected coordinates are displayed in an interface as they are selected by a user as shown in channel 1010 of FIG. 10.

In another embodiment, a stationary hot spot may take the shape of a circle. In this embodiment, dimension data may include a first point and a radius to which the hot spot should be extended from the first point. A user can enter the dimensional data for a circular hot spot directly into an interface table or by selecting a point and radius in the channel in a manner similar to selecting a rectangular hot spot.

After dimensional data is received in step 1210, action data is received in step 1220. Action data specifies an action to execute once a user provides input to select the hot spot during playback of the document. The action data may be one of a set of pre-configured actions or an author configured action. In one embodiment, a pre-configured action may include a highlight or other visual representation indicating that an area is a hot spot, a change in the appearance of a cursor, playback of video or other media content in a channel, displaying a visual marker or other indicator within a channel of the document, displaying text in a portion of the channel, displaying text in a supplementary channel, selection of a different scene, stopping or starting a timer, a combination of these, or some other action. The inputs that may trigger an action may include placing a cursor over a hot spot, a single click or double click of a mouse device while a cursor is over a hot spot, an input from a keyboard or other input device while a cursor is over a hot spot, or some other input. Once an action has been configured, method 1200 ends at step 1225.

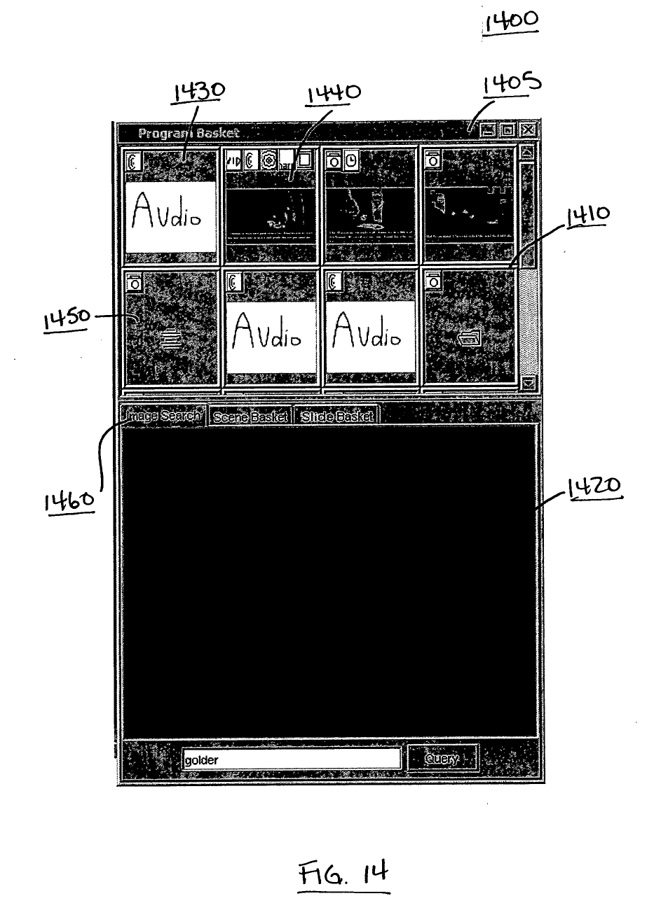

A method 1300 for configuring a moving hot spot program property in accordance with one embodiment of the present invention is illustrated in FIG. 13. Configuring a moving hot spot property in accordance with the present invention involves determining a hot spot area, a beginning hot spot location and time and an ending hot spot location and time. The hot spot is then configured to move from the start location to the ending location over the time period indicated during document playback. Method 1300 begins with start step 1305. Next, beginning time data is received by the system in step 1310. In one embodiment, an author can enter beginning time data directly into an interface or by selecting a time during playback of channel content. The starting location data for the hot spot is then received by the system at step 1320. In one embodiment, starting location data includes two points that form opposite corners of a rectangle. The points can be entered directly into a hot spot configuration interface or by selecting the points within the channel that will contain the hot spot, similar to the first and second point selection of step 1210 of method 1200. In another embodiment, the hot spot is in the shape of a circle. In this case, the starting location data includes a center point and radius data. In a manner similar to that of method 1200, an author may directly enter the center point and radius data into an interface for configuring a moving circular hot spot such as the interface illustrated in channel 1020 in FIG. 10. Alternatively, an author may select the center point and radius in the channel itself and the corresponding data will automatically be entered into such an interface. Next, the end time data is received at step 1330. As with the start time, the stop time can be entered by providing input directly into a hot spot interface associated with the channel or by selecting a point during playback of the channel content. The ending point data is then received at step 1340 in a similar manner as the starting point data. Action data is then received in step 1350. Action data specifies an action to execute once a user provides input to select the hot spot during playback of the document. The action data may be one of a set of pre-configured actions or an author configured action, as discussed in relation to method 1200. Receiving a hot spot in step 1350 is similar to receiving a hot spot in step 1220 of method 1200 and will not be repeated herein. Operation of method 1300 ends at step 1355. Multiple moving hot spots can be configured for a channel by repeating method 1300.

In yet another embodiment, an author may dynamically create a hot spot by providing input during playback of a media content. In this embodiment, an author provides input to select a hot spot configuration mode. Next, the author provides input to initiate playback of the media content and provides a further input to pause playback at a desired content playback point. At the desired playback point, an author may provide input to select a initial point in the channel. Alternatively, the author need not provide input to pause channel content playback and need only provide input to select an initial point during content playback for a channel. Once an initial point is selected, content playback continues from the desired playback point forward while an author provides input to formulate a path beginning from the initial point and continuing within the channel. As the author provides input to formulate a path within the channel during playback, location information associated with the path is stored at determined intervals. In one embodiment, an author provides input to generate the path by manipulating a cursor within the channel. As the author moves the cursor within the channel, the system samples the channel coordinates associated with the location of the cursor and enters the coordinates into a table along with their associated time during playback. In this manner, a table is created containing a series of sampled coordinates and the time during playback each coordinate was sampled. Coordinates are sampled until the author provides an input ending the hot spot configuration. In one embodiment, hot spot sampling continues while an author provides input to move a cursor through a channel while pressing a button on a mouse device. In this case, sampling ends when the user stops depressing a button on the mouse device. In another embodiment, the sampled coordinate data stored in the database may not correspond to equal intervals. For example, the system may configure the intervals at which to sample the coordinate data as a function of the distance between the coordinate data. Thus, if the system detected that an author did not provide input to select new coordinate data over a period of three intervals, the system may eliminate the data table entries with coordinate data that are identical or within a certain threshold.

Though hot spots in the general shape of circles and rectangles are discussed herein, the present invention is not intended to be limited to hot spots of any these shapes. Hot spot regions can be configured to encompass a variety of shapes and forms, all of which are considered within the scope of the present invention. Hot spot regions in the shapes of a circle and rectangle are discussed herein merely for the purpose of example.

During playback, a user may provide input to select interactive regions corresponding to features including but not limited to a hot spot, a channel, mapping icons, including object and character icons, and object icons in mapping channels. When a selecting input is received, the MDMS determines if the selecting input corresponds to a location in the document associated with a location configured to be an interactive region. In one embodiment, the MDMS compares the received selected location to regions configured to be interactive regions at the time associated with the user selection. If a match is found, then further processing occurs to implement an action associated with the interactive region as discussed above.

After channel settings are configured at step 840 of method 800, scene settings may be configured in step 850. A scene is a collection or layer of channel content for a document. In one embodiment, a document may have multiple scenes but retains a single multi-channel layout or grid layout. A scene may contain content to be presented simultaneously for up to all the channels of a digital document. When document playback goes from a first scene to a second scene, the media content associated with the first scene is replaced with media content associated with the second scene. For example, for a document having five channels as shown in FIG. 10, a first scene may have media content in all five channels and a second scene may have content in only the top two channels. When traversing from this first scene to the second scene, the document will change from displaying content in all five channels to displaying content in only the top two channels. Thus, when traversing from scene to scene, all channel content of the previous scene is replaced to present the channel content (or lack thereof) associated with the current scene. In another embodiment, only some channels may undergo a change in content when traversing between scenes. In this case, a four channel document may have a first scene with media content in all four channels and a second scene may be configured with content in only two channels. In this case, when the second scene is activated, the primary content associated with the second scene is displayed in the two channels with configured content. The two channels with no content in the second scene can be configured to have the same content as a different scene, such as scene one, or present no content. When configured to have the same content as the first scene, the channels effectively do not undergo any change in content when traveling between scenes. Though examples discussed herein have used two scenes, any number of scenes is acceptable and the examples and embodiment discussed herein are not intended to limit the scope of the present invention.

A user to import media and save a scene with a unique identifier. Scene progression in a document may then be choreographed based upon user input of automatic events within the document. Traveling through scenes automatically may be done as the result of a timer as discussed above, wherein the action taken at the expiration of the timer corresponds to initiating the playback of a different scene, or upon the occurrence of some other automatically occurring event. Traveling between scenes as the result of user input may include input received from selection of a hot spot, selection of a channel, or some other input. In one embodiment, upon creating a multi-channel document, the channel content is automatically configured to be the initial scene. A user may configure additional scenes by configuring channel content, stage settings, and channel settings as discussed above in steps 820-840 of method 800 as well as scene settings. After scene settings have been configured, operation ends at step 855.

In one embodiment, a useful feature of a customized multi-channel document of the present invention is that the media elements are presented exactly as they were generated. No separate software applications are required to play audio or view video content. The timing, spatial properties, synchronization, and content of the document channels is preserved and presented to a user as a single document as the author intended.

In one embodiment of the present invention, a digital document may be annotated with additional content in the form of annotation properties. The additional content may include text, video, images, sound, mapping data and mapping objects, and hot spot data and hot spots. In one embodiment, the annotations may be added as additional material by editing an existing digital document project file as illustrated in and discussed with regard to FIGS. 8 and 10-13. Annotations and annotation properties are added in addition to the pre-existing content of a document, and do not change the pre-existing document content. Depending on the application of the document, annotations may be added to channels having no content, channels having content, or both.

In one embodiment, annotations may be added to document channels having no content. Annotation content that can be added in this embodiment includes text, video, one or more images, web page content, mapping data to map an object on a designated map channel and hot spot data for creating a hot spot. Content may be added as discussed above and illustrated in FIGS. 8 and 10-13.

Annotations may be used for several applications of a digital document in accordance with the present invention. In one embodiment, the annotations may be used to implement a business report. For example, a first author may create a digital document regarding a monthly report. The first author may designate a map channel as one of several content channels. The map channel may include an image of a chart or other representation of goals or tasks to accomplish for a month, quarter, or some other interval. The document could then be sent to a number of people considered annotating authors. Each annotating author could annotate the first author's document by generating a mapping object in the map channel showing progress or some other information as well as providing content for a particular channel. If a user selects an annotating author's mapping object, content may be provided in a content channel. In one embodiment, each content channel may be associated with one annotating author. The mapping object can be configured to trigger content presentation or the mapping object can be configured as a hot spot. Further, the annotating author may configure a content channel to have hot spots that provide additional information.

In another embodiment, annotations can be used to allow multiple people to provide synchronized content regarding a core content. In this embodiment, a first author may configure a document with content such as a video of an event. Upon receiving the document from the first author, annotating authors could annotate the document by providing text comments at different times throughout playback of the video. Each annotating author may configure one channel with their respective content. In one embodiment, comments can be entered during playback by configuring a channel as a text channel and setting a preference to enable editing of the text channel content during document playback. In this embodiment, a user may edit the text within an enabled channel during document playback. When the user stops document playback, the user's text annotations are saved with the document. Thus, annotating authors could provide synchronized comments, feedback, and further content regarding a teleconference, meeting, video or other media content. Upon playback of the document, each annotating author's comments would appear in a content channel at a time during playback of the core content as configured by the annotating author.

A project file may be saved at any time during operation of method 800, 1100, 1200 and 1300. A project file may be saved as a text file, binary file, or some other format. In any case, the author may configure the project file in several ways. In one embodiment, the author may configure the file to be saved in an over-writeable format such that the author or anyone else can open the file and edit the document settings in the file. In another embodiment, the author may configure a saved project file as annotation-allowable. In this case, secondary authors other than the document author may add content of the project file as an annotation but may not delete or edit the original content of the document. In yet another embodiment, a document author may save a file as protected wherein no secondary author may change original content or add new content.

In another embodiment, an MDMS project file can be saved for use in a client-server system. In this case, the MDMS project file may be saved by uploading the MDMS project file to a server. To access the uploaded project file, a user or author may access the uploaded MDMS project file through a client.

In one embodiment, a project file of the MDMS application can be accessed by loading the MDMS application jar file and then loading the .spj file. A .jar file in this case includes document components and java code that creates a document project file—the .spj file. In one embodiment, any user may have access to, playback, or edit the .spj file of this embodiment. In another embodiment, a .jar file includes the document components and java code included in the accessible-type .jar file, but also includes the media content comprising the document and resources required to playback the document. Upon selection of this type of .jar file, the document is automatically played. The .jar file of this embodiment may be desirable to an author who wishes to publish a document without allowing users to change or edit the document. A user may playback a publish-type .jar file, but may not load it or edit it with the document authoring tool of the present invention. In another embodiment, only references to locations of media content are stored in the publish-type .jar file and the not the media itself. In this embodiment, execution of the .jar file requires the media content to be accessible in order to playback the document.

In one embodiment of the present invention, a digital document may be generated using an authoring tool that incorporates a media configuration and management tool, also called a collection basket. The collection basket is in itself a collection of tools for searching, retrieving, importing, configuring and managing media, content, properties and settings for the digital document. The collection basket may be used with the stage manager tool as described herein or with another media management or configuration tool.

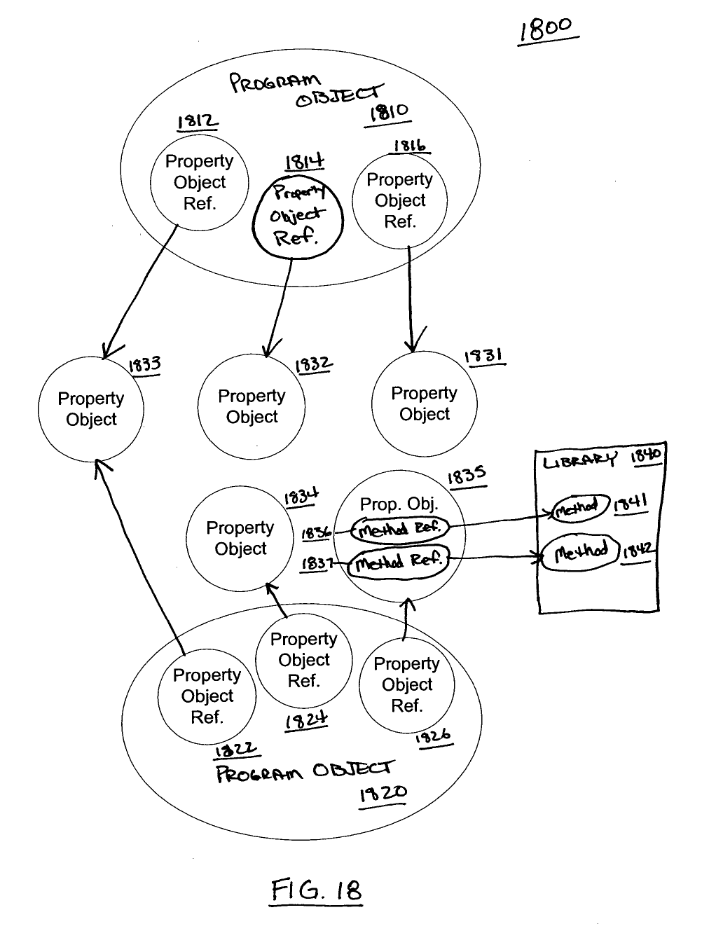

In one embodiment, the collection basket is used in conjunction with the stage window which displays the digital document channels. A collection of properties associated with a media file collectively form a program. Programs from the collection basket can be associated with channels of the stage window. In one embodiment, the program property configuration tool can be implemented as a graphical user interface. The embodiment of the present invention that utilizes a collection basket tool with the layout stage is discussed below with reference to FIGS. 1-20.

In one embodiment of the present invention, a collection basket system can be used to manage and configure programs. A program as used herein is a collection of properties. In one embodiment, a program is implemented as an object. The object may be implemented in Java programming language by Sun Microsystems, Mountain View, Calif., or any other object oriented programming language. The properties relate to different aspects of a program as discussed herein, including media, border, synchronization, narration, hot spot and annotation properties. The properties may also be implemented as objects. The collection basket may be used to configure programs individually and collectively. In one embodiment, the collection basket may be implemented with several windows for configuring media. The windows, or baskets, may be organized and implemented in numerous ways. In one embodiment, the collection basket may include a program configuring tool, or program basket, for configuring programs. The collection basket may also include tools for manipulating individual or groups of programs, such as a scene basket tool and a slide basket tool. A scene basket may be used to configure one or more scenes that comprise different programs. A slide basket tool may be used to configure a slide show of programs. Additionally, other elements may be implemented in a collection basket, such as a media searching or retrieving tool.

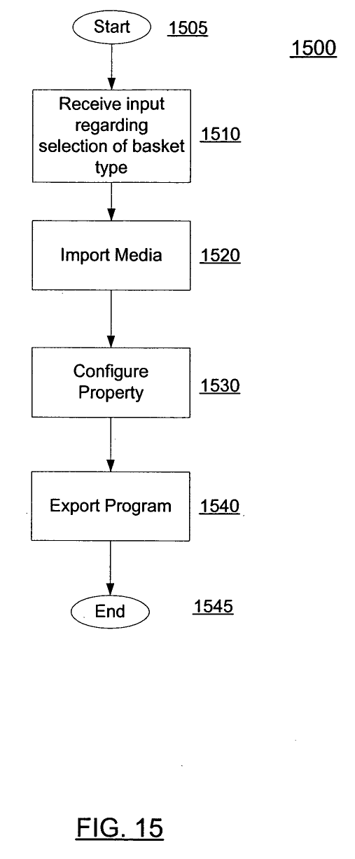

A collection basket tool interface 1400 in accordance with one embodiment of the present invention is illustrated in FIG. 14. Collection basket interface 1400 includes a program basket window 1410 and an auxiliary window 1420, both within the collection basket window 1405. Program basket window 1410 includes a number of program elements such as 1430 and 1440, wherein each program element represents a program. The program elements are each located in a program slot within the program basket. Auxiliary window 1420 may present any of a number of baskets or media configuring tools or elements for manipulating individual or groups of programs. In the embodiment illustrated in FIG. 14, the media configuring tools are indexed by tabbed pages and include an image searching element, a scene basket element, and a slide basket element.

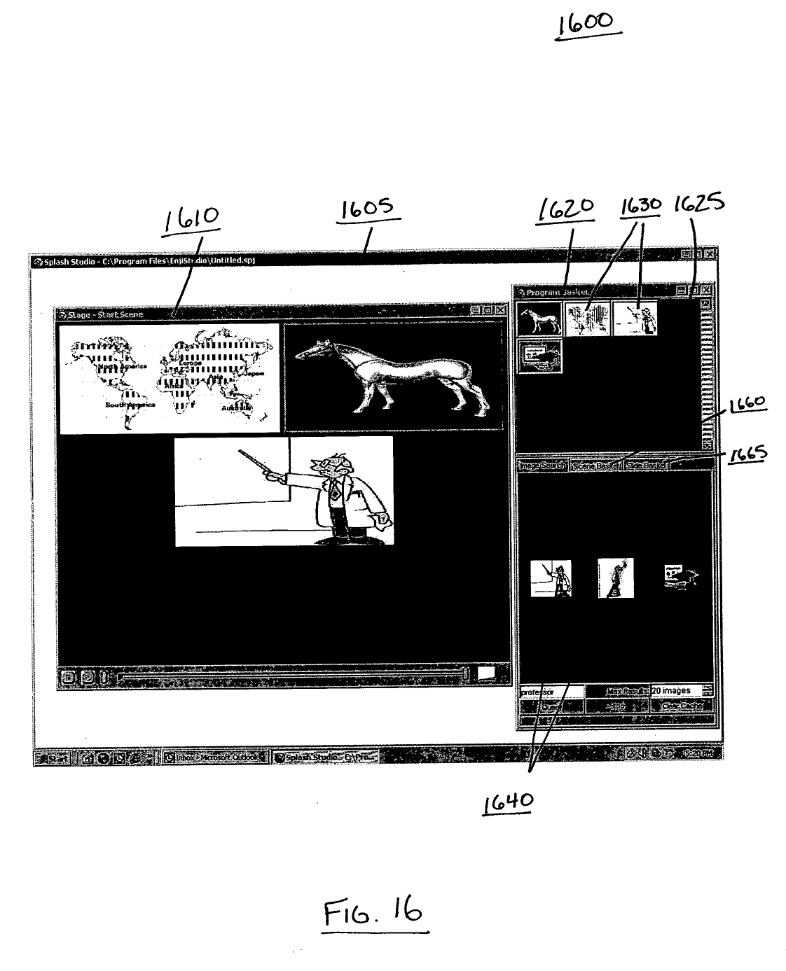

Media content can be processed in numerous ways by the collection basket or other media configuring tools. In general, these tools can be used to create programs, receive media, and then configure the programs with properties. The properties may relate to the media associated with the program or be media independent. Method 1500 of FIG. 15 illustrates a process for processing media content using the program basket in accordance with one embodiment of the present invention. Method 1500 begins with start step 1505. Next, an input regarding a selected tool or basket type is received in step 1510. The input selecting the particular basket type may be received through any input device or input method known in the art. In the embodiment illustrated in FIG. 14, the input may be selection of a tab corresponding to the particular basket or working area of the basket.

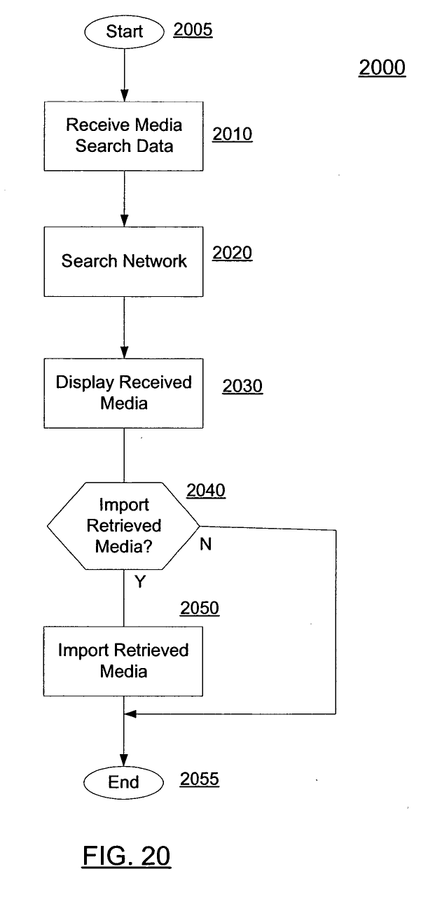

Once the type of basket has been selected, media may be imported to the basket at step 1520. For the scene and slide basket, programs can be imported to either of the baskets. In the case of the program basket, the imported media file may be any type of media, including but not limited to 3D content, video, audio, an image, image slides, or text. In one embodiment, a media filter will analyze the media before the imported media is imported to characterize the media type and ensure it is one of the supported media formats. In one embodiment, once media is imported to the program basket, a program object is created. The program object may include basic media properties that all media may have, such as a name. The program object may include other properties specific to the medium type. Media may be imported one at a time or as a batch of media files. For batch file importing in a program basket, each file will be assigned to a different program. In yet another embodiment, the media may be imported from a media search tool, such as an image search tool. A method 2000 for implementing an image search tool in accordance with one embodiment of the present invention is discussed with reference to FIG. 20. In one embodiment, the media search tool is equipped with a media viewer so that a user can preview the search results. In one embodiment, once the media file is imported, the program object created is configured to include a reference to the media. In this case, each program is assigned an identifier. The identifier associated with a particular program is included in the program object. The underlying program data structure also provides a means for the program object to reference the program user interface device being used, and vice versa.

After step 1520 in method 1500, properties may then be configured to programs at step 1530. There are several types of properties that may be configured and associated with programs. In one embodiment, the properties include but are not limited to common program properties, media related properties, synchronization properties, annotation properties, hotspot properties, narration properties, and border properties. Common properties may include program name, a unique identifier, user defined tags, program description, and references to other properties. Media properties may include attributes applicable to the individual media type, whether the content is preloaded or streaming, and other media related properties, such as author, creation and modified date, and media copyright information. Hot spot properties may include hotspot shape, size, location, action, text, and highlighting. Narration and annotation properties may include font properties and other text and text display related attributes. Border properties may relate to border text and border size, colors and fonts. A tag property may also be associated with a program. A tag property may include text or other electronic data indicating a keyword, symbol or other information to be associated with the program. In one embodiment, the keyword may be used to organize the programs as discussed in more detail below.

In the embodiment illustrated in interface 1400 of FIG. 14, properties are represented by icons. For example, program element 1430 includes one property icon in the upper left hand corner of the program element. Program element 1440 includes five property icons in the upper part of the of program element. The properties may be manipulated through actions performed on their associated icons. Actions on the icons may include delete, copy, and move and may be triggered by input received from a user. In one embodiment, the icons can be moved from program element to program element, copied, and deleted, by manipulating a cursor over the collection basket interface.

Data model 1800 illustrates the relationship between program objects and property objects in accordance with one embodiment of the invention. Programs and properties are generated and maintained as programming objects. In one embodiment, programs and properties are generated as Java™ objects. Data model 1800 includes program object 1810 and 1820, property objects 1831-1835, method references 1836 and 1837, methods 1841-1842, and method library 1840. Program object 1810 includes property object references 1812, 1814, and 1816. Program object 1820 includes property object references 1822, 1824, and 1826. In the embodiment illustrated, program objects include a reference to each property object associated with the program object. Thus, if program object 1810 is a video, program object 1810 may include a reference 1812 to a name property 1831, a reference 1814 to a synchronization property 1832 and a reference 1816 to a narration property 1833. Different program objects may include a reference to the same property object. Thus, property object reference 1812 and property object reference 1822 may refer to the same property object 1833.

Further, some property objects may contain a reference to one or more methods. For example, a hot spot property object 1835 may include method references 1836 and 1837 to hot spot actions 1841 and 1842, respectively. In one embodiment, each hot spot action is a method stored in a hot spot action method library 1840. The hot spot action library is a collection of hot spot action methods, the retrieval of which can be carried out using the reference to the hot spot action method contained in the hot spot property.

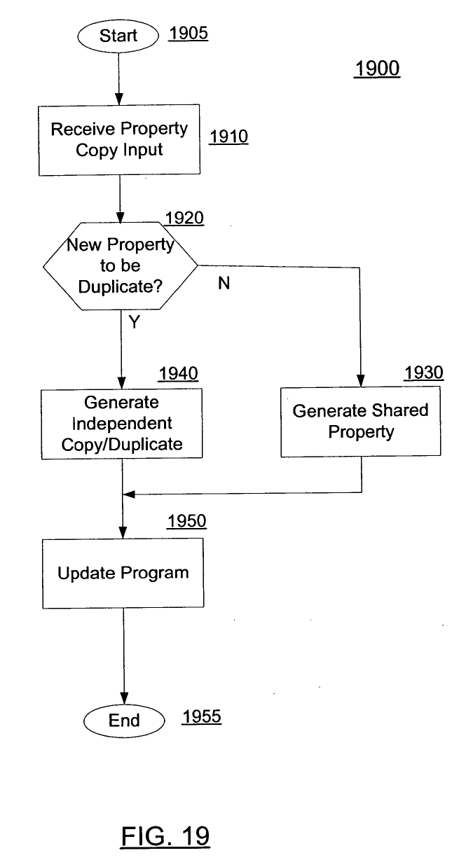

In an embodiment wherein each program is an object, and each property is an object, the properties and programs can be manipulated within the program basket using their respective program element representations and icons very conveniently. In the case of property objects represented by icons, an icon can be copied from program to program by an author. Method 1900 of FIG. 19 illustrates this process in accordance with one embodiment of the present invention. Method 1900 begins with start step 1905. Next, the program basket system receives input indicating an author wishes to copy an property object to another program in the program basket. In one embodiment, a user may indicate this by dragging an icon from one program element to another program element. The system then determines if the new property will be a duplicate copy or a shared property object at step 1920. A shared property is one in which multiple property object references refer to the same object. Thus, as a modification is made to the property object, multiple programs are affected. In one embodiment, the system may receive input from an author at step 1920. In one embodiment, the author system will prompt or provide another means from receiving input from the author, such as providing a menu display, at step 1920 to determine the author's intention. If the new property object is to be a shared property, a shared property is generated at step 1930. Generating a shared includes generating a property object reference to the property object that is being shared. If a shared is not to be generated, a duplicate but identical copy of the property object and a reference to the new object is generated at step 1940. The program receiving the new shared or duplicate property object is then updated accordingly at step 1950. Operation of method 1900 then ends at step 1955.

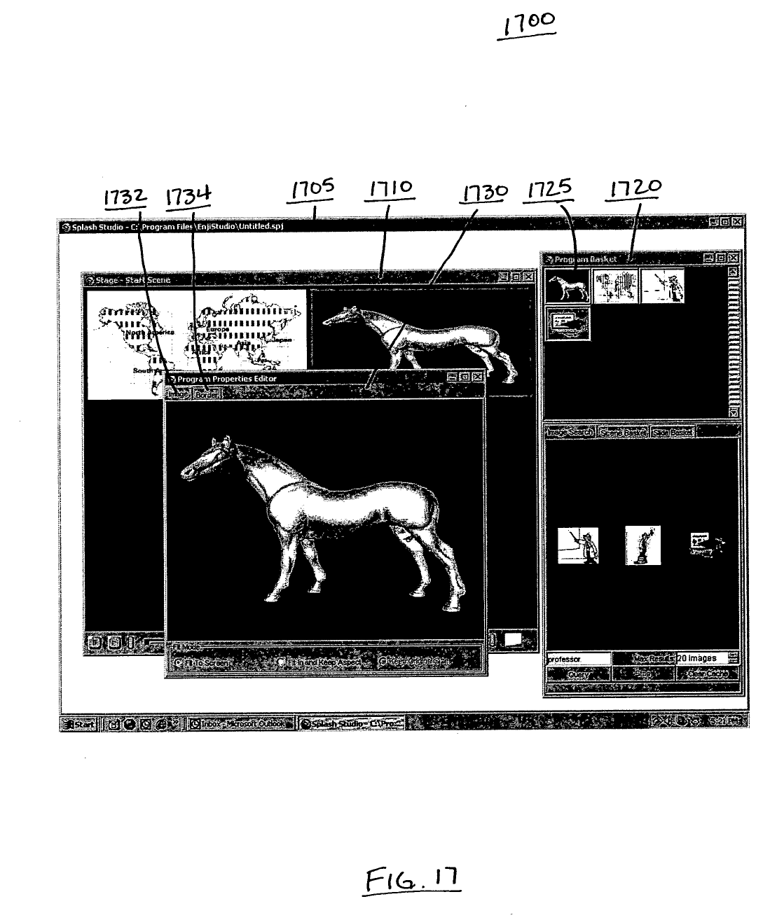

In one embodiment, a program editor interface is used to configure properties at step 1530 of method 1500. In this case, property icons may not be displayed in the program elements. An example of an interface 1600 in accordance with this embodiment of the present invention is illustrated in FIG. 16. As illustrated in FIG. 16, interface 1600 includes a workspace window 1605, a stage window 1610, and a collection basket 1620. The collection basket includes programs 1630 in the program basket window and an image search tool in the auxiliary window. The programs displayed in the collection basket do not display property icons. This embodiment is one of several view modes provided by the authoring system of the present invention. The program editor for a program in the collection basket can be generated upon the receipt of input from a user. The program editor is an interface for configuring properties for a program. The interface 1700 of FIG. 17 illustrates interface 1600 after a program element has been selected for property configuration. In the embodiment illustrated in FIG. 17, interface 1700 displays a property editor tool 1730 that corresponds to program 1725. The program interface appears as a separate interface upon receiving input from an author indicating the author would like to configure properties for a particular program in the program basket. As illustrated, the program interface includes tabs for selecting a property of the program to configure. In one embodiment, the program editor may configure properties including common program properties, media related properties, hotspot properties, narration properties, annotation properties, synchronization properties and border properties.

After properties have been configured in step 1530, a user may export a program from the collection basket to a stage channel at step 1540. In one embodiment, each channel in a stage layout has a predetermined identifier. When a program is exported from the collection basket and imported to a particular channel, the underlying data structure provides a means for the program object to reference the channel identifier, and vice versa. The exporting of the program can be done by a variety of input methods, including drag-and-drop methods using a visual indicator (such as a cursor) and an input device (such as a mouse), command line entry, and other methods as known in the art to receive input. After exporting a program at step 1540, operation of method 1500 ends at step 1545. In one embodiment, the programs exported to the stage channel are still displayed in the collection basket and may still be configured. In one embodiment, configurations made to programs in the collection basket that have already been exported to a channel will automatically appear in the program exported to the channel.

With respect to method 1500, one skilled in the art will understand that not all steps of method 1500 must occur. Further, the steps illustrated in method 1500 may occur in a different order than that illustrated. For example, an author may select a basket type, import media, and export the program without configuring any properties. Alternatively, an author could import media, configure properties, and then save the program basket. Though not illustrated in method 1500, the program basket scene and slide basket can be saved at any time. Upon receiving input indicating the elements of the collection basket should be saved, all elements in all the baskets of the collection basket are saved. In another embodiment, media search tool results that are not imported to program basket will not be saved during a program basket save operation. In this case, the media search tool content are stored in cache memory or some temporary directory and cleared after the application is closed or exits.

The display of the program elements in the program basket can be configured by an author. An author may provide input regarding a sorting order of the program elements. In one embodiment, the program elements may be listed according to program name, type of media, or date they were imported to the program basket. The programs may also be listed by a search for a keyword, or tag property, that is associated with each program. This may be useful when the tag relates to program content, such as the name of a character, place, or scene in a digital document. The display of the program elements may also be configured by an author such that the programs may be displayed in a number of columns or as thumbnail images. The program elements may also be displayed by how the program is applied. For example, the program elements may be displayed according to whether the program is assigned to a channel in the stage layout or some other media display component. The program elements may also be displayed by groups according to which channel they are assigned to, or which media display component. In another embodiment, the programs may be arranged as tiles that can be moved around the program basket and stacked on top of each other. In another embodiment, the media and program properties may be displayed in a column view that provides the media and properties as separate thumbnail type representations, wherein each column represents a program. Thus, one row in this view may represent media. Subsequent rows may represent different types of properties. A user could scroll through different columns to view different programs to determine which media and properties were associated with each program.

As discussed above, media tools may be included in a collection basket in addition to baskets. In one embodiment, a media searching tool may be implemented in the collection basket. A method 2000 for implementing an media searching and retrieving tool in accordance with one embodiment of the present invention is illustrated in FIG. 20. Method 2000 begins with start step 2005. Next, media search data is received at step 2010. In one embodiment, keywords regarding the media are received through a command line in the media search tool interface. The search data received may also indicate the media type, date created, location, and other information. In FIG. 16, the auxiliary window has a tab for an image search tool which is selected. The image search interface has a query line at the bottom of the interface. Within the auxiliary window, images 1640 are displayed in interface 1600.

Once data is received at step 2010, a search is performed at step 2020. In one embodiment, the search is performed over a network. The image search tool can search in predetermined locations for media that match the search data received in step 2010. In an embodiment where the search is for a particular type of image, the search engine may search the text that is embedded with an image to determine if it matches the search data provided by the author. In another embodiment, the search data may be provided to a third party search engine. The third party search engine may search a network such as the Internet and provide results based on the search data provided by the search tool interface. In one embodiment, the search may be limited by search terms such as the maximum number of results to display, as illustrated in interface 1600. A search may also be stopped at any time by a user. This is helpful to end searches early when a user has found media that suits her needs before the maximum number of retrieved media elements have been retrieved and displayed.

Once the search is performed, the results of the search can be displayed in the search tool interface in step 2030. In one embodiment, images, key frames of video, titles of audio, and titles of text documents are provided in the media search interface window. In the embodiment illustrated in FIG. 16, images 1640 are illustrated as a result of a search for a keyword of “professor”. In one embodiment, the media search tool also retrieves media related information regarding the image, including the author, image creation date, copyright image and terms of use, and any other information that may be associated with the media as meta data. In this embodiment, the author may include this information in a digital document when using the retrieved media in a digital document. The media search tool then determines whether or not to import the media displayed in the search window at step 2040. Typically, a user selection of a displayed media or user input indicating the media should be imported to a program indicates that the media displayed in the search results window should be imported. If the system determines that the media should be imported, the media is imported at step 2050. If the media is not to be imported, then the operation continues to step 2055. Operation of method 2000 ends at step 2055.

Three dimensional (3D) graphics interactivity is something widely used in electronic games but passively used in movie or story telling. In summary, implementing 3D graphics typically includes creating a 3D mathematical model of an object, transforming the 3D mathematical model into 2D patterns, and rendering the 2D patterns with surfaces and other visual effects. Effects that are commonly configured with 3D objects include shading, shadows, perspective, and depth. In the past, 3D graphic technology has been widely used in electronic games.

While 3D interactivity enhances game play, it usually interrupts the flow of a narration in story telling applications. Story telling applications of 3D graphic systems require much research, especially in the user interface aspects. In particular, previous systems have not successfully determined what and how much to allow users to manipulate and interact with the 3D models. There is a clear need to blend story telling and 3D interactivity to provide a user with a positive, rich and fulfilling experience. The 3D interactivity must be fairly realistic in order to enhance the story, mood and experience of the user.

With the current state of technology, typical recreational home computers do not have enough CPU processing power to playback or interact with a realistic 3D movie. With the multi-channel player and authoring tool of the present invention, the user is presented with more viewing and interactive choices without requiring all the complexity involved with configuration of 3D technology. It is also advantageous for online publishing since the advantages of the present invention can be utilized while the bandwidth issue prevents full scale 3D engine implementation.

Currently, there are several production houses such as Pixar who produce and own many precious 3D assets. To generate an animated movie such as “Shrek” or “Finding Nimo”, production house companies typically construct many 3D models for movie characters using both commercial and in house 3D modeling and rendering tools. Once the 3D models are created, they can be used over and over to generate many different angles, profiles, actions, emotions and different animation of the characters.

Similarly, using 3D model files for various animated objects, the multi-channel system of the present invention can present the 3D objects in as channel content in many different ways.

With some careful and creative design, the authoring tool and document player of the present invention provides the user with more interactivities, perspectives and methods of viewing the same story without demanding a high end computer system and high bandwidth that's still not widely accessible to the typical user. In one embodiment of the present invention, the MDMS may support a semi-3D format, such as the VR format, to make the 3D assets interactive but not requiring an entire embedded 3D rendering engine.

For example, for story telling applications, whether it is using 2D or 3D animation, it is highly desirable for the user to be able to control and adjust the timing of the video provided in each of multiple channels so that the channels can be synchronized to create a compelling scene or effect. For example, a character in one channel might be seen throwing a ball to another character in another channel. While it is possible to produce video or movies that synchronized perfectly outside of this invention, it is nevertheless, a tedious and inefficient process. The digital document authoring system of the present invention provides the user interface to the user to control the playback of the movie in each channel so that an event like displaying the throwing of a ball from one channel to another can be easily timed and synchronized accordingly. Other inherent features of the present invention can be used to simplify the incorporation of effects with movies. For example, users can also synchronize the background sound tracks along with synchronizing the playback of the video or movies.

With the help of a map in the present invention, which may be in the format of a concept, landscape or navigational map, more layers of information can be built into the story. This encourages a user to be actively engaged as they try to unfold the story or otherwise retrieve information through the various aspects of interacting with the document. As discussed herein, the digital document authoring tool of the present invention provides the user with an interface tool to configure a concept, landscape, or navigational map. The configured map can be a 3D asset. In this embodiment of a multi-channel system, one of the channels may incorporate 3D map and the other channels are playing the 2D assets at the selected angle or profile. This may produce a favorable and compromised solution based on the current trend of users wanting to see more 3D artifacts while using a CPU and bandwidth that experiences limitations in handling and providing 3D assets.

The digital document of the present invention may be advantageously implemented in several commercial fields. In one embodiment, the multiple channel format is advantageous for presenting group interaction curriculums, such as educational curriculums. In this embodiment, any number of channels can be used. A select number of channels, such as an upper row of channels, can by used to display images, video files, and sound files as they relate to the topic matter being discussed in class. A different select group of channels, such as a lower row of channels, can be used to display keywords that relate to the images and video. The keywords can appear from hotspots configured on the media, they can be typed into either three channels, they can be selected by a mouse click, or a combination of these. The chosen keyword can be relocated and emphasized in many ways, including across text channels, highlighted with color, font variations, and other ways. This embodiment allows groups to interact with the images and video by calling or recounting events that relate to the scene that occurs in the image and then writing key words that come up as a result of the discussions. After document playback is complete, the teacher may choose to save the text entries and have the students reopen the file on another computer. This embodiment can be facilitated by a simple client/server or a distributed system as known in the art.

In another embodiment, the multiple channel format is advantageous for presenting a textbook. Different channels can be used as different segments of a chapter. Maps could occur in one, supplemental video in another, images, sound files, and a quiz. The other channels would contain the main body of the textbook. The system would allow the student to save test results and highlight areas in the textbook where the test background came from. Channels may represent different historical perspectives on a single page giving an overview of global history without having to review it sequentially. Moving hotspots across maps could help animate events in history that would otherwise go undetected.

In another embodiment, the multiple channel format is advantageous for training or call center training. The multi-channel format can be used as a spatial organizer for different kinds of material. Call center support and other types of call or email support centers use unspecialized workers to answer customer questions. Many of them spend enormous amounts of money to educate the workers on a product that may be too complicated to learn in a short amount of time. What call center personnel really need is to know how to find the answers to customers' questions without having to learn everything about a product—especially if it is about software which has consistent upgrades. The multi-channel can cycle through a lot of material in a short amount of time and the user constantly viewing the document will learn the special layout of the manual and also—will retain information just by looking at the whole screen over and over again.

In another embodiment, the multiple channel format is advantageous for online catalogues. The channels can be used to display different products with text appearing in attached channels. One channel could be used to display the checkout information. In one embodiment, the MDMS would include a more specialized client server set up with the backend server hooked up to an online transaction service. For a clothing catalogue, a picture could be presented in one channel and a video of someone with the clothes and information about sizes in another channel.

In another embodiment, the multiple channel format is advantageous for instructional manuals. For complicated toys, the channels could have pictures of the toy from different angles and at different stages. A video in another channel could help with putting in difficult part. Separate sound with images and also be used to illustrate a point or to free someone from having to read the screen. The manuals could be interactive and provide the user with a road map regarding information about the product with a mapping channel.

In another embodiment, the multiple channel format is advantageous for a front end interface for displaying data. This could use a simple client server component or a more specialized distributed system. The interface can be unique to the type of data being generated. An implementation of the mapping channel could be used as one type of data visualization tool. This embodiment would display images as moving icons across the screen. These icons have information associated with them and appear moving to its relational target.

By way of a non-limiting example, a system authoring tool including a stage component and a collection basket component according to one embodiment of the present invention is illustrated in FIG. 7. Although this diagram depicts objects/processes as logically separate, such depiction is merely for illustrative purposes. It will be apparent to those skilled in the art that the objects/processes portrayed in this figure can be arbitrarily combined or divided into separate software, firmware or hardware components. Furthermore, it will also be apparent to those skilled in the art that such objects/processes, regardless of how they are combined or divided, can execute on the same computing device or can be distributed among different computing devices connected by one or more networks.

As shown in FIG. 7, a display stage component and collection basket component can be configured to receive information for the generation of a multi-channel document. Stage component 740 and collection basket component 750 can receive and be used in the generation of project files and published files. File manager 710 can save and open project files 772 and published files and documents 770. In the embodiment illustrated in FIG. 7, files and documents may be saved and opened with XML parser/generator 711 and publisher 712. The file manager can receive and parse a file to provide data to data manager 732 and can receive data from data manager 732 in the generation of project files and published files.

Stage component 740 can transmit data to and receive data from data manager 732 and interact with resource manager 734, project manager 724, and layout manager 722, to render a stage window and stage layout such as that illustrated in FIG. 16. The collection basket component can be used to configure scene, program, and slide show data. The configured information can be provided to stage component 740 and used to create and display a digital document. Slide shows and programs can be configured within stage component 740 and collection basket component 750 and then associated with channels such as channels 745, 746, and 748. Programs and slide shows can reference channels and channels can reference programs and slide shows. The channels can include numerous types of media as discussed herein, including but not limited to text, single image, audio, video, and slide shows as shown.

In some embodiments, the various manager components may interact with editors that may be presented as user interfaces. The user interfaces can receive input from an author authoring a document or a user interacting with a document. The input received determine how the document and its data should be displayed and or what actions or effects should occur. In yet another embodiment, a channel may operate as a host, wherein the channel receives data objects, components such as a program, slideshows and any other logical data unit.

In one embodiment, a plurality of user interfaces or a plurality of modes for the various editors are provided. A first interface or mode can be provided for amateur or unskilled authors. The GUI can present the more basic and/or most commonly configured properties and/or options and hide the more complex and/or less commonly configured properties and/or options. Less options may be provided but the options can include the more obvious and common options. A second interface or mode can be provided for more advanced or skilled authors. The second interface can provide for user configuration of most if not all configurable properties and/or options.

Collection basket component 750 can receive data from data manager 732 and can interact with program manager 726, scene manager 728, slide show manager 727, data manger 732, resource manager 734, and hot spot action library 755 to render and manage a collection basket. The collection basket component can receive data from the manager components such as the data and program managers to create and manage scenes such as that represented by scene 752, slide shows such as that represented by slide show 754, and programs such as that represented by program 753.

Programs can include a set of properties. The properties may include media properties, annotation properties, narration properties, border properties, synchronization properties, and hot spot properties. Hot spot action library 755 can include a number of hot spot actions, implemented as methods. In various embodiments, the manager components can interact with editor components that may be presented as user interfaces (UI).

The collection basket component can also receive information and data such as media files 762 and content from a local or networked file system 792 or the World Wide Web 764. A media search tool 766 may include or call a search engine and retrieve content from these sources. In one embodiment, content received by collection basket 750 from outside the authoring tool is processed by file filter 768.

Content may be exported to and imported from the collection basket component 750 to the stage component 740. For example, slide show data may be exported from a slide show such as slide show 754 to channel 748, program data may be exported from a program such as program 753 to channel 745, or scene data from a scene such as scene 752 to scene 744. The operation and components of FIG. 7 are discussed in more detail below.

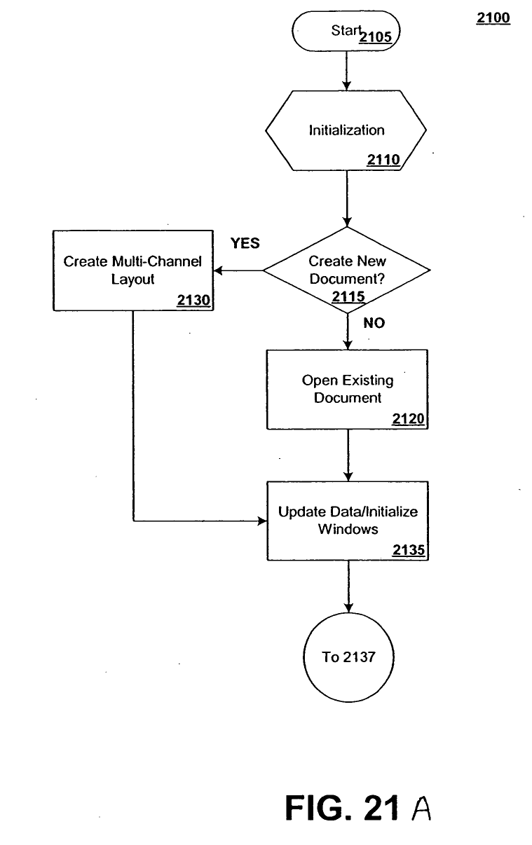

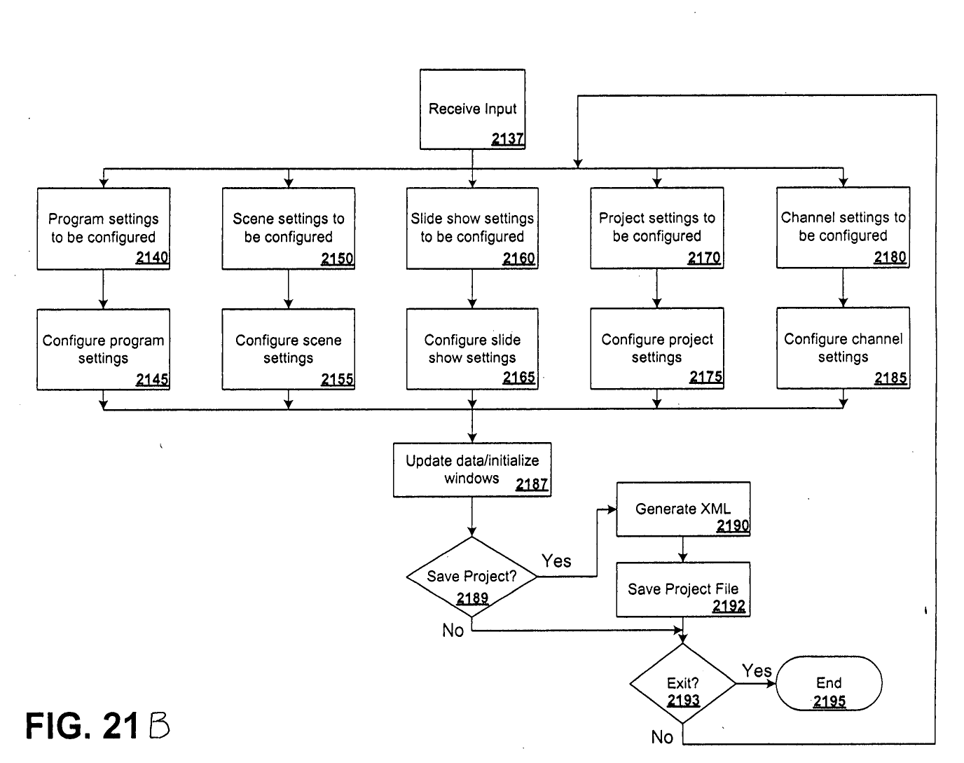

A method 2100 for generating an interactive multi-channel document in accordance with one embodiment is shown in FIG. 21. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways. Method 2100 can be used to generate a new document or edit an existing document. Whether generating a new document or editing an existing document, not all the steps of method 2100 need to be performed. In one embodiment, document settings are stored in cache memory as the file is being created or edited. The settings being created or edited can be saved to a project file at any point during the operation of method 2100. In one embodiment, method 2100 is implemented using one or more interactive graphical user interfaces (GUI) that are supported by a system of the present invention.

User input in method 2100 may be provided through a series of drop down menus or some other method using an input device. In other embodiments, context sensitive popup menus, windows, dialog boxes, and/or pages can be presented when input is received within a workspace or interface of the MDMS. Mouse clicks, keyboard selections including keystrokes, voice commands, gestures, remote control inputs, as well as any other suitable input can be used to receive information. The MDMS can receive input through the various interfaces. In one embodiment, as document settings are received by the MDMS, the document settings in the project file are updated accordingly. In one embodiment, any document settings for which no input is received will have a default value in a project file. Undo and redo features are provided to aid in the authoring process. An author can select one of these features to redo or undo a recent selection, edit, or configuration that changes the state of the document. For example, redo and undo features can be applied to hotspot configurations, movement of target objects, and change of stage layouts, etc. In one embodiment, a user can redo or undo one or multiple selections, edits, or configurations. The state of the document is updated in accordance with any redo or undo.

Method 2100 begins with start step 2105. Initialization then occurs at step 2110. During the initialization of the MDMS in step 2110, a series of data and manager classes can be instantiated. A MDMS root window interface or overall workspace window 1605, a stage window 1610, and a collection basket interface 1620 as shown in FIG. 16 can be created during the initialization. In one embodiment, data manager 132 includes one or more user-interface managers which manages and renders the various windows. In another embodiment, different user interfaces are handled by the particular manager. For example, the stage layout user interface may be handled by a layout manager.

In step 2115, the MDMS can determine whether a new multi-channel document is to be created. In one embodiment, the MDMS receives input indicating that a new multi-channel document is to be created. Input can be received in numerous ways, including but not limited to receiving input indicating a user selection of a new document option in a window or popup menu. In one embodiment, a menu or window can be presented by default during initialization of the system. If the MDMS determines that a new document is not to be created in step 2115, an existing document can be opened in step 2120. In one embodiment, opening an existing document includes calling an XML parser that can read and interpret a text file representing the document, create and update various data, generate a new or identify a previously existing start scene of the document, and provide various media data to a collection basket such as basket 1620.

If the MDMS determines that a new document is to be created, a multi-channel stage layout is created in step 2130. In one embodiment, creating a layout can include receiving stage layout information from a user. For example, the MDMS can provide an interface for the user to specify a number of rows and columns which can define the stage layout. In another embodiment, the user can specify a channel size and shape, the number of channels to place in the layout, and the location of each channel. In yet another embodiment, creating a layout can include receiving input from an author indicating which of a plurality of pre-configured layouts to use as the current stage layout. An example of pre-configured layouts that can be selected by an author is shown in FIG. 9. In one embodiment, the creation of stage layouts is controlled by layout manager 722. Layout manager 722 can include a layout editor (not shown) that can further include a user interface. The interface can present configuration options to the user and receive configuration information.

In one embodiment of the present invention, a document can be configured in step 2130 to have a different layout during different time intervals of document playback. A document can also be configured to include a layout transition upon an occurrence of a layout transition event during document playback. For example, a layout transition event can be a selection of a hotspot, wherein the transition occurs upon user selection of a hotspot, expiration of a timer, selection of a channel, or some other event as described herein and known to those skilled in the art.

In step 2135, the MDMS can update data and create the stage channels by generating an appropriate stage layout. In one embodiment, layout manager 722 generates a stage layout in a stage interface such as stage window 1610 of FIG. 16. Various windows can be initialized in step 2135, including a stage window such as stage window 1610 and a collection basket such as collection basket 1620.

After window initialization is complete at step 2135, document settings can be configured. At step 2137, input can be received indicating that document settings are to be configured. In one embodiment, user input can be used to determine which document setting is to be configured. For example, a user can provide input to position a cursor or other location identifier within a workspace or overall window such as workspace 1605 of FIG. 16 using an input device and simultaneously provide a second input to indicate selection of the identified location. The MDMS receives the user input and determines the setting to be configured. In another embodiment, if a user clicks or selects within the workspace, the MDMS can present the user with options for configuring program settings, configuring scene settings, configuring slide show settings, and configuring project settings. The options can be presented in a graphical user interface such as a window or menu.

In some embodiments, context sensitive graphical user interfaces can be presented depending on the location of a user's input or selection. For example, if the MDMS receives input corresponding to a selection within program basket interface 320, the MDMS can determine that program settings are to be configured. After determining that program settings are to be configured, the MDMS can provide a user interface for configuring program settings. In any case, the MDMS can determine which document setting is to be configured at steps 2140, 2150, 2160, 2170, or 2180 as illustrated in method 2100. Alternatively, operation may continue to step 2189 or 2193 directly from step 2135, discussed in more detail below.

In step 2140, the MDMS can determine that program settings are to be configured. In one embodiment, the MDMS determines that program settings are to be configured from information received from a user at step 2137. There are many scenarios in which user input may indicate program settings are to be configured. As discussed above, a user can provide input within a workspace of the MDMS. In one embodiment, a user selection within a program basket window such as window 1625 can indicate that program settings are to be configured. In response to an author's selection of a program within the program basket window, the MDMS may prompt the author for program configuration information.

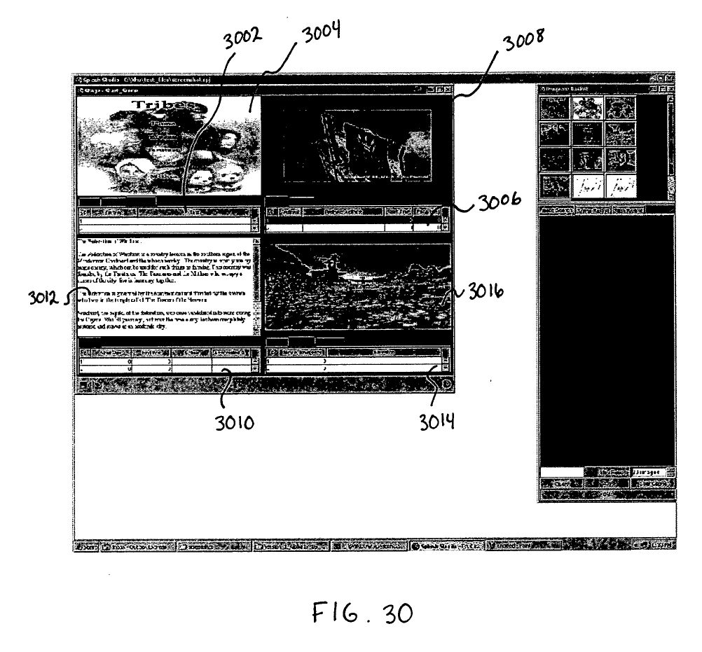

In one embodiment, the MDMS accomplishes this by providing a program configuration window to receive configuration information for the program. In another embodiment, after a program has been associated with a channel in the stage layout, the MDMS can provide a program editor interface in response to an author's selection of a channel or a program in the channel. FIG. 30 illustrates various program editor interfaces within channels of the stage. In another embodiment, a user can select a program setting configuration option from a menu or window. If the MDMS determines that program settings are to be configured, program settings can be configured in step 2145.

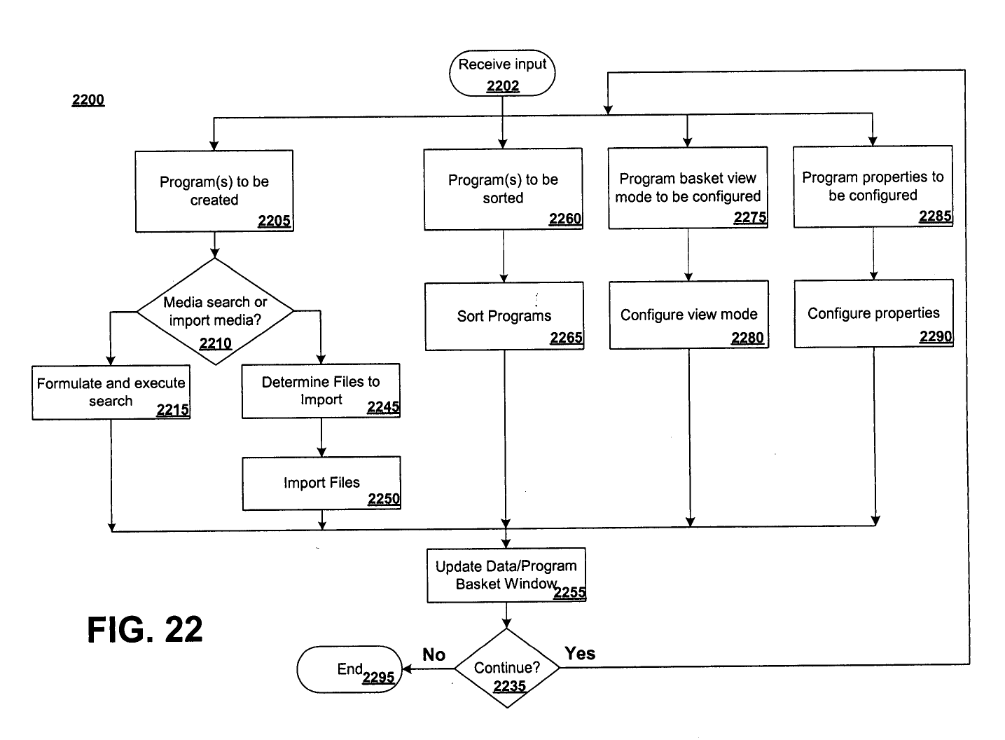

In one embodiment, if program settings are to be configured in step 2145, program settings can be configured as illustrated by method 2200 shown in FIG. 22. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Operation of method 2200 begins with the receipt of input at step 2202 indicating that program settings are to be configured. In one embodiment, the input received at step 2202 can be the same input received at step 2137.

In one embodiment, the MDMS can present a menu or window including various program setting configuration options after determining that program settings are to be configured in step 2140. The menu or window can provide options for any number of program setting configuration tasks, including creating a program, sorting program(s), changing a program basket view mode, and editing a program. In one embodiment, the various configuration options can be presented within individual tabbed pages of a program editor interface.

The MDMS can determine that a program is to be created at step 2205. In one embodiment, the input received at step 2202 can be used to determine that a program is to be created. After determining that a program is to be created at step 2205, the MDMS determines whether a media search is to be performed or media should be imported at step 2210. If the MDMS receives input from a user indicating that a media search is to be performed, operation continues to step 2215.

In one embodiment, a media search tool such as tool 1650, an extension or part of collection basket 1620, can be provided to receive input for performing the media search. The MDMS can perform a search for media over the internet, World Wide Web (WWW), a LAN or WAN, or on local or networked file folders. Next, the MDMS can perform the media search. In one embodiment, the media search is performed according to the method illustrated in FIG. 20. After performing a media search, the MDMS can update data and a program basket window.

If input is received at step 2210 indicating that media is to be imported, operation of method 2200 continues to step 2245. In step 2245, the MDMS determines which media files to import. In one embodiment, the MDMS receives input from a user corresponding to selected media files to import. Input selecting media files to import can be received in numerous ways. This may include but is not limited to use of an import dialog user interface, drag and drop of file icons, and other methods as known in the art. For example, an import dialog user interface can be presented to receive user input indicating selected files to be imported into the MDMS. In another case, a user can directly “drag and drop” media files or copy media files into the program basket.

After determining the media files to be imported at step 2245, the MDMS can import the files in step 2250. In one embodiment, a file filter is used to determine if selected files are of a format supported by the MDMS. In this embodiment, supported files can be imported. Attempted import of non-supported files will fail. In one embodiment, an error condition is generated and an optional error message is provided to a user indicating the attempted media import failed. Additionally, an error message indicating the failure may be written to a log.

After importing media in step 2250, the MDMS can update data and the program basket window in step 2255. In one embodiment, each imported media file becomes a program within the program basket window and a program object is created for the program. FIG. 16 illustrates a program basket window 1625 having four programs therein. In one embodiment, a set of default values or settings are associated with any new programs depending on the type of media imported to the program. As previously (will be) discussed, media can be imported one media file at a time or as a batch of media files.

After updating data and the program basket window in step 2255 operation of method 2200 continues to step 2235 where the system determines if operation of method 2200 should continue. In one embodiment, the system can determine that operation is to continue from input received from a user. If operation is to continue, operation continues to determine what program settings are to be configured. If not, operation ends at end step 2295.

In step 2260, the MDMS determines that programs are to be sorted. In one embodiment, the MDMS can receive input from a user indicating that programs are to be sorted. For example, in one embodiment the MDMS can determine that programs are to be sorted by receiving input indicating a user selection of an attribute of the programs. If a user selects the name, type, or import date attribute of the programs, the MDMS can determine that programs are to be sorted by that attribute. Programs can be sorted in a similar manner as that described with regard to the collection basket tool. In another embodiment, display of programs can be based on user defined parameters such as a tag, special classification or grouping. In yet another embodiment, sorting and display of programs can be based on the underlying system data such as by channel, by scene, slide show, or some other manner. After sorting in this manner, users may follow-up with operations such as exporting all programs associated with a particular channel, delete all programs tagged with a specific keyword, etc. After determining that programs are to be sorted in step 2260, the MDMS can sort the programs in step 2265. In one embodiment, the programs are sorted according to a selection made by a user during step 2260. For example, if the user selected the import date attribute of the programs, the MDMS can sort the programs by their import date. After sorting the programs in step 2265, the MDMS can update data and the program basket window in step 2255. The MDMS can update the program basket window such that the programs are presented according to the sorting performed in step 2265.

In step 2275, the MDMS can determine that the program basket view mode is to be configured. At step 2280, configuration information for the program basket view mode can be received and the view mode configured. In one embodiment, the MDMS can determine that programs are to be presented in a particular view format from input received from a user. For example, a popup or drop-down menu can be provided in response to a user selection within the program basket window. Within the menu, a user can select between a multi-grid thumbnail view, a multi-column list view, multi-grid thumbnail view with properties displayed in a column, or any other suitable view. In one embodiment, a view mode can be selected to list only those programs associated with a channel or only those programs not associated with a channel. In one embodiment, input received at step 2202 can indicate program basket view mode configuration information. After determining a program basket view format, the MDMS can update data and the program basket window in step 2255.

In step 2285, the MDMS determines that program properties are to be configured. Program properties can be implemented as a set of objects in one embodiment. An object can be used for each property in some embodiments. In step 2290, program properties can be configured. In one embodiment, program properties can be configured by program manager 726. Program manager 726 can include a program property editor that can present one or more user interfaces for receiving configuration information. In one embodiment, the program manager can include manager and/or editor components for each program property.

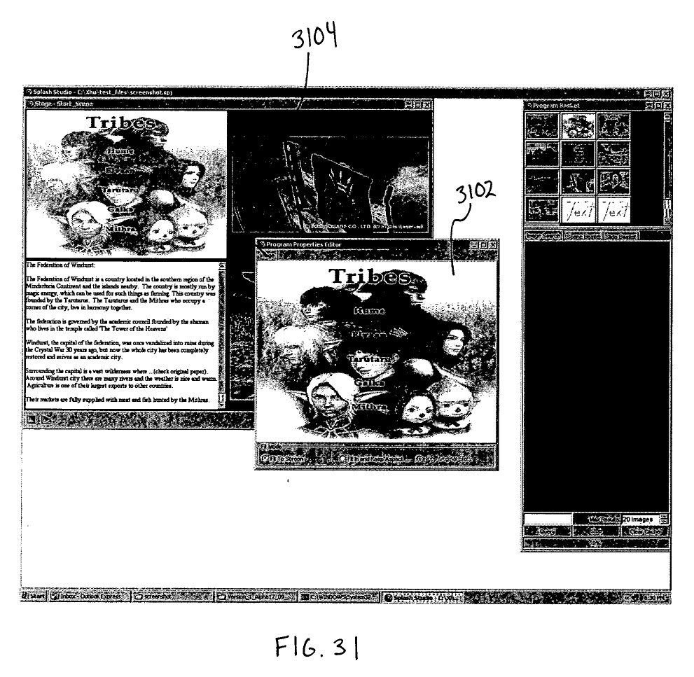

An exemplary program property editor user interface 3102 is depicted in FIG. 31. Interface 3102 includes an image property tab 3104. Interface 3102 only includes an image property tab because no other property is associated with the program. In one embodiment, a property tab can be included for each type of property associated with the program. Selection of a property tab can bring to the foreground a page for configuring the respective property. After configuring program properties at step 2290, data and the program basket window can be updated at step 2155.

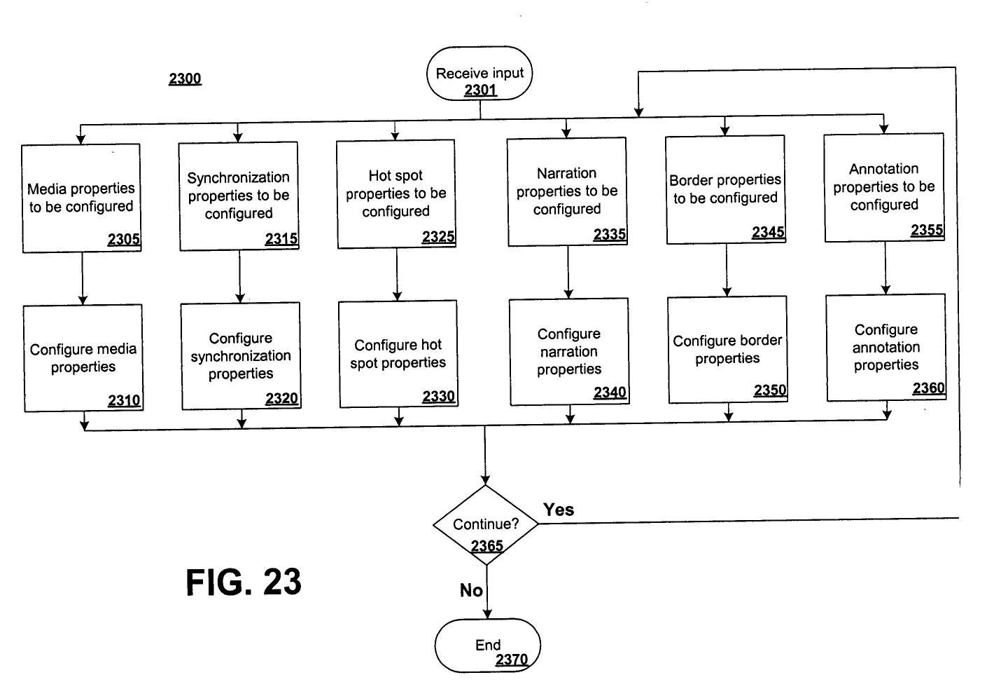

In one embodiment, program properties are configured according to the method illustrated in FIG. 23. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

At step 2301, input can be received indicating that program properties are to be configured. In one embodiment, the input received at step 2301 can be the same input received at step 2202. At steps 2305, 2315, 2325, 2335, 2345, and 2355, the MDMS can determine that various program properties are to be configured. In one embodiment, the system can determine the program property to be configured from the input received at step 2301. In another embodiment, additional input can be received indicating the program property to be configured. In one embodiment, the input can be received from a user.

At step 2305, the MDMS determines that media properties are to be configured. After determining that media properties are to be configured, media properties can be configured at step 2310 A media property can be an identification of the type of media associated with a program. A media property can include information regarding a media file such as filename, size, author, etc. In one embodiment, a default set of properties for a program are set for a program when a media type is determined.

At step 2315, the MDMS determines that synchronization properties are to be configured. Synchronization properties are then configured at step 2320. Synchronization properties can include synchronization information for a program. In one embodiment, a synchronization property includes looping information (e.g., automatic loop back), number of times to loop or play-back a media file, synchronization between audio and video files, duration information, time and interval information, and other synchronization data for a program. By way of a non-limiting example, configuring a synchronization property can include configuring information to synchronize a first program with a second program. A first program can be synchronized with a second program such that content presented in the first program is synchronized with content presented in the second channel. A user can adjust the start and/or end times for each program to synchronize the respective content. This can allow content to seemingly flow between two programs or channels of the document. For example, a ball can seemingly be thrown through a first channel into a second channel by synchronizing programs associated with each channel.

At step 2325, the MDMS determines that hotspot properties are to be configured Once the MDMS determines that hotspot properties are to be configured, hotspot properties can be configured at step 2330.

Configuring hotspot properties can include setting, editing, and deleting properties of a hotspot. In one embodiment, a GUI can be provided as part of a hotspot editor (which can be part of hotspot manager 780) to receive configuration information for hotspot properties. Hotspot properties can include, but are not limited to, a hotspot's geographic area, shape, size, color, associated actions, and active states. An active state hotspot property can define when and how a hotspot is to be displayed, whether the hotspot should be highlighted when selected, and whether a hotspot action is to be persistent or non-persistent. A non-persistent hotspot action is tightly associated with the hotspot's geographic area and is not visible and/or active if another hotspot is selected. Persistent hotspot actions, however, continue to be visible and/or active event after other hotspots are selected.

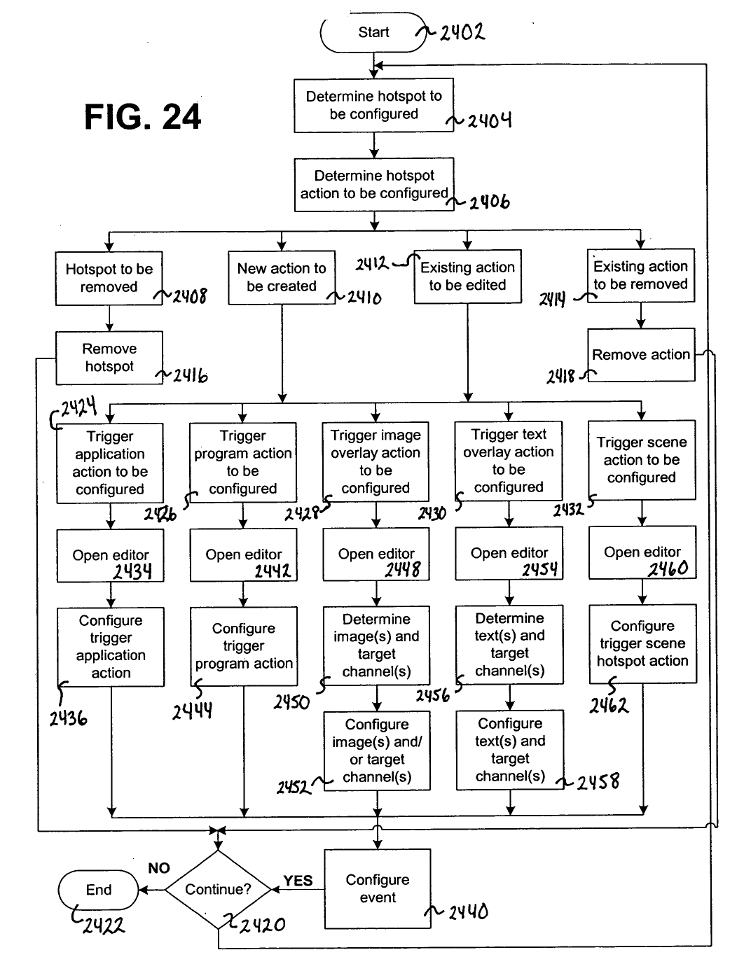

In one embodiment, configuring hotspot properties for a program includes configuring hotspot properties as described with respect to channels in FIGS. 12 and 13. FIG. 24 is a method for configuring hotspot properties according to another embodiment. Configuring hotspot properties can begin at start step 2402. At step 2404, the MDMS can receive input and determine that a hotspot is to be configured. In one embodiment, the MDMS can determine that a hotspot is to be configured from input received from a user. In one embodiment, the input can be the same input received at step 2301. The MDMS can also receive input from a user selecting a pre-defined hotspot to be configured at step 2404. Additionally, input may be received to define a new hotspot that can then be configured.

After determining the hotspot to be configured, the MDMS can determine that a hotspot action is to be configured at step 2406. In one embodiment, input from a user can be used at step 2406 to determine that a hotspot action is to be configured. The MDMS can also receive input indicating that a pre-defined action is to be configured or that a new action is to be configured at step 2406.

At steps 2408-2414, the MDMS can determine the type of hotspot configuration to be performed. In one embodiment, the input received at steps 2404 and 2406 is used to determine the configuration to be performed. In one embodiment, input can be received (or no input can be received) indicating that no action is to be configured. In such embodiments, configuration can proceed from steps 2408-2414 back to start step 2402 (arrows not shown).

At step 2408, the MDMS can determine that a hotspot is to be removed. After determining that a hotspot is to be removed, the hotspot can be removed at step 2416. After removing a hotspot, the MDMS can determine if configuration is to continue at step 2420. If configuration is not to continue, the method ends at step 2422. If configuration is to continue, the method proceeds to step 2404 to receive input.

At step 2410, the MDMS can determine that a new hotspot action is to be created. At step 2412, the MDMS can determine that an existing action is to be edited. In one embodiment, the MDMS can also determine the action to be edited at step 2412 from the input received at step 2406. At step 2414, the MDMS can determine that an existing hotspot action is to removed. In one embodiment, the MDMS can determine the hotspot action to be removed from input received at step 2406. After determining that an existing action is to be removed, the action can be removed at step 2418.

After determining that a new action is to be created, that an existing action is to edited, or removing an existing action, the MDMS can determine the type of hotspot action to be configured at steps 2424-2432.

At step 2424, the MDMS can determine that a trigger application hotspot action is to be configured. A trigger application hotspot action can be used to “trigger,” invoke, execute, or call a third-party application. In one embodiment, input can be received from a user indicating that a trigger application hotspot action is to be configured. At step 2434, the MDMS can open a trigger application hotspot action editor. In one embodiment, the editor can be part of hotspot manager 780. As part of opening the editor, the MDMS can provide a GUI that can receive configuration information from a user.

At step 2436, the MDMS can configure the trigger application hotspot action. In one embodiment, the MDMS can receive information from a user to configure the action. The MDMS can receive information such as an identification of the application to be triggered. Furthermore, information can be received to define start-up parameters and/or conditions for launching and running the application. In one embodiment, the parameters can include information relating to files to be opened when the application is launched. Additionally, the parameters can include a minimum and maximum memory size that the application should be running under. The MDMS can configure the action in accordance with the information received from the user. The action is configured such that activation of the hotspot to which the action is assigned causes the application to start and run in the manner specified by the user.

After the hotspot action is configured at step 2436, an event is configured at step 2440. Configuring an event can include configuring an event to initiate the hotspot action. In one embodiment, input is received from a user to configure an event. For example, a GUI provided by the MDMS can include selectable events. A user can provide input to select one of the events. By way of non-limiting example, an event can be configured as user selection of the hotspot using an input device as known in the art, expiration of a timer, etc. After configuring an event, configuration can proceed as described above.

At step 2426, the MDMS can determine that a trigger program hotspot action is to be configured. A trigger program hotspot action can be used to trigger, invoke, or execute a program. For example, the hotspot action can cause a specified program to appear in a specified channel. After determining that a trigger hotspot action is to be configured, the MDMS can open a trigger program hotspot action editor at step 2442. As part of opening the editor, the MDMS can provide a GUI to receive configuration information.

At step 2444, the MDMS can configure the trigger program action. The MDMS can receive information identifying a program to which the action should apply and information identifying a channel in which the program should appear at step 2444. The MDMS can configure the specified program to appear in the specified channel upon an event such as user selection of the hotspot.

At step 2440, the MDMS can configure an event to trigger the hotspot action. In one embodiment, the MDMS can configure the event by receiving a user selection of a pre-defined event. For example, a user can select an input device and an input action for the device as the event in one embodiment. The MDMS can configure the previously configured action to be initiated upon an occurrence of the event. After an event is configured at step 2440, configuration proceeds as previously described.

At step 2428, the MDMS can determine that a trigger overlay of image(s) hotspot action is to be configured. A trigger overlay of image(s) hotspot action can provide an association between an image and a hotspot action. For example, a trigger overlay action can be used to overlay an image over content of a program and/or channel.

At step 2448, the MDMS can open a trigger overlay of image(s) editor. As part of opening the editor, the MDMS can provide a GUI to receive configuration information for the hotspot action. At steps 2450 and 2452, the MDMS can configure the action using information received from a user.

At step 2450, the MDMS can determine the image(s) and target channel(s) for the hotspot action. For example, a user can select one or more images that will be overlaid in response to the action. Additionally, a user can specify one or more target channels in which the image(s) will appear. In one embodiment, a user can specify an image and channel by providing input to place an image in a channel such as by dragging and dropping the image.

In one embodiment, a plurality of images can be overlaid as part of a hotspot action. Furthermore, a plurality of target channels can be selected. One image can be overlaid in multiple channels and/or multiple images can be overlaid in one or more channels.

An overlay action can be configured to overlay images in response to multiple events. By way of a non-limiting example, a first event can trigger an overlay of a first image in a first channel and second event can trigger an overlay of a second image in a second channel. Furthermore, more than one action may overlay images in a single channel.

At step 2452, the MDMS can configure the image(s) and/or channel(s) for the hotspot action. For example, a user can provide input to position the selected image at a desired location within the selected channel. In one embodiment, a user can specify a relative position of the image in relation to other objects such as images or text in other target channels. Additionally, a user can size and align the image with other objects in the same target channel and/or other target channels. The image(s) can be ordered (e.g., send to front or back), stacked in layers, and resized or moved. At step 2440, the MDMS can configure an event to trigger the hotspot action. In one embodiment, the MDMS can configure the event by receiving a user selection of a pre-defined event. The MDMS can configure the previously configured action to be initiated upon an occurrence of the event. In one embodiment, multiple events can be configured at step 2440. After an event is configured at step 2440, configuration proceeds as previously described.

At step 2430, the MDMS can determine that a trigger overlay of text(s) hotspot action is to be configured. A trigger overlay of text(s) hotspot action can provide an association between text and a hotspot action in a similar manner to an overlay of images. For example, a trigger overlay action can be used to overlay text over content of a program and/or channel.

At step 2454, the MDMS can open a trigger overlay of text(s) editor. As part of opening the editor, the MDMS can provide a GUI to receive configuration information for the hotspot action. At steps 2456 and 2458, the MDMS can configure the action using information received from a user.

At step 2456, the MDMS can determine the text(s) and target channel(s) for the hotspot action. In one embodiment the MDMS can determine the text and channel from a user typing text directly into a channel.

In one embodiment, a plurality of text(s) (i.e., a plurality of textual passages) can be overlaid as part of a hotspot action. Furthermore, a plurality of target channels can be selected. One text passage can be overlaid in multiple channels and/or multiple text passages can be overlaid in one or more channels. As with an image overlay action, a text overlay action can be configured to overlay text in response to multiple events.

At step 2458, the MDMS can configure the text(s) and/or channel(s) for the hotspot action. For example, a user can provide input to position the selected text(s) at a desired location within the selected channel. In one embodiment, a user can specify a relative position of the text in relation to other objects such as images or text in other target channels as describe above. Additionally, a user can size and align the text with other objects in the same target channel and/or other target channels. Text can also be ordered, stacked in layers, and resized or moved. Furthermore, a user can specify a font type, size, color, and face, etc.

At step 2440, the MDMS can configure an event to trigger the hotspot action. In one embodiment, the MDMS can configure the event by receiving a user selection of a pre-defined event. The MDMS can configure the previously configured action to be initiated upon an occurrence of the event. In one embodiment, multiple events can be configured at step 2440. After an event is configured at step 2440, configuration proceeds as previously described.

At step 2432, the MDMS can determine that a trigger scene hotspot action is to be configured for the hotspot. A trigger scene hotspot action can be configured to change the scene within a document. For example, the MDMS can change the scene presented in the stage upon selection of hotspot. At step 2460, the MDMS can open a trigger scene hotspot action editor. As part of opening the editor, the MDMS can provide a GUI to receive configuration information.

At step 2462, the MDMS can configure the trigger scene hotspot action. In one embodiment, input is received from a user to configure the action. For example, a user can provide input to select a pre-defined scene. The MDMS can configure the hotspot action to trigger a change to the selected scene. After configuring the action, configuration can continue to step 2440 as previously described.

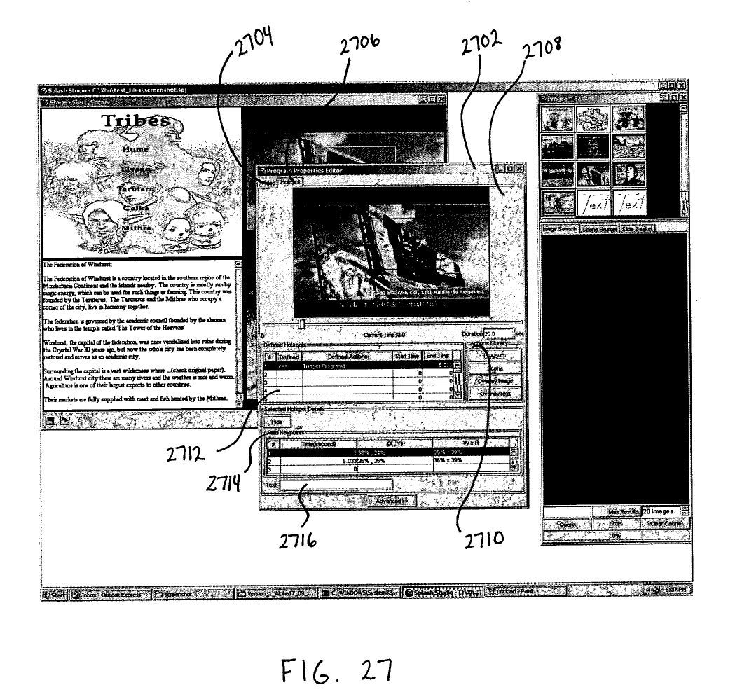

FIG. 27 illustrates a program properties editor user interface 2702. As illustrated, the interface includes a video tab 2704 and a hotspot tab 2706 as such properties are associated with the program. The MDMS can provide a page for configuration of the respective property when a tab is selected. A hotspot configuration editor page 2708 is shown in FIG. 27.

Editor page 2708 includes a hotspot actions library 2710 having various hotspot actions listed. Table 2712 can be used in the configuration of hotspots for the program. The table includes user configurable areas for receiving information including the action type, start time, end time, hotspot number, and whether the hotspot is defined. Editor page 2708 further includes a path key point table 2714 that can be used to configure a hotspot path. Text box 2716 is included for receiving text for hotspot actions such as text overlay. Additionally, selection of a single hot spot may trigger multiple actions in one or more channels.

At step 2335, the MDMS determines that narration properties are to be configured. After the MDMS determines that narration properties are to be configured, narration properties are configured at step 2340.

In one embodiment, a narration property can include narration data for a program. In one embodiment, configuring narration data of a narration property of a program can be performed as previously described with respect to channels. Program property interface 3014 of FIG. 30, as illustrated, is enabled to configure a narration property.

At step 2345, the MDMS determines that border properties are to be configured. After the MDMS determines that border properties are to be configured, border properties are configured at step 2350.

Configuring border properties can include configuring a visual indicator for a program. A visual indicator may include a highlighted border around a channel associated with the program or some other visual indicator as previously described.

At step 2355, the MDMS determines that annotation properties are to be configured. After the MDMS determines that annotation properties are to be configured, annotation properties are configured at step 2360.

Configuring annotation properties can include receiving information defining annotation capability as previously discussed with regards to channels. An author can configure annotation for a program and define the types of annotation that can be made by other users. An author can further provide synchronization data for the annotation to the program.

After configuring one of the various program properties, the MDMS can determine at step 2365 if the property configuration method is to continue. If property configuration is to continue, the method continues to determine what program property is to be configured. If not, the method can end at step 2370. In one embodiment, input is received at step 2365 to determine whether configuration is to continue.

FIG. 30 illustrates various program property editor user interfaces presented within channels of a stage window in accordance with one embodiment. Property editor user interface 3002, as shown, is enabled to receive configuration information for a text overlay hotspot action for the program associated with channel 3004. Interface 3006, as shown, is enabled to receive configuration information for a defined hotspot action for the program associated with channel 3008. Interface 3010, as shown, is enabled to receive configuration information to define a hotspot and corresponding action for the program associated with channel 3012. Interface 3014, as shown, is enabled to receive configuration information for narration data for the program associated with channel 3016.

After program settings are configured at step 2145 of method 2100, various program data can be updated at step 2187. If appropriate, various windows can be initialized and/or updated.

In step 2189, the MDMS can determine if a project is to be saved. In one embodiment, an author can provide input indicating that a project is to be saved. In another embodiment, the MDMS may automatically save the document based on a configured period of time or some other event, such as the occurrence of an error in the MDMS. If the document is to be saved, operation continues to step 2190. If the document is not to be saved, operation continues to step 2193. At step 2190, an XML representation can be generated for the document. After generating the XML representation, the MDMS can save the project file in step 2192. In step 2193, the MDMS determines if method 2100 for generating a document should end. In one embodiment, the MDMS can determine if method 2100 should end from input received from a user. If the MDMS determines that method 2100 should end, method 2100 ends in step 2195. If the MDMS determines that generation is to continue, method 2100 continues to step 2137.

In step 2150 in method 2100, the MDMS determines that scene settings are to be configured. In one embodiment, the MDMS determines that scene settings are to be configured from input received from a user. In one embodiment, input received at step 2137 can be used to determine that scene settings are to be configured. For example, an author can make a selection of or within a scene basket tabbed page such as that represented by tab 1660 in FIG. 16. Next, scene settings are configured at step 2155. In one embodiment, scene manager 728 can be used in configuring scene settings. Scene manager 728 can include a scene editor that can present a user interface for receiving scene configuration information.

Configuring scene settings can include configuring a document to have multiple scenes during document playback. Accordingly, a time period during document playback for each scene can be configured. For example, configuring a setting for a scene can include configuring a start and end time of the scene during document playback. A document channel may be assigned a different program for various scenes. Configuring scene settings can also include configuring markers for the document.

A marker can be used to reference a state of the document at a particular point in time during document playback. A marker can be defined by a state of the document at a particular time, the state associated with a stage layout, the content of channels, and the respective states of the various channels at the time of the marker. A marker can conceptually be thought of as a checkpoint, similar to a bookmark for a bounded document. A marker can also be thought of as a chapter, shortcut, or intermediate scene. Configuring markers can include creating new markers as well as editing pre-existing markers.

The use of markers in the present invention has several applications. For example, a marker can help an author break a complex multimedia document into smaller logical units such as chapters or sections. An author can then easily switch between the different logical points during authoring to simplify such processes as stage transitions involving multiple channels. Markers can further be configured such that the document can transition from one marker to another marker during document playback in response to the occurrence of document events, including hotspot selection or timer events.

After scene settings are configured at step 2155 of method 2100, various scene data can be updated at step 2187. If appropriate, various windows can be initialized and/or updated. After updating data and/or initializing windows at step 2187, method 2100 proceeds as discussed above.

At step 2160, the MDMS determines that slide show settings are to be configured. In one embodiment, the determination is made when the MDMS receives input from a user indicating that the slide show settings are to be configured. For example, the input received at step 2137 can be used to determine that slide show settings are to be configured. Slide show settings are then configured at step 2165. In one embodiment, slide show manger 727 can configure slide show settings. The slide show manager can include an editor component to present a user interface for receiving configuration information.

A slide show containing a series of images or slides as content may be configured to have settings relating to presenting the slides. In one embodiment, configuring a slide show can include configuring a slide show as a series or images, video, audio or slides. In one embodiment, configuring slide show settings includes creating a slide show from programs. For example, a slide show can be configured a series of programs.

In one embodiment, a slide show setting may determine whether a series of images or slides is cycled through automatically or based on an event. If cycled through automatically, an author may specify a time interval at which a new image should be presented. If the images in a slide show are to be cycled through upon the occurrence of an event, the author may configure the slide show to cycle the images based upon the occurrence of a user initiated event or an programmed event. Examples of a user-initiated events include but are not limited to selection of a mapping object, hot spot, or channel by a user, mouse events, and keystrokes. An example of a programmed event may include but are not limited to the end of a content presentation within a different channel and the expiration of a timer.

Configuring slide show settings can include configuring slide show properties. Slide Show properties can include media properties, synchronization properties, hotspot properties, narration properties, border properties, and annotation properties. In one embodiment, slide shows can be assigned, copied, and duplicated as discussed with regards to programs. For example, a slide show can be dragged from a slide show tool or window to a channel within the stage window. After slide show settings are configured at step 2165 of method 2100, various program data can be updated at step 2187. If appropriate, various windows can be initialized and/or updated. After updating data and/or initializing windows at step 2187, method 2100 proceeds as discussed above.

In step 2170, the MDMS determines that project settings are to be configured. In one embodiment, input received from a user at step 2137 is used to determine that project settings are to be configured. Project settings can include settings for an overall project or document including stage settings, synchronization settings, sound settings, and publishing settings.

In one embodiment, the MDMS determines that project settings are to be configured based on input received from a user. For example, a user can position a cursor or other location identifier within the stage window using an input device and simultaneously provide input by clicking or selecting with the input device to indicate selection of the identified location.

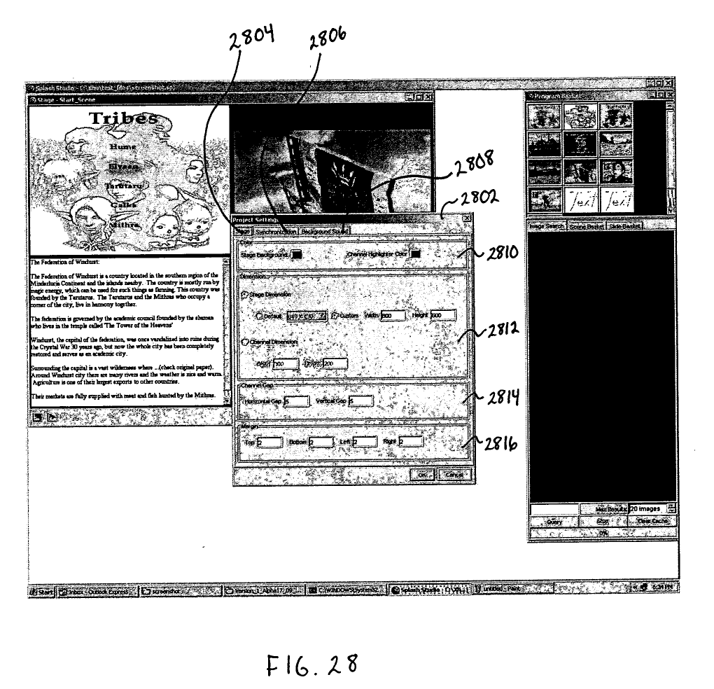

In another embodiment, if a user provides input to select an area within the stage window, the MDMS can generate a window, menu, or other GUI for configuring project settings. The GUI can include options for configuring stage settings, synchronization settings, sound settings, and publishing settings. FIG. 28 depicts an exemplary project setting editor interface 2802 in accordance with an embodiment.

In one embodiment, the window or menu can include tabbed pages for each of the configuration options as is shown in FIG. 28. If a tab is selected, a page having configuration options corresponding to the selected tab can be presented. If the MDMS determines that project settings are to be configured, project settings are configured in step 2175. In one embodiment, project manager 724 can configure project settings. The project manager can include a project editor. The project editor can control the presentation of a user interface for receiving project configuration information. In one embodiment, the project manager can include manager and/or editor components for the various project settings.

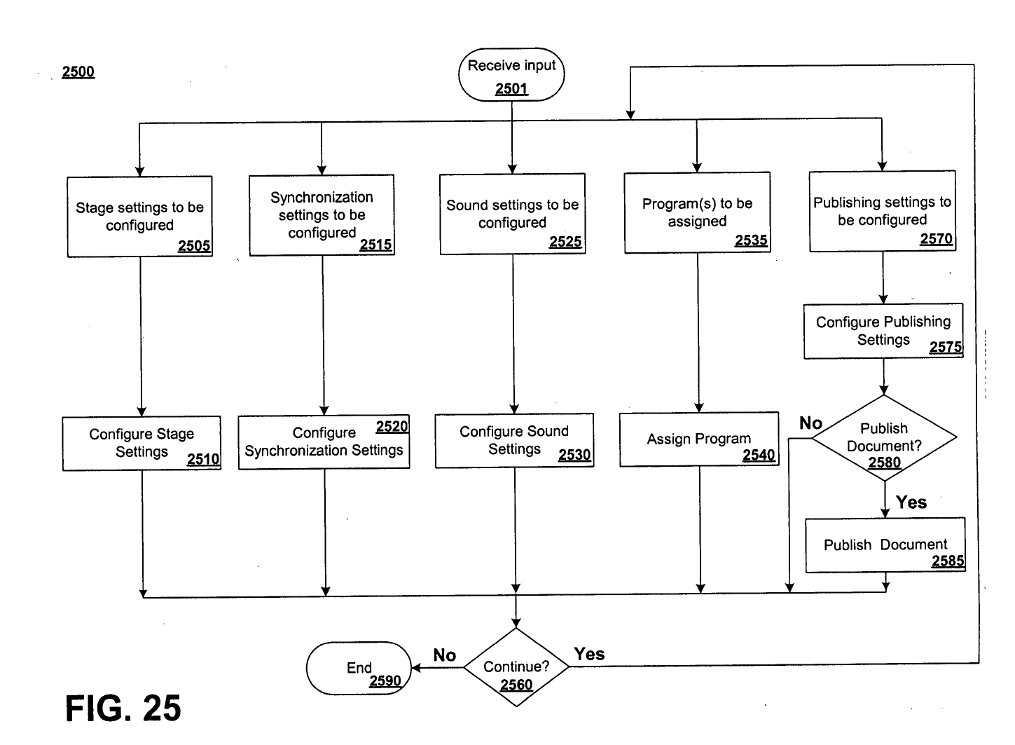

In one embodiment, project settings can be configured as illustrated by method 2500 shown in FIG. 25. Method 2500 can begin by receiving input at step 2501 indicating that project settings are to be configured. In one embodiment, the input received at step 2501 is the same input received at step 2137. After determining that project settings are to be configured the MDMS can determine whether to configure stage settings, synchronization settings, sound settings, publishing settings, or assign a program or programs to a channel, or that publishing settings are to be configured. In one embodiment, the MDMS can make these determinations from input received from a user at step 2501. In another embodiment, a menu or window can be provided after the MDMS determines that project settings are to be configured. The menu or window can include options for configuring the various project settings. The MDMS can determine that a particular project setting is to be configured from a user's selection of one of the options.

In step 2505, the MDMS determines that stage settings are to be configured for the document. In one embodiment, the MDMS determines that stage settings are to be configured from input received from a user. As discussed above, a project setting menu including a tabbed page or option for configuring stage settings can be provided when the MDMS determines that project settings are to be configured. In this case, the MDMS can determine that stage settings are to be configured from a selection of the stage setting tab or option.

In step 2510, the MDMS configures stage settings for the document. Stage settings for the document can include auto-playback, stage size settings, display mode settings, stage color settings, stage border settings, channel gap settings, highlighter settings, main controller settings, and timer event settings. In one embodiment, configuring stage settings for the document can include receiving user input to be used in configuring the stage settings. For example, the MDMS can provide a menu or window to receive user input after determining that stage settings are to be configured.

In one embodiment, the menu is configured to receive configuration information corresponding to various stage settings. The menu may be configured for receiving stage size setting configuration information, receiving display mode setting configuration information, receiving stage color setting configuration information, receiving stage border setting configuration information, receiving channel gap setting configuration information, receiving highlighter setting configuration information, main controller setting configuration information, and receiving timer event setting configuration information.

In other embodiments, the menu or window can include an option, tab, or other means for each configurable stage setting. If an option or tab is selected, a popup menu or page can be provided to receive configuration data for the selected setting. In one embodiment, stage settings for which configuration information was received can be configured. Default settings can be used for those settings for which no configuration information is received.

The stage settings may include several configurable settings. Stage size settings can include configuration of a size for the stage during a published mode. Display mode settings can include configuration of the digital document size. By way of a non-limiting example, a document can be configured to playback in a full-screen mode or in a fit to stage size. Stage color settings can include a color for the stage background. Stage border settings can include a setting for a margin size around the document. Channel gap settings can include a size for the spacing between channels within the stage window. Highlighter settings can include a setting for a highlight color of a channel that has been selected during document playback.

Main controller settings can include an option for including a main controller to control document playback as well as various settings and options for the main controller if the option for including a controller is selected. The main controller settings can include settings for a start or play, stop, pause, rewind, fast forward, restart, volume control, and step through document component of the main controller.

Timer event settings can be configured to trigger a stage layout transition, a delayed start of a timer, or other action. A timer can be configured to count-down a period of time, to begin countdown of a period of time upon the occurrence of an event or action, or to initiate an action such as a stage layout transition upon completion of a count down. Multiple timers and timer events can be included within a MC document.

Configuring stage settings can also include configuring various channel settings. In one embodiment, configuring channel settings can include presenting a channel in an enlarged version to facilitate easier authoring of the channel. For example, a user can provide input indicating to “zoom” in on a particular channel. The MDMS can then present a larger version of the channel. Configuring channel settings can also include deleting the content and/or related information such as hotspot and narration information from a channel.

In one embodiment, a user can choose to “cut” a channel. The MDMS can then save the channel content and related information in local memory such as a cache memory and remove the content and related information from the channel. The MDMS can also provide for copying of a channel. The channel content and related information can be stored to a local memory or cached and the content and related information left within the channel from which it is copied.

A “cut” or “copied” channel can be a duplicate or shared copy of the original, as discussed above. In one embodiment, if a channel is a shared copy of another channel, it will reference the same program as the original channel. If a channel is to be a duplicate of the original channel, a new program can be created and displayed within the program basket window.

The MDMS can also “paste” a “cut” or “copied” channel into another channel. The MDMS can also provide for “dragging” and “dropping” of a source channel into a destination channel. In one embodiment, “cutting,” “copying,” and “pasting” channels includes “cutting,” “copying,” and “pasting” one or more programs associated with the channel along with the program or programs properties. In one embodiment, a program editor can be invoked from within a channel, such as by receiving input within the channel.

After stage settings are configured at step 2510, method 2500 proceeds to step 2560 where the MDMS determines if operation should continue. In one embodiment, the MDMS will prompt a user for input indicating whether operation of method 2500 should continue. If operation is to continue, method 2500 continues to determine a project setting to be configured. If operation is not to continue, operation of method 2500 ends at step 2590.

In step 2515, the MDMS determines that synchronization settings for the document are to be configured. In one embodiment, the MDMS determines that synchronization settings are to be configured from input received from a user. Input indicating that synchronization settings are to be configured can be received in numerous ways. As discussed above, a project setting menu including a tabbed page or option for configuring synchronization settings can be provided when the MDMS determines that project settings are to be configured. The MDMS can determine that synchronization settings are to be configured from a selection of the synchronization setting tab or option.

In step 2520, the MDMS can configure synchronization settings. In one embodiment, configuring synchronization settings can include receiving user input to be used in configuring the synchronization settings. In one embodiment, synchronization settings for which configuration data was received can be configured. Default settings can be used for those settings for which no input is received.

In one embodiment, synchronization settings can configured for looping data and synchronization data in a program, channel, document, or slide show. Looping data can include information that defines the looping characteristics for the document. For example, looping data can include a number of times the overall document is to loop during document playback. In one embodiment, the looping data can be an integer representing the number of times the document is to loop. The MDMS can configure the looping data from information received from a user or automatically.

Synchronization data can include information for synchronizing the overall document. For example, synchronization data can include information related to the synchronization of background audio tracks of the document. Examples of background audio include speech, narration, music, and other types of audio. Background audio can be configured to continue throughout playback of the document regardless of what channel is currently selected by a user. The background audio layer can be chosen such as to bring the channels of an interface into one collective experience. Background audio can be chosen to enhance events such as an introduction, conclusion, as well as to foreshadow events or the climax of a story. The volume of the background audio can be adjusted during document playback through an overall playback controller. Configuring synchronization settings for background audio can include configuring start and stop times for the background audio and configuring background audio tracks to begin upon specified document events or at specified times, etc. Multiple background audio tracks can be included within a document and synchronization data can define respective times for the playback of each of the background audio tracks.

After synchronization settings are configured at step 2520, operation of method 2500 continues to step 2560 where the MDMS determines if method 2500 should continue. If operation of method 2500 should continue, operation returns to determine a setting to be configured Else, operation ends at step 2590.

In step 2525, the MDMS determines that sound settings for the document are to be configured. In one embodiment, the MDMS can determine that sound settings are to be configured from input received from a user. As discussed above, a project setting menu including a tabbed page or option for configuring sound settings can be provided when the MDMS determines that project settings are to be configured. The MDMS can determine that sound settings are to be configured from a selection of the synchronization setting tab or option.

In step 2530, the MDMS configures sound settings for the document. In one embodiment, configuring sound settings can include receiving user input to be used in configuring sound settings. In one embodiment, sound settings for which configuration data was received can be configured. Default settings can be used for those settings for which no input is received.

Sound settings can include information relating to background audio for the document. Configuring sound settings for the document can include receiving background audio tracks from user input. Configuring sound settings can also include receiving audio tracks for individual channels of the MDMS. Audio corresponding to an individual channel can include dialogue, non-dialogue audio or audio effects, music corresponding or not corresponding to the channel, or any other type of audio. Sound settings can be configured such that audio corresponding to a particular channel is played upon user selection of the particular channel during document playback. In one embodiment, sound settings can be configured such that audio for a channel is only played during document playback when the channel is selected by a user. When a user selects a different channel, the audio for the previously selected channel can stop or decrease in volume and the audio for the newly selected channel presented. One or more (or none) audio tracks may be associated with a particular channel. For example, an audio track and an audio effect (e.g., an effect triggered upon selection of a hotspot of other document event) can both be associated with one channel. Additionally, in a channel having video content with its own audio track, additional audio track can be associated with the channel. More than one audio track for a given channel may be activated at one particular time.

After sound settings are configured, operation of method 2500 continues to step 2560 where the MDMS determines if method 2500 should continue If operation of method 2500 should continue, operation returns to determine a setting to be configured Else, operation ends at step 2590.

At step 2535, the MDMS determines that a program is to be assigned to a channel. In one embodiment, information is received from a user at step 2501 indicating that a program is to be assigned to a channel. At step 2540, the MDMS assigns a program to a channel. In one embodiment, the MDMS can assign a program to a channel based on information received from a user. For example, a user can select a program within the program basket and drag it into a channel. In this case, the MDMS can assign the selected program to the selected channel. The program can contain a reference to the channel or channels to which it is assigned. A channel can also contain a reference to the programs assigned to the channel. Additionally, as previously discussed, a program can be assigned to a channel by copying a first channel (or program within the first channel) to a second channel.

In one embodiment, a program can be assigned to multiple channels. An author can copy an existing program assigned to a, first channel to a second channel or copy a program from the program basket into multiple channels. The MDMS can determine whether the copied program is to be a shared copy or a duplicate copy of the program. In one embodiment, a user can specify whether the program is to be a shared copy or a duplicate copy. As discussed above, shared copy of a program can reference the same program object as the original program and a duplicate copy can be an individual instance of the original program object. Accordingly, if changes are made to an original program, the changes will be propagated to any shared copies and changes to the shared copy will be propagated to the original. If changes are made to a duplicate copy, they will not be propagated to the original and changes to the original will not be propagated to the duplicate.

After any programs have been assigned at step 2540, operation of method 2500 continues to step 2560 where the MDMS determines if method 2500 should continue. If operation of method 2500 should continue, operation returns to determine a setting to be configured Else, operation ends at step 2590. In one embodiment, assigning programs to channels can be performed as part of configuring program settings at step 2145 of FIG. 21.

In step 2570, the MDMS determines that publishing settings are to be configured for the document. In one embodiment, the MDMS can determine that publishing settings are to be configured from input received from a user. Input indicating that publishing settings are to be configured can be received in numerous ways as previously discussed. In one embodiment, a project setting menu including a tabbed page or option for configuring publishing settings can be provided when the MDMS determines that project settings are to be configured. The MDMS can determine that publishing settings are to be configured from a selection of the publishing setting tab or option.

In step 2575, the MDMS configures publishing settings for the document. In one embodiment, configuring publishing settings can include receiving user input to be used in configuring publishing settings. Publishing settings for which configuration data is received can be configured. Default settings can be used for those settings for which no input is received.

Publishing settings can include features relating to a published document such as a document access mode setting and player mode setting. In some embodiments, publishing settings can include stage settings, document settings, stage size settings, a main controller option setting, and automatic playback settings.

Document access mode controls the accessibility of the document once published. Document access mode can include various modes such as a read/write mode, wherein the document can be freely played and modified by a user, and a read only mode, wherein the document can only be played back by a user.

Document access mode can further include a read/annotate mode, wherein a user can playback the document and annotate the document but not remove or otherwise modify existing content within the document. A user may annotate on top of the primary content associated with any of the content channels during playback of the document. The annotative content can have a content data element and a time data element. The annotative content is saved as part of the document upon the termination of document playback, such that subsequent playback of the document will display the user annotative content at the recorded time accordingly. Annotation is useful for collaborations, it can come in the form of viewer's feedback, questions, remarks, notes, or returned assignment, etc. Annotation can provide a footprint and history of the document. It can also serve as a journal part of the document. In one embodiment, the document can only be played back on the MDMS if it is published in read/write or read/annotate document access mode.

Player mode can control the targeted playback system. In one embodiment, for example, the document can be published in SMIL compliant format. When in this format, it can be played back on any number of media players including REALPLAYER, QuickTime, and any SMIL compliant player. The document can also be published in a custom type of format such that it can only be played back on the MDMS or similar system. In one embodiment, if the document is published in SMIL compliant format, any functionality included within the document that is not supported by SMIL type format documents can be disabled. The MDMS can indicate to a user that such functionality has been disabled in the published document when some of the functionality of a document has been disabled. In one embodiment, documents published in read/write or read/annotate document access mode are published in the custom type of format having an extension associated with the MDMS.

A main controller publishing setting is provided for controlling playback. In one embodiment, the main controller can include an interface allowing a user to start or play, stop, pause, rewind, fast forward, restart, adjust the volume of audio, or step through the document on a linear time based scale either forward or backward. In one embodiment, the main controller includes a GUI having user selectable areas for selecting the various options. In one embodiment, a document published in the read/write mode can be subject to playback after a user selects a play option and subject to authoring after a user selects a stop option. In this case, a user interacts with a simplified controller.

In step 2580, the MDMS can determine whether the document is to be published. In one embodiment, the MDMS may use user input to determine whether the document is to be published. If the MDMS determines that the document is to be published, operation continues to step 2585 where the document is published. In one embodiment, the document can be published according to method D00 illustrated in FIG. D. If the document is not to be published, operation of method 2500 continues to step 2560.

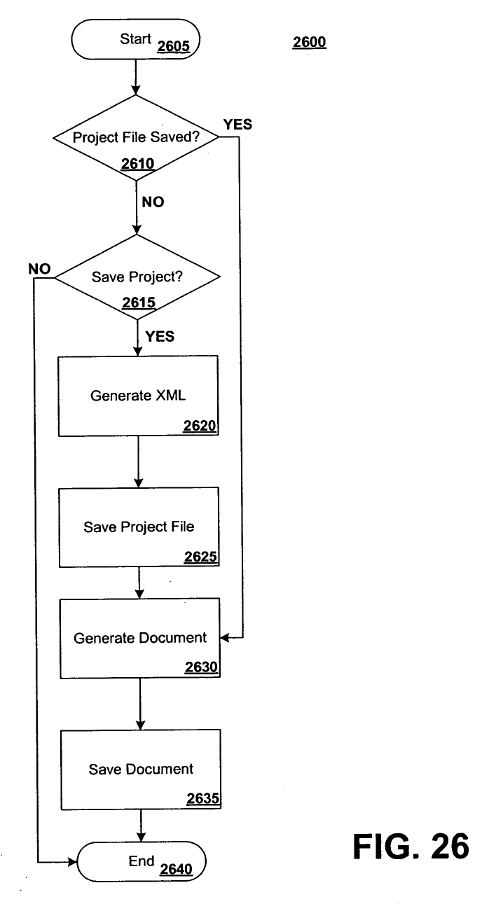

FIG. 26 illustrates a method 2600 for publishing a document in accordance with one embodiment of the present invention. Method 2600 begins with start step 2605. Next, it is determined whether a project file has been saved for the document at step 2610. If a project file has already been saved, method 2600 proceeds to step 2630, where a document can be generated. If a project file has not been saved, operation continues to step 2615 where the MDMS determines whether a project file is to be saved for the document. In one embodiment, the MDMS can determine that a project file is to be saved from user input. For example, the MDMS can prompt a user in a menu to save a project file if it is determined in step 2610 that a project file has not been saved.

If the MDMS determines that a project file is to be saved at step 2615, a document data generator can generate a data file representation of the document in step 2620. In one embodiment, the MDMS can update data for the document and project file when generating the data file representation. In one embodiment, the data file representation is an XML representation and the generator is an XML generator. The project file can be saved in step 2625.

After the project file has been saved, the MDMS can generate the document in step 2630. In one embodiment, the published document is generated as a read-only document. In one embodiment, the MDMS generates the published document as a read only document when the document access mode settings in step 2575 indicates the document should be read-only. The document may be published in SMIL compliant, MDMS custom, or some other format based on the player mode settings received in step 2575 of method 2500. Documents generated in step 2630 can include read/write documents, read/annotate document, and read only documents. In step 2635, the MDMS can save the published document. Operation of method 2600 then ends at step 2640.

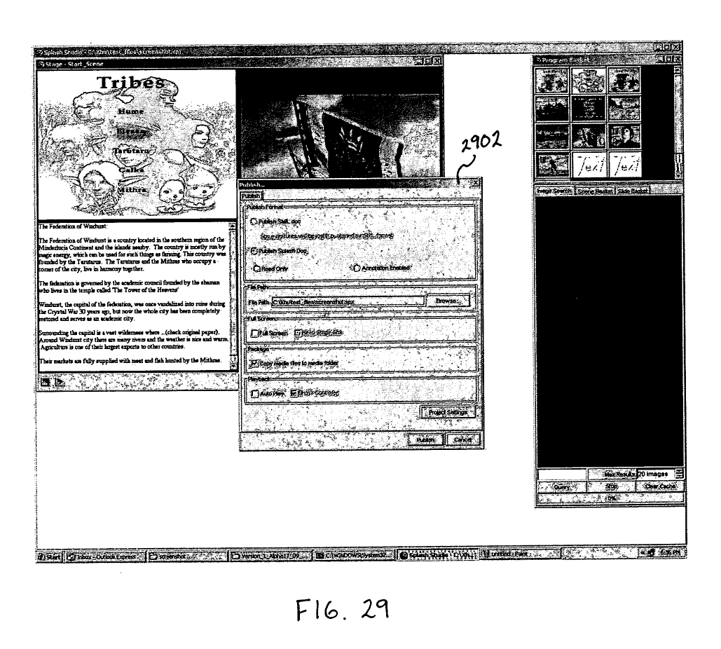

FIG. 29 illustrates a publishing editor user interface 2902 in accordance with one embodiment. As illustrated interface 2902 includes configurable options for publishing the document as an SMIL document or publishing the document as an MDMS document. Interface 2902 further includes an area to specify a file path for the published document, a full screen or keep stage size option, a package option, and playback options.

After project settings are configured at step 2175 of method 2100, various project data can be updated at step 2187. If appropriate, various windows can be initialized and/or updated. After updating data and/or initializing windows at step 115, method 2100 proceeds as discussed above.

FIG. 28 illustrates project editor user interface 2802 in accordance with one embodiment. Interface 2802 includes a stage configuration tab 2804, synchronization configuration tab 2806, and background sound configuration tab 2808. Stage configuration page 2808 can be used to receive configuration information from a user. Page 2808 includes a color configuration area 2810 where a stage background color and channel highlight color can be configured. Dimension configuration area 2812 can be used to configure a stage dimension and channel dimension. Channel gap configuration area 2814 can be used to configure a horizontal and vertical channel gap. Margin configuration area 2816 can be used to configure a margin for the document.

At step 2180, the MDMS determines that channel settings are to be configured. In one embodiment, the MDMS determines that channel settings are to be configured from input received from a user. In one embodiment, input received at step 2137 can be used to determine that channel settings are to be configured. For example, an author can make a selection of or within a channel from which the MDMS can determine that channel settings are to be configured.

Next, channel settings are configured at step 2185. In one embodiment, channel manager 785 can be used in configuring channel settings. In one embodiment, channel manager 785 can include a channel editor. A channel editor can include a GUI to present configuration options to a user and receive configuration information. Configuring channel settings can include configuring a channel background color, channel border property, and/or a sound property for an individual channel, etc.

After channel settings are configured at step 2185 of method 2100, various channel data can be updated at step 2187. If appropriate, various windows can be initialized and/or updated. After updating data and/or initializing windows at step 115, method 2100 proceeds as discussed above.

Three dimensional (3D) graphics interactivity is something widely used in electronic games but passively used in movie or story telling. In summary, implementing 3D graphics typically includes creating a 3D mathematical model of an object, transforming the 3D mathematical model into 2D patterns, and rendering the 2D patterns with surfaces and other visual effects. Effects that are commonly configured with 3D objects include shading, shadows, perspective, and depth.

While 3D interactivity enhances game play, it usually interrupts the flow of a narration in story telling applications. Story telling applications of 3D graphic systems require much research, especially in the user interface aspects. In particular, previous systems have not successfully determined what and how much to allow users to manipulate and interact with the 3D models. There is a clear need to blend story telling and 3D interactivity to provide a user with a positive, rich and fulfilling experience. The 3D interactivity must be fairly realistic in order to enhance the story, mood and experience of the user.

With the current state of technology, typical recreational home computers do not have enough CPU processing power to playback or interact with a realistic 3D movie. With the multi-channel player and authoring tool of the present invention, the user is presented with more viewing and interactive choices without requiring all the complexity involved with configuration of 3D technology. It is also advantageous for online publishing since the advantages of the present invention can be utilized while the bandwidth issue prevents full scale 3D engine implementation.

Currently, there are several production houses such as Pixar who produce and own many precious 3D assets. To generate an animated movie such as “Shrek” or “Finding Nimo”, production house companies typically construct many 3D models for movie characters using both commercial and in house 3D modeling and rendering tools. Once the 3D models are created, they can be used over and over to generate many different angles, profiles, actions, emotions and different animation of the characters.

Similarly, using 3D model files for various animated objects, the multi-channel system of the present invention can present the 3D objects in as channel content in many different ways.

With some careful and creative design, the authoring tool and document player of the present invention provides the user with more interactivities, perspectives and methods of viewing the same story without demanding a high end computer system and high bandwidth that's still not widely accessible to the typical user. In one embodiment of the present invention, the MDMS may support a semi-3D format, such as the VR format, to make the 3D assets interactive but not requiring an entire embedded 3D rendering engine.

For example, for story telling applications, whether it is using 2D or 3D animation, it is highly desirable for the user to be able to control and adjust the timing of the video provided in each of multiple channels so that the channels can be synchronized to create a compelling scene or effect. For example, a character in one channel might be seen throwing a ball to another character in another channel. While it is possible to produce video or movies that synchronized perfectly outside of this invention, it is nevertheless, a tedious and inefficient process. The digital document authoring system of the present invention provides the user interface to the user to control the playback of the movie in each channel so that an event like displaying the throwing of a ball from one channel to another can be easily timed and synchronized accordingly. Other inherent features of the present invention can be used to simplify the incorporation of effects with movies. For example, users can also synchronize the background sound tracks along with synchronizing the playback of the video or movies.

With the help of a map in the present invention, which may be in the format of a concept, landscape or navigational map, more layers of information can be built into the story. This encourages a user to be actively engaged as they try to unfold the story or otherwise retrieve information through the various aspects of interacting with the document. As discussed herein, the digital document authoring tool of the present invention provides the user with an interface tool to configure a concept, landscape, or navigational map. The configured map can be a 3D asset. In this embodiment of a multi-channel system, one of the channels may incorporate 3D map and the other channels are playing the 2D assets at the selected angle or profile. This may produce a favorable and compromised solution based on the current trend of users wanting to see more 3D artifacts while using a CPU and bandwidth that experiences limitations in handling and providing 3D assets.

The digital document of the present invention may be advantageously implemented in several commercial fields. In one embodiment, the multiple channel format is advantageous for presenting group interaction curriculums, such as educational curriculums. In this embodiment, any number of channels can be used. A select number of channels, such as an upper row of channels, can by used to display images, video files, and sound files as they relate to the topic matter being discussed in class. A different select group of channels, such as a lower row of channels, can be used to display keywords that relate to the images and video. The keywords can appear from hotspots configured on the media, they can be typed into either three channels, they can be selected by a mouse click, or a combination of these. The chosen keyword can be relocated and emphasized in many ways, including across text channels, highlighted with color, font variations, and other ways. This embodiment allows groups to interact with the images and video by calling or recounting events that relate to the scene that occurs in the image and then writing key words that come up as a result of the discussions. After document playback is complete, the teacher may choose to save the text entries and have the students reopen the file on another computer. This embodiment can be facilitated by a simple client/server or a distributed system as known in the art.

In another embodiment, the multiple channel format is advantageous for presenting a textbook. Different channels can be used as different segments of a chapter. Maps could occur in one, supplemental video in another, images, sound files, and a quiz. The other channels would contain the main body of the textbook. The system would allow the student to save test results and highlight areas in the textbook where the test background came from. Channels may represent different historical perspectives on a single page giving an overview of global history without having to review it sequentially. Moving hotspots across maps could help animate events in history that would otherwise go undetected.

In another embodiment, the multiple channel format is advantageous for training or call center training. The multi-channel format can be used as a spatial organizer for different kinds of material. Call center support and other types of call or email support centers use unspecialized workers to answer customer questions. Many of them spend enormous amounts of money to educate the workers on a product that may be too complicated to learn in a short amount of time. What they really need is to know how to find the answers to customers' questions without having to learn everything about a product—especially if it is about software which has consistent upgrades. The multi-channel can cycle through a lot of material in a short amount of time and the user constantly viewing the document will learn the special layout of the manual and also—will retain information just by looking at the whole screen over and over again.

In another embodiment, the multiple channel format is advantageous for online catalogues. The channels can be used to display different products with text appearing in attached channels. One channel could be used to display the checkout information. This would require a more specialized client server set up with the backend server probably hooked up to services that specialized in online transactions. For a clothing catalogue one can imagine a picture in one channel—a video of someone where the clothes and information about sizes in another channel.

In another embodiment, the multiple channel format is advantageous for instructional manuals. For complicated toys, the channels could have pictures of the toy from different angles and at different stages. A video in another channel could help with putting in difficult part. Separate sound with images and also be used to illustrate a point or to free someone from having to read the screen.

In another embodiment, the multiple channel format is advantageous for a front end interface for displaying data. This could use a simple client server component or a more specialized distributed system. The interface can be unique to the type of data being generated. We could use one of our other technologies, the living map, to work as one type of data visualization tool. This displays images as moving icons across the screen. These icons have information associated with them and appear moving to its relational target. Although we don't have the requirements laid out, we see this as a viable use of our technology.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing at least one of additive model representation and reconstruction.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for authoring a digital document, comprising:
configuring a multi-channel stage layout for the document, the multi-channel stage layout including a plurality of stage channels; and
configuring a program, wherein configuring the program includes associating the program with at least one of the plurality of stage channels.

2. The method of claim 1, wherein configuring a program includes creating the program.

3. The method of claim 2, wherein creating the program includes:
importing a media file to a program slot.

4. The method of claim 1, wherein creating the program comprises:
performing a media search; and
importing a media file to a program slot, the media file being retrieved as part of the media search.

5. The method of claim 1, wherein configuring a program includes configuring program properties for the program.

6. The method of claim 1, further comprising:
configuring scene settings for the document.

7. The method of claim 6, wherein configuring scene settings includes:
configuring a marker.

8. The method of claim 7, wherein the marker references a state of the document at a particular time during playback of the document.

9. The method of claim 8, wherein the state of the document includes a stage layout at the particular time, a content of stage channels of the stage layout at the particular time, and settings for the stage channels at the particular time.

10. The method of claim 9, wherein the content of one of the stage channels at the particular time can include a program associated with the one of the stage channels.

11. The method of claim 6, wherein configuring scene settings for the document comprises:
configuring a first marker;
configuring a second marker;
configuring the document to transition from the first marker to the second marker during document playback.

12. The method of claim 11, wherein the document is configured to transition from the first marker to the second marker in response to a document event.

13. The method of claim 1, further comprising:
configuring a slide show for the document.

14. The method of claim 13, wherein configuring the slide show comprises:
configuring the slide show as a series of content.

15. The method of claim 14, wherein the configuring the slide show as a series of content comprises configuring the slide show as at least one of a series of images, a series of videos, a series of audio, and a series of slides.

16. The method of claim 13, wherein configuring the slide show comprises:
configuring the slide show as a series of programs.

17. The method of claim 13, further comprising:
configuring a cycling setting for the slide show.

18. The method of claim 17, wherein configuring the cycling setting includes configuring the series of content to cycle automatically.

19. The method of claim 17, wherein configuring the cycling setting includes configuring the series of content to cycle in response to a document event.
